(19) United States
(12) Patent Application Publication
(10) Pub. No.: US 2016/0149956 A1
(43) Pub. Date: May 26, 2016

(54) MEDIA MANAGEMENT AND SHARING SYSTEM

(71) Applicant: WHIP NETWORKS, INC., Santa Monica, CA (US)

(72) Inventors: Ori BIRNBAUM, Santa Monica, CA (US); Richard ROSENBLATT, Santa Monica, CA (US); Yagil ENGEL, Santa Monica, CA (US); Jonathan YAARI, Santa Monica, CA (US); Amir LANGER, Santa Monica, CA (US); Marcelo WAISMAN, Santa Monica, CA (US); Melissa DOOLEY, Santa Monica, CA (US); Eithan EPHRATI, Santa Monica, CA (US)

(21) Appl. No.: 14/947,725

(22) Filed: Nov. 20, 2015

Related U.S. Application Data
(60) Provisional application No. 62/082,720, filed on Nov. 21, 2014.

(51) Int. Cl. H04L 29/06; G06F 21/10

(52) U.S. Cl. CPC H04L 63/20; G06F 21/10; H04L 63/10

(57) ABSTRACT

The distribution of media clips stored on one or more servers is controlled using updateable permissions or rules defined by a content owner. The clip is made available from a server via a website, app or other source, for an end-user to view; the permissions or rules stored in memory are then updated; the permissions or rules are reviewed before the clip is subsequently made available, to ensure that any streaming or other distribution of the clip is in compliance with any updated permissions or rules.

### CROSS-REFERENCE TO RELATED APPLICATIONS

This application is based on, and claims priority to U.S. Provisional Application No. 62/082,720, filed Nov. 21, 2014, the entire contents of which being fully incorporated herein by reference.

### BACKGROUND OF THE INVENTION

1. Field of the Invention

The field of the invention relates to a media management and sharing system. It finds particular application in sharing clips of media, such as live broadcast TV, that has been authorized and licensed by the content owners.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

2. Technical Background

With the spread of Internet broadband connections, video clips taken from established media sources, community or individual-produced clips have become very popular. While the rise of mobile and social networks have caused an explosion of online video consumption, most of the tens of millions of videos shared each day are user-generated content (UGC), or worse—grainy, user-uploaded TV clips.

There are currently many options for viewers to watch TV, make a clip of a favorite moment, and discover a trending clip and also to search for a specific clip. Viewers may share the clip to their friends via social media, SMS or email, or their friends also share the clip and it goes viral. However, TV moments are not always recorded legally, and as a result the clip is often deleted (e.g. by the content owners) after it has been shared. Similarly, content owners are not fully leveraging the explosive distribution potential of social sharing to drive their viewership and advertising revenue.

This invention provides a solution for users to record, share and view media clips legally, and a solution for content providers and content owners to control the post-clip redirect strategy, by directing traffic to the target of the provider's choice. In addition, data is gathered in order to yield new targeting opportunities for dynamic advertising and programming decisions. The terms ‘content owner’, ‘content provider’ and ‘content partner’ may, but do not have to, refer to the same kind of entity. The term ‘content owner’ will be used in this specification expansively to cover ‘content providers’ and ‘content partners’.

3. Discussion of Related Art

US2013/0347046A1 discloses a device with a digital camera that films a TV broadcast shown on a user's main TV screen and then distributes that recording to friends connected over a social network. The aim of the system is apparently to make private non-commercial recordings of TV broadcasts; in some countries, private non-commercial recordings are not copyright infringements.

US2010/0242074A1 discloses a cable TV head-end that enables customers viewing cable TV using that head-end to create video clips and share those amongst other cable TV subscribers.

US20130132842A1 discloses a system in which a sensor (e.g. a microphone or a camera on a smartphone) is used to detect what the viewer is watching on his main TV screen and to match the associated fingerprint with a large database of content stored on a server; the server can then send the identified content to designated recipients.

### SUMMARY OF THE INVENTION

The invention is a method of controlling the distribution of media clips stored on one or more servers, including the following processor implemented steps:

(a) updateable permissions or rules relating to the media clip are defined by a content owner, content partner or content distributor (‘content owner’) and stored in memory;

(b) the clip is made available from the server via a website, app or other source, for an end-user to view;

(c) the permissions or rules stored in memory are then updated;

(d) the permissions or rules are reviewed before the clip is subsequently made available, to ensure that any streaming or other distribution of the clip is in compliance with any updated permissions or rules.

This specification also describes a broad array of innovative concepts. We list them here:

Concept A: Content-owner can alter permissions at any time

Concept B: Media search with relevancy ranking using social traction

Concept C: Closed captions with milli-second time stamps

Concept D Recognition of TV cast members

Concept E: Automatic scheduling of clip creation and publication

Concept F: Social value of clips: hot moments

Concept G: Detecting peak moment(s) of a TV program based on clipping activity

Concept H: Monetising TV

Concept I: Embed Portal

Concept J: App auto-opens to show clips from the TV channel you are watching on your TV set

Concept K: Search input creates the clip

Concept L: Extensible video clipping system using a micro-service architecture

Concept M: Analysing user-interaction with video content by examining scrolling behaviours

Concept N: Suppression

Concept O: Adding end-cards in real-time

Concept P: Secure media management and sharing system with licensed content

Concept Q: Social network (eg Facebook) integration

Concept R: Clipping system within RAM

Concept S: Compression of video metadata

### BRIEF DESCRIPTION OF THE FIGURES

Aspects of the invention will now be described, by way of example(s), with reference to the following Figures, in which:

FIG. 1 shows a diagram of the key concepts for the domain model.

FIG. 2 shows a diagram of the system architecture.

FIG. 3 shows a diagram of the system functional architecture.

FIG. 4 shows an example illustrating the extraction of closed captions within video.

FIG. 5 shows screenshots examples of Whipclip mobile application within the Home tab.

FIG. 6 shows screenshots examples of Whipclip mobile application within the TV shows tab.

FIG. 7 shows a screenshot example of Whipclip mobile application within the Music tab.

FIG. 8 shows a screenshot example of Whipclip mobile application in which an end-user is able to share a clip.

FIG. 9 shows a screenshot example of Whipclip mobile application with a clip including a spoiler alert.

FIG. 10 shows a screenshot with an example of the clipping tool.

FIG. 11 shows screenshots example of a clipping tool and an example of the page when a user shares a clip and is also prompted to add a comment.

FIG. 12 shows an example of web design.

FIG. 13 shows a screenshot example for a web design for a particular channel

FIG. 14 illustrates an example on how a specific published clip can be either shared from the web, or alternatively a link can be created to embed the specific clip.

FIG. 15 displays an example of Share Clip Web Design.

FIG. 16 displays an example of share Clip mobile-web design.

FIG. 17 shows an example of the Partner Portal page with the main menu header and the different settings available.

FIG. 18 shows an example of a Channel Settings page of the Partner Portal.

FIG. 19A shows a screenshot of an endcard as seen by an end-user on the Whipclip application.

FIG. 19B shows a screenshot of an endcard as seen by an end-user on the Whipclip Facebook page.

FIG. 20 shows an example of the webpage to modify channel settings.

FIG. 21 shows an example of the webpage to modify an episode setting for a specific channel.

FIG. 22 shows an example of a Clipping Rules page.

FIG. 23 shows a further example of a Clipping Rules page.

FIG. 24 shows a further example of a Clipping Rules page.

FIG. 25 shows an example of a Clip/Suppress page.

FIG. 26 shows a further example of a Clip/Suppress page.

FIG. 27 shows a further example of a Clip/Suppress page after the selection of a particular episode.

FIG. 28 shows a further example of a Clip/Suppress page available before sharing the content.

FIG. 29 shows a further example of a Clip/Suppress page for a particular episode of a show displaying the suppression rules that have been pre-set.

FIG. 30 shows a further example of a Clip/Suppress page for a particular episode of a show displaying the suppression rules that have been pre-set.

FIG. 31 shows an example of a Clips page.

FIG. 32 shows an example of a EPG page.

FIG. 33 shows an example of clipping tool in the live TV/VOD apps for the first time user.

FIG. 34 shows an example of sharing the clip over social networks in the live TV/VOD apps for the first time user.

FIG. 35 shows an example of clipping tool in the live TV/VOD apps for the repeat user.

FIG. 36 shows an example of a clip being shared and the show name promoted.

FIG. 37 shows a diagram representing the high-level functions and components of the system.

FIG. 38 shows a diagram of the system architecture.

FIG. 39 shows a diagram for a video clipping system micro-service architecture.

FIG. 40 shows a diagram of system architecture for video reception.

FIG. 41 shows a diagram of system architecture for creating clips.

FIG. 42 shows a diagram of system architecture for playing clips.

FIG. 43 shows a diagram of checking for suppression rules in real time.

FIG. 44 shows a diagram of identifying key moments for users clips.

FIG. 45 shows an action diagram of using mobile scrolling data for information feedback.

FIG. 46 shows a diagram of scrolling data indicating user action sent from mobile to the server.

FIG. 47 is a diagram illustrating the content request from the mobile client.

FIG. 48 shows examples of mobile, web and social distribution of media content.

FIG. 49 shows an example of the layout of the different modules of the embed portal.

FIG. 50 shows Whipclip site modules.

FIG. 51 shows an example of the features that may be available for different users within the embed portal.

FIG. 52 shows an example of a Metrics page.

FIG. 53 shows an example of a Metrics page for reporting audience analytics for a specific channel.

FIG. 54 shows an example of further data available on a Metrics page for reporting audience analytics for a specific channel.

FIG. 55 shows an example of further data available on a Metrics page for reporting audience analytics for a specific channel.

FIG. 56 shows an example of a Metrics page for reporting audience analytics for a specific show.

FIG. 57 shows examples of a Metrics page for reporting audience analytics for a specific episode.

### TERMINOLOGY

The general terminology used in this specification will now be explained.

### Domain Model

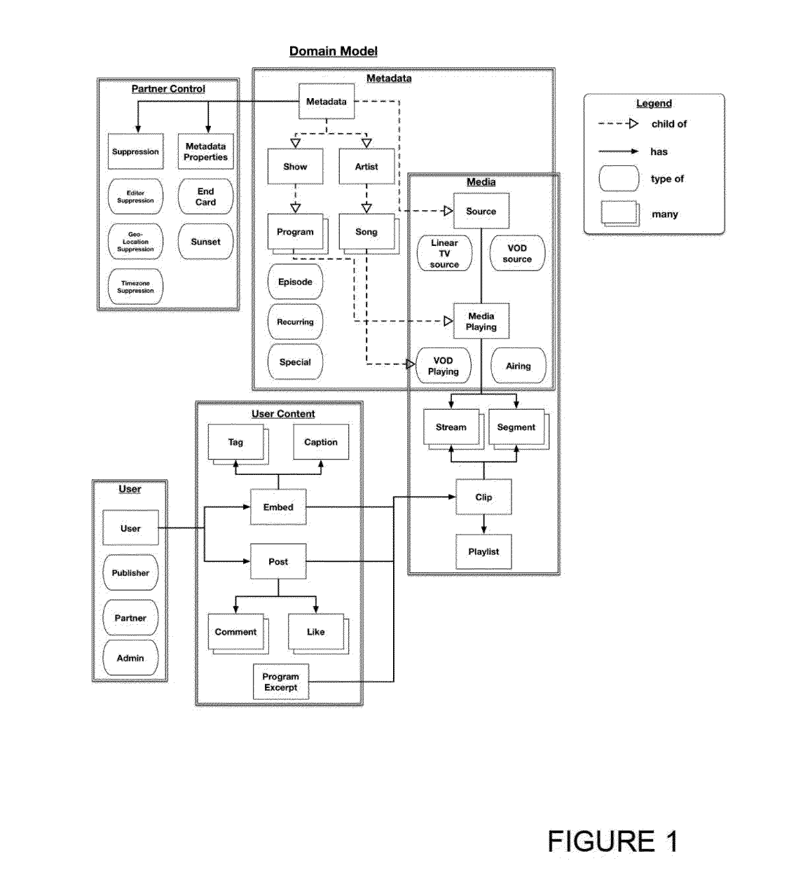

The domain is divided into 5 main areas: Partner Control, EPG Metadata, Media, User content and User. FIG. 1 shows a diagram of the domain model with the key areas and their relationships.

Clip/media: Clip is a segment of video that has both an in-time and an out-time within a larger video element. A video clip is short, usually around 30 seconds long. Clip refers also to the sequence of segment(s) given to the media player. In essence, it is whatever gets played. They can be for example, linear clips, VOD clips, MP4 clips etc.

A clip comes from a Source. A source can be, but is not limited to: TV Channels, internet streaming providers, Music corporation such as UMG, etc. It can also either be linear TV Source or VOD (Video on Demand).

A clip is composed by a sequence of Segment(s). The concept of Segments, which form the clip, is very important. This is very dependent on the media type, which is very valuable within today's HLS world.

The stream refers to the way the video is encoded, as every video may be encoded in a different quality and the same clip may be played in a different resolution suitable to the network configuration.

User: the user area contains different types of users. Examples of users are, but not limited to:

External user or Publisher—someone who uses our clients, has followers, creates posts etc. When we use the term ‘our’ we are referring to Whip Networks, Inc. and an implementation of the invention from Whip Networks, Inc.

Partner—A representative of our partners who uses the partner portal. A partner may control the properties such as the suppression rules of the clip as explained in detail in the following chapters.

Admin—An internal administrator who can control the application, block users, access data etc.

User content refers to how an-end user sees a clip, either for example as a Post in the Whipclip application or embedded in a third party website (Embed), wherein both may use the same clip. In addition, an end-user may also perform a search via the Program Excerpt, wherein a clip may be generated from sections of the program that matches the end-user search.

Post: the social area also refers to the post area.

Post is a social concept, whilst clip is media only. Post is published with a clip inside it.

A post is also linked to a like and comment properties.

Metadata: an example of hierarchy consists of the following: Show->Program->Airing

Where airing is the actual metadata linked to every clip and every airing is linked to a specific program in a specific show.

The architecture of the system allows mapping of domains to other hierarchical sets. The music domain for example may have the artist, song and clip linked tougher. The structure of the metadata makes it easy to add another child in the tree structure, such as for example Movies or Live sport events.

Metadata may refer to EPG metadata or to media metadata: EPG metadata refers to any data that has been extracted from the Electronic Program Guides (EPG).

Media metadata relates to media information about the video such as for example the duration of the segments. Generally media metadata holds information that is needed to play the video.

We will now look at the terminology relating to the following concepts:

### 1. Live

### 2. Video On-demand (VOD)

### 3. Channels

### 4. Genres

5. Show types

### 6. Hierarchy

### 7. Architecture

### 1. Live

Live refers to something airing on TV in real-time for a specific time zone. Typically sports and news broadcasts are watched live in order to be relevant to the viewer.

Broadcast Delay (West Coast Delay): Broadcast Delay refers to special events (including for example award shows, the Olympics) that are broadcast live in the Eastern & Central time zones of the US and that are often tape-delayed on the west coast. However, these broadcasts are often still considered “live.”

### 2. Video On-demand (VOD):

VOD enables users to watch video content when they choose to, rather than having to watch (live) at a specific broadcast time. On-demand content can be most prominently found on streaming services such as for example iTunes, Netflix, Hulu, and Amazon. The streaming services often present a library of content where it is possible to choose what and when to watch that content.

### 3. Channels

Channels are physical or virtual medium of communication where live TV can be distributed.

Broadcast: Broadcast refers to TV programming that is sent live over-the-air to all receivers. These channels are typically free and broadcast a wide range of content that appeals to a wide audience (ABC, Fox, NBC, CBS).

(Basic) Cable: Basic cable refers to TV programming that is sent live over cable and satellite receivers. These channels are available by default with the base cost of any cable/satellite package (˜$30). Many of these channels include a wide range of content that appeal to a wide audience and have a mix of original and syndicated content (TNT, TBS, USA). Some channels specialize in a specific genre (Ex: CNN is dedicated to news broadcasting, and ESPN is dedicated to sports broadcasting.)

(Premium) Cable: Premium cable refers to TV programming that costs an extra premium either on-demand or in addition to basic cable. Premium channels typically specialize in original TV programming and movies (for example HBO, Showtime, Cinemax).

### 4. Genres

Genre loosely defines groups of similar content. Basic genres may include for example: Action, Comedy, Drama, Horror, Mystery, Romance, and Thriller. (Ex: http://www.hulu.com/tv/genres). Sub-genres can be used to further breakdown basic genre groups (Ex: Sports-Comedies, Supernatural-Horror, etc).

### 5. Show Types

News: News refers to a program devoted to current events, often using interviews and commentary.

Sports: Sports refers to the live broadcast of a sport as a TV program. It usually involves one or more commentators that describe the sporting event as it's happening. (e.g. Monday Night Football on ESPN).

Episodic Shows: Episodic Shows refers to TV episodes that are not directly dependent on the previous episode for you to understand what is taking place. Typically these include Talk shows and News broadcasts, and Formulaic dramas such as CSI and Law and Order.

Serial Shows: Serial shows refers to the opposite of Episodic where every episode is directly dependent on the previous episode. Serialized shows slowly develop characters and story over many episodes, watching a random episode out of turn would not typically be enjoyable. (Ex: Lost, Game of Thrones, Parenthood).

Miniseries: Miniseries are similar to a Serial TV show, but has a pre-determined amount of episodes in its run. Typically a miniseries will run for 2 to 8 episodes, and is often found on premium cable channels. (Ex: Band of Brothers HBO)

Special: Special refers to a TV program that interrupts the normally scheduled broadcasting schedule. Specials can include presidential addresses, Award shows, and The Olympics.

Re-runs (Syndication): Re-runs are a rebroadcast of an episode. There are 2 types of re-runs, those that occur during a hiatus and those that occur when a program is syndicated.

### Hiatus

Currently running shows will rerun older episodes from the same season to fill the time slot with the same program. This is often done because the length of a year (52 weeks) is often much longer than the length of a season (16-28 episodes). Mid-season break (during the winter holiday season) is when you will most typically see these types of re-runs.

### Syndication

A television program goes into syndication when many episodes of the program are sold as a package for a large sum of money. Syndicated programming is typically found on basic cable in order for them to fill out their programming schedule.

### 6. Hierarchy

Channels consist of shows: a show is a title of the program which all related episodes and seasons belong. (Ex: I watched that great show/series last night: Game of Thrones.)

Shows may have one or more seasons: a season is a group of episodes of a specific show/series. Typically seasons are numbered annually and air at specific times of the year. (Ex: The first season of Game of Thrones aired from March-June in 2010, the second season aired from March-June in 2011, etc).

Shows typically have multiple episodes: an episode is a single entry of content in a show/series that will usually be 30-60 minutes long and could be part of a serial or episodic program. (Ex: Season 2 Episode 9: Blackwater of Game of Throne is widely regarded as one of the best episodes in TV history.)

Shows air at a specific time slot: for example, new episodes of Modern Family air on Mondays at 8:00 pm.

A Program is the underlying video content: any scheduled TV content is called a program. It can be an episode of a serialized or episodic TV show, it can be a sporting event, it can be a music video, or it can be a special that interrupts regularly scheduled programming.

### 7. Architecture

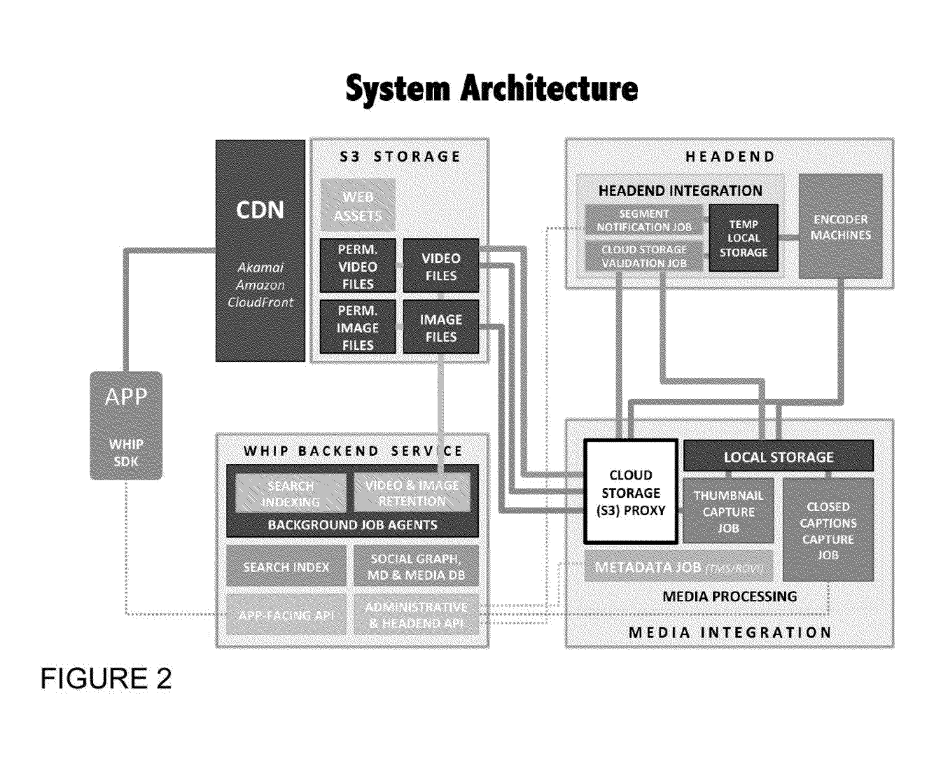

FIG. 2 shows a diagram of the system architecture.

HeadEnd: Headend is a master facility for receiving television signals for processing and distributing over a cable TV system. HeadEnd is used to receive the TV channel feeds (MPEG transport stream—MPEG-TS) and perform transcoding and upload to the Cloud (Amazon, Akamai).

Encoder (or Harmonic): Encoder is responsible for capturing, compressing and converting audio/video files into the MPEG-TS feed at multiple bitrates.

CDN (Content Delivery Network): CDN is a large distributed system of servers deployed in multiple data centers across the Internet. The goal of a CDN is to serve content to end-users with high availability and performance. We will specifically rely on CDN=s to serve our live and on-demand streaming content.

HLS—HLS (HTTP Live Streaming): HLS is an HTTP-based media streaming communications protocol implemented by Apple as part of their QuickTime, Safari, OS X, and iOS software. It works by breaking the overall stream into a sequence of small HTTP-based file downloads, each download loading one short chunk of an overall potentially unbounded transport stream.

As the stream is played, the client may select from a number of different alternate streams containing the same material encoded at a variety of data rates, allowing the streaming session to adapt to the available data rate.

Thumbnails: Thumbnails are small preview images representative of the original content, used to assist our users with browsing and creating clips.

Thumbnail Capture—The thumbnail capture job is responsible for extracting thumbnails from the HLS feed and populating them in our clip compose screens. These thumbnails serve as a navigational tool to help a user select the start and end points for their clip.

Closed Captions (CC): the Closed Captioning (CC) extracts the CC transcripts from the HLS feed and enables these in the app. etc, providing the ability for a user to search for specific moments in the archived media.

CC is a series of subtitles to a TV program. We use captions to provide the ability to search for specific moments within a live broadcast or on-demand program.

EPG (Electronic Program Guide): EPG—The EPG (electronic program guide) metadata provides users of our applications with continuously updated broadcast programming, or scheduling information for current and upcoming programming, along with cast information and episode synopsis. At Whipclip, we also refer to this as the EPG metadata job.

### DETAILED DESCRIPTION

This section describes the Whipclip system from Whip Networks, Inc.

### Overview

The Whipclip Mobile Application is a mobile application enabling users to clip, search and share their favorite moments from content partners.

The Whipclip Embed Widget enables content partners to populate their websites with collections of clips served by the Whipclip Player; the Whipclip Player plays the clips created from content partners and administers the clipping rules set by content partners in the Whipclip Partner Portal. The Whipclip Partner Portal enables the content partners to create and share clips as well as to control the properties of the clips. And the SDK enables content partners to integrate Whipclip into their own applications.

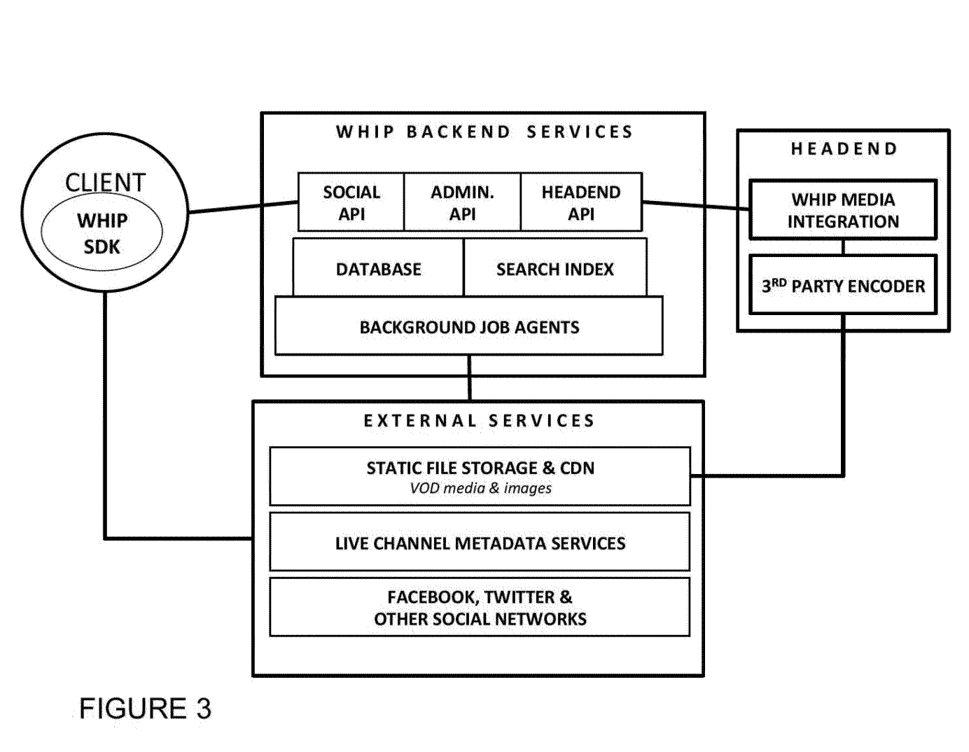

FIG. 2 shows the diagram of the overall system architecture. FIG. 3 shows a diagram with an example of a functional architecture. Whipclip backend services are linked to the SDK, headend and external services. External services may include static life storage and CDN, live channel metadata services, and social networks such as Facebook, Twitter, and other social networks.

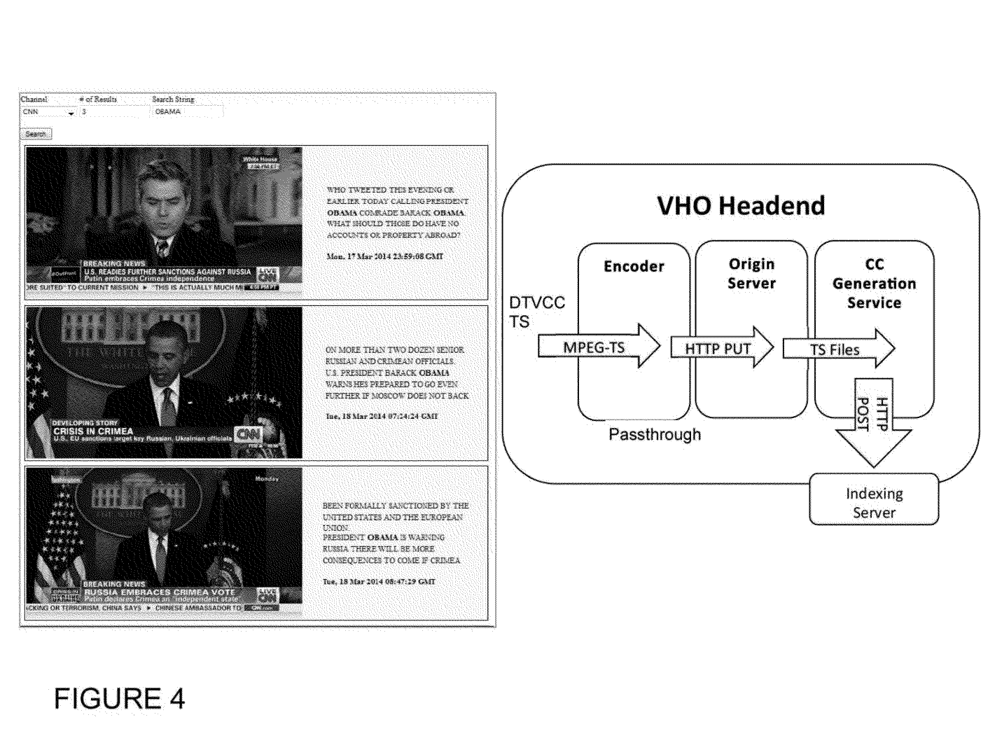

Whipclip ingests live cable TV content as well as library content. Whipclip encodes the video to HLS (HTTP Live Streaming), uploads multiple bitrates to the cloud, and makes it available to users via CDNs (content delivery networks). This enables the users to clip and share live TV within seconds of it airing. Further Whipclip features, some or all of which can be combined with each other, include:
the system extracts the associated closed captions of the video and indexes them into our search engine in near real-time. These captions, along with show EPG metadata and user comments, enable users to find their favorite moments on TV using the search feature. FIG. 4 illustrates an example how the system may extract closed captions of a video in real time. The digital TV closed caption transport stream (DTV CCTS) may be passed through an encoder, an origin server and a closed caption generation service. The system may then index the closed caption in real time into the search engine with their associated timestamp.
the EPG metadata assists our users by continuously updating broadcast programming in our app with scheduling information for current and upcoming programs, along with cast information and episode synopsis.
Whipclip uses social networks features (Follow, Like, Comment) to further drive app engagement. Whipclip also personalizes the user experience based on everything the system learns about the user over time to serve up compelling, relevant content that keeps the user engaged.
Personalization of a feed may also be done by following a person, idea or mood.
Whipclip makes clipping, finding or sharing the right moments easy and fast. However, finding the right moment within a full program or episode is not a trivial problem.
Whipclip is able to use the signals in the system to determine what are the hot moments trending right now and surface them on the Trending feed, thereby driving traffic to the Whipclip app to discover crowd-sourced hot moments on TV.
real-time statistics feed timecode are layered on top of video timecode, such that users can search for specific points (e.g. fouls for a chosen team or player).
Whipclip enables end-users to search within TV video using EPG metadata, closed caption or subtitle information.
Whipclip enables end-users to search for specific cast members within TV video by using a facial recognition system. The system may include the steps of (i) retrieving the cast of an episode (ii) obtaining a set of pictures for each cast member in an episode (iii) training a face recognition system (iv) using the trained system to get appearance timestamps for each cast member, and (v) using this data for search queries that contain a cast member name or character name.
Whipclip is able to accurately generate and provide a clip corresponding to the search request of an end-user.
the trending algorithm displays a leaderboard of the most viral clips—clips with the most social activity—in real-time. This is a true crowd-sourced leaderboard across the Whipclip app ecosystem, and is also available on a Show level. A user's feed on the Home tab lists clips shared by folks the user follows. Whipclip may also personalize a user's feed using machine learning in order to surface more clips the user is likely to love and share.
trending clips may be based on the terms that are currently trending on social media (e.g. Twitter, Facebook, etc.), and further be matched to the clips that involved those terms.
Whipclip tracks an end-user's scrolling behaviour in real time within the mobile application in order to personalise the end-user feed. This may be done in real-time while the end-user is interacting with the mobile application.
Whipclip makes it easier for “early sharers” to find the big moments and curate them. The majority of folks who hear about the big moments (e.g. “OMG—the Red Wedding was brutal!”) can find them using a trending feature and a search ranking algorithm—in fact, the curation of the early sharers is a big help to the algorithm (e.g. Red Wedding may not be even be in the transcript, but likely will be in the curated caption). Once the user found the moment, he can watch it and easily share it with friends—as is, or with user edits.
content owners may access a dedicated partner portal to set up at any time all the rules and permissions of their content. For example content owners may control suppression, end card, expiration or maximum clip length. They may also control availability of clips after they were created, and even after they were published in a third party's website.
content owners may schedule automatic clipping via the partner portal for promotional purposes. For example, content owners may setup: (i) live tune in (automatically create a clip relative to the time the user logs in, meaning we show the user the last X minutes of the program; (ii) always clip the first X minutes of a show.
content owners are also able to customise the content of the clips via the insertion of an endcard during the clip. The endcard may be an image at the end of the clip with a link e.g. a programmable hyperlink, and link text, in order to route referral traffic to the destination of the content owner's choice. The destination address may be to a website belonging to the content owner itself.
to help mitigate the risk of spoilers, Whipclip is time zone aware and does not surface clips from shows that have yet to air in a user's time zone. Even on views initiated on 3^{rd} party distribution platforms like Facebook and Twitter—which result in views on the web platform—Whipclip is able to block clips from playing for shows that have yet to air in user's time zone.
Whipclip's security model prevents a user-id (or device-id for anonymous users) from watching an entire show by keeping track of how many clips of a show instance (i.e. episode) users have watched, and prevents users from watching any more clips once the user has reached his or her maximum viewing percentage threshold, which is currently set at 50%, but can be changed when necessary.
Whipclip provides a “skeleton key” for authentication, where users enter their authentication information into Whipclip once and then seamlessly access all Content Owners' streaming sites.
The system is able to maintain data of months of video within RAM memory using a segment data compression algorithm; this enables efficient and massively scalable clip creation and clip viewing to take place.
the application may auto-open to show clips from a TV channel that is being currently watched on a TV set
a clip may be created and published or shared on a website, app or other source and may be displayed together with a user selectable option, such as a ‘buy now’ button.

We will now look at the following areas in turn:
1. Mobile Application
2. Embed Widget
3. Partner Portal (PP)
4. Software Development Kit (SDK)
5. Back End Architecture
6. Live Tune in
7. Creation and Playing of Large Quantities of Video Clips with Efficient Storage of Media Metadata in System RAM
8. System and Method for Content Owners to Prevent Access to Specific Parts of a Video Stream in Real Time Within a Clipping System
9. A Video Clipping System Allowing Content Owners to Control Online Properties of Clip
10. A Video Clipping System Allowing Content Owners to Restrict the Maximal Aggregated Time a User Views from a Show
11. Clipping Live TV in Realtime and Scheduling of Automatic Realtime Clip Creation
12. Identify Hot TV Moments from Users' Clipping Activity
13. Using Mobile Scrolling Data for Information Stream Personalization
14. Embed portal/WHIPCLIP PRO/Controlling content rights and permissions
15. Social Network, e.g. Facebook, Integration
16. Reporting Tools
17. Searching on TV Transcripts and Video to Generate Program Excerpts

### 1. Mobile Application

The Mobile Application is a mobile application that enables users to clip, search, and share their favorite moments from content partners such as for example, TV or music programs. As permitted by clipping rules set by the content partners in the Whipclip Partner Portal, users are able to clip live from content partners, search a particular program or show by keyword and create clips from those search results, and share resulting clips to social media platforms (e.g. Facebook, Twitter, Pinterest, and Tumblr), or by email or SMS.

Whipclip Player may serve both the purpose of playing the clips created from content partners as well as administering the clipping rules set by the content partners in the Whipclip Partner Portal.

When a user clicks on a clip created from the Whipclip Platform, whether within the Whipclip Mobile Application or from social media, email, or SMS, the Whipclip Player serves up the approved segment of content partners from a recorded stream.

Examples of the key features of Whipclip mobile application include, but are not limited to:
Create clips
   Clip from “live” (last X seconds, as specified by partners)
   Clip from search results
Search
   Search by network
   Search by show
   Search by hashtag
   Search by keyword
   Notifications
Watch trending clips
   Player view inline or fullscreen
   Sort by full feed, trending, recent, liked
Sharing features
   Share as-is
   Share with edited clip
   Share to Facebook
   Share to Twitter
   Share to Pinterest
   Share to Tumblr
   Share to Snapchat
   Share to SMS
   Email link
   Copy link
Social features
   Like
   Comment
   Follow
Feedback
   Mark as spoiler
   Flag as inappropriate
   Send feedback

A standard signup procedure is followed; hence the details of the procedure will not be elaborated in this document.

### 1.1 Home

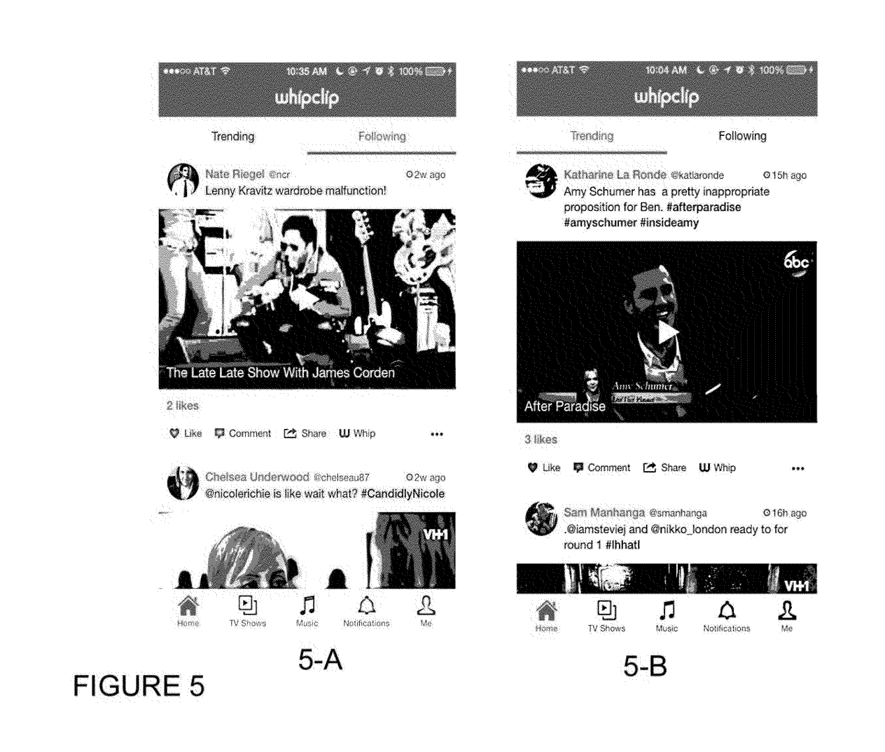

As shown in FIG. 5-A, the home tab of the Whipclip application may display a personal feed of clips in chronological order of when they were shared (the newest clips at the top). An end-user feed may display the clips published by the end-user, together with the clips published by ‘followed-users’ of the end-user. An end-user feed display may also be customized as detailed later.

Within the home button, it may be possible to select between a list of ‘trending’ clip and ‘following clip’.

As shown in FIG. 5-B, the trending section may display clips that are currently trending on Whipclip based on the following factors:
1. Virality. The social engagement (popularity) score may be determined using the Likes (least valuable), Comments (more valuable), Shares (most valuable), and views. All things being equal, posts with stronger social engagement should surface before posts with weaker engagement.
2. Recency, such as when a clip was created or published. All things being equal, newer posts should precede older posts.
3. When there are multiple clips trending from essentially the same underlying video segment (Peak Moment), the duplicate clips may be de-dupe and only the most viral clip is shown. However, if someone from the end-user social graph has posted a clip, his or her clips may be shown instead. This would prevent the scenario where there are numerous trending clips from the same big moment on TV.
4. The trending logic may apply to the Trending tab in the app, and other scenarios:

Trending on Whipclip embed widget

Trending on <Channel>embed widget

Trending on <Show>embed widget

Trending on <Genre>embed widget

Trending feeds on the Partner Portal

### 1.2 TV Shows

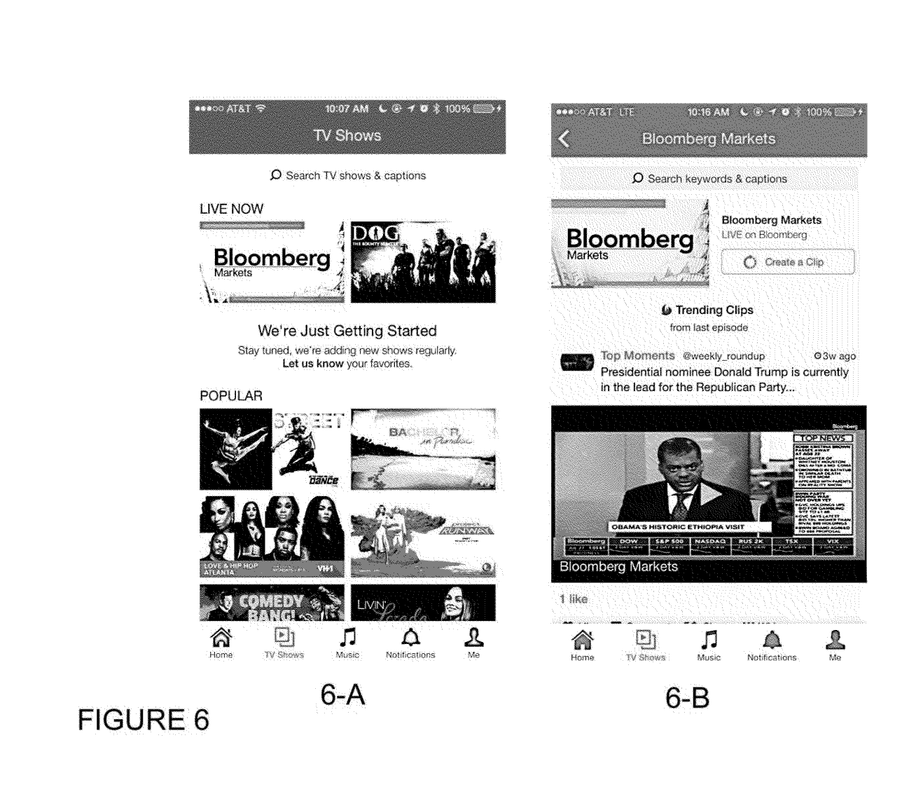

As shown in FIG. 6-A, TV shows tab may display the TV channels that are currently ‘Live now’ as well as a list of popular TV shows with the most popular at the top. By selecting a live TV channel or a specific show, the end-user may be directed to the specific TV channel or show page, as shown in FIG. 6-B.

It may also be possible to navigate through shows by popularity as well as by alphabetical order. Live shows may also be presented with a progress bar.

Additionally, the feed display may also be customized specifically to an end-user.

### 1.3 Music

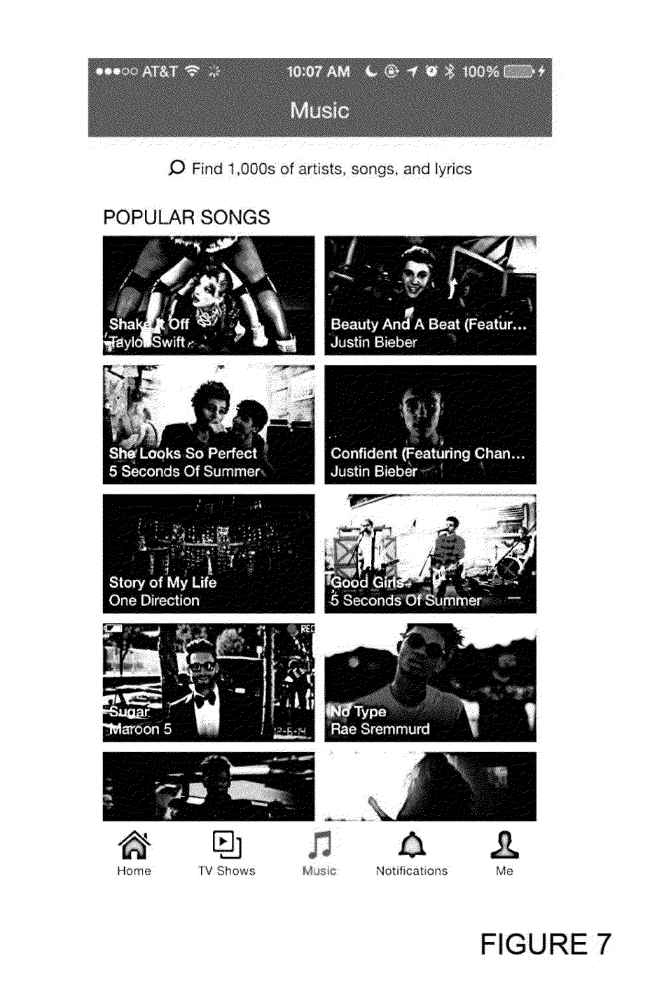

Similarly to the TV shows tab, a music tab may display a list of popular Music channel or songs. An example is shown in FIG. 7.

### 1.4 Search

As also shown in FIGS. 6 and 7, a search bar may be displayed to search for TV shows or music. Search results may be provided to an end-user with a list of suggestions as a query is entered, auto-completing words within the context of the search request or TV shows or music that has been selected. Details on the search function are provided in Section 17.

### 1.5 Social

Like when an end-user likes a clip, the end-user's ‘like history’ is updated and the person who created or shared the clip is notified. The popularity score for the liked clip may also go up. An additional feature may be to auto-post a like on the behalf of an end-user when permissions have been sought and verified. However, followers may not see this feature.

Follow Recommendations: in order to grow engagement with the mobile app, an end-user may be recommended current Whipclip users (Contacts, Facebook friends, Twitter followers) to follow. Suggested follow up may also be recommended.

Comment: when an end-user comments on a clip, the person who shared the clip is notified. The popularity score for the commented clip may also go up (more than a like, since a comment is a stronger action)

An additional feature may be to auto-post a comment on the behalf of an end-user when permissions have been sought and verified. However, followers may not see this feature.

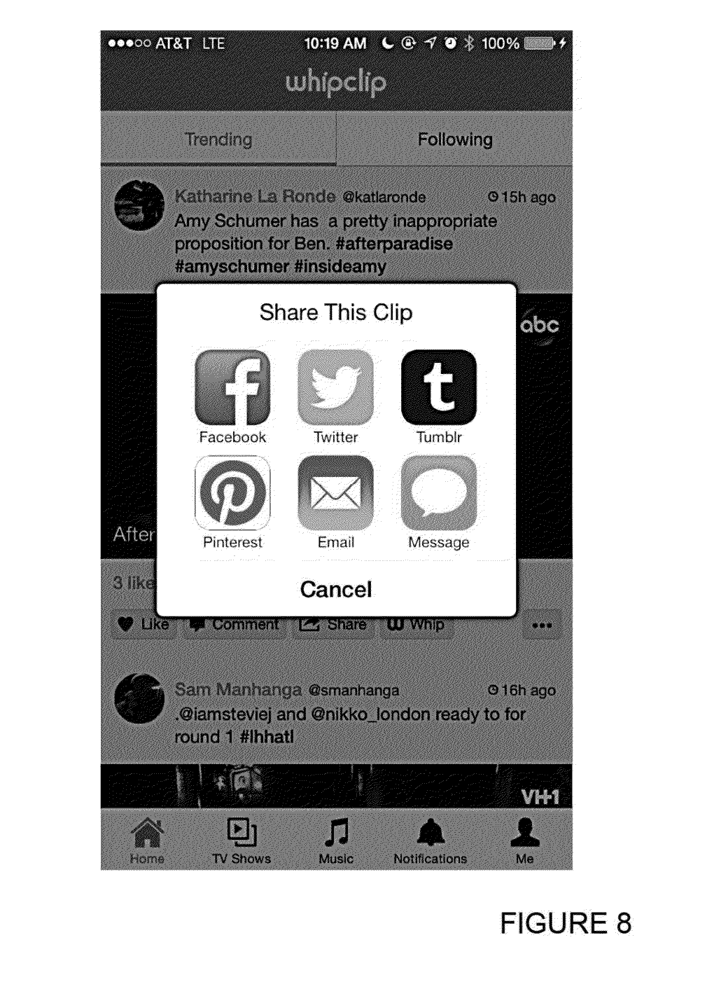

Share: when an end-user shares a clip, he may either edit the clip before sharing it or share it as is. Followers may be able to see the shared clip, and the person from whom the clip was shared is notified. The clip is then added to the profile of the end-user that has shared it. The popularity score for the commented clip may also go up (even more than comment as this is the strongest action as it means that an end-user really want his followers to see the shared clip). A clip may also be shared to Facebook, Twitter, Tumblr, Pinterest, by email or text as seen in the example in FIG. 8.

An additional feature may be to auto-post a shared clip on the behalf of an end-user when permissions have been sought and verified. However, followers may not see this feature.

Watch: Another aspect of the function is the following: permissions are required to add activity to the Facebook sidebar (e.g. if a user watches clip) so that Whipclip can add to the sidebar “<User> watched <this clip> on Whipclip”.

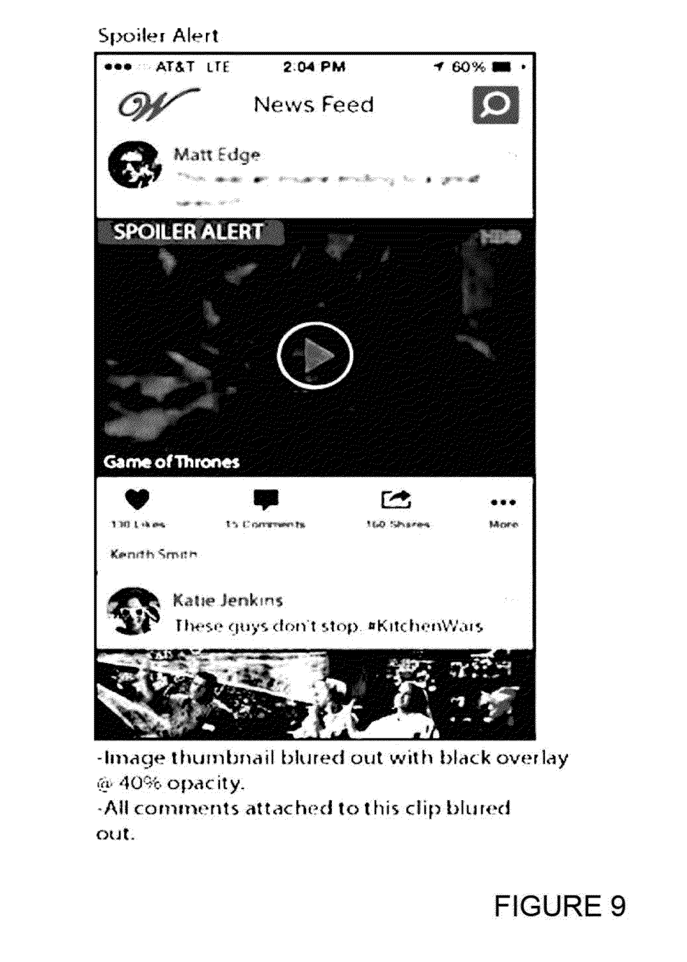

Spoilers: an example is given in FIG. 9. Spoilers' alerts may be used when the clip reveals spoilers of the referenced show. An indicator may appear confirming when an end-user has selected “Spoilers.” Once the number of “Spoilers” selections meet the preset threshold, all users may receive the “Spoiler Treatment”. The clip and clip caption may be blurred for all users with a warning that it contains spoilers. An end-user may bypass this warning and play the clip anyway. Any clip that meets or exceeds the threshold may also be reviewed by the content owner in the Partner Portal.

Report Inappropriate: this function may be used when the clip is not suitable for an end-user or most audiences. An indicator may appear confirming to an end-user that he has selected “Report Inappropriate”. Once the number of “Report Inappropriate” selections meet the preset threshold, the clip may be suppressed. Suppressed clips may not be seen by anyone. Any clip that meets or exceeds the threshold may also be reviewed in the Partner Portal

Edit/Delete an end-user own Clip: Selecting “Delete” may prompt an end-user to Confirm or Cancel. Confirming may delete your clip whereas cancelling may bring back the end-user to the previous screen. Selecting “Edit” may allow an end-user to re-scrub the clip. Selecting “Save” when the end-user has finished editing may change the clip to the re-scrubbed version permanently.

### 1.6 Clip

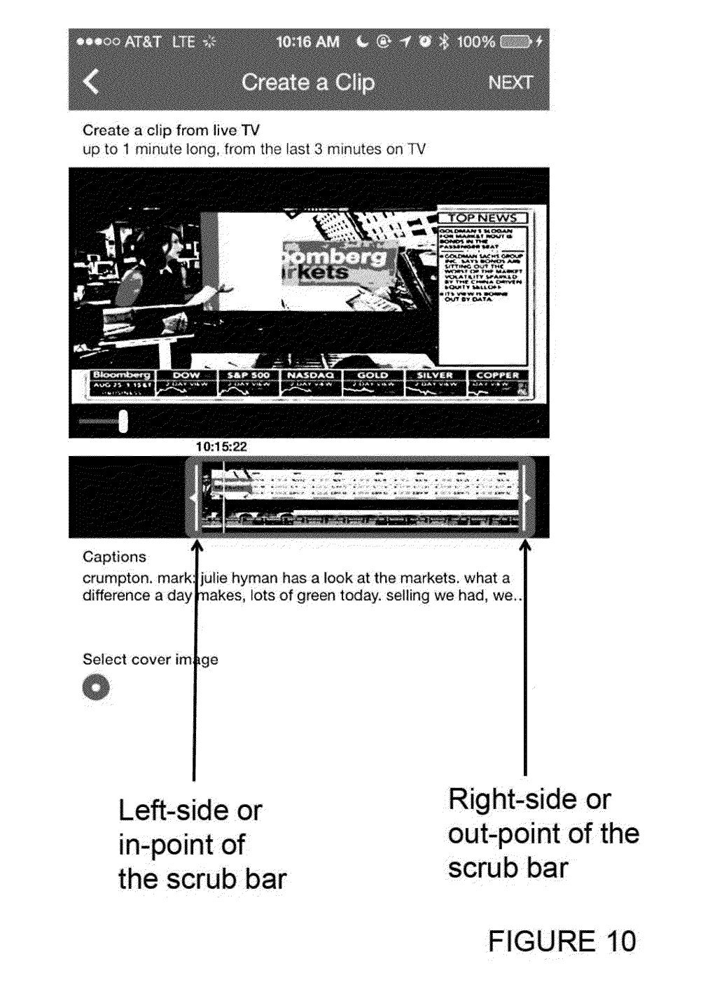

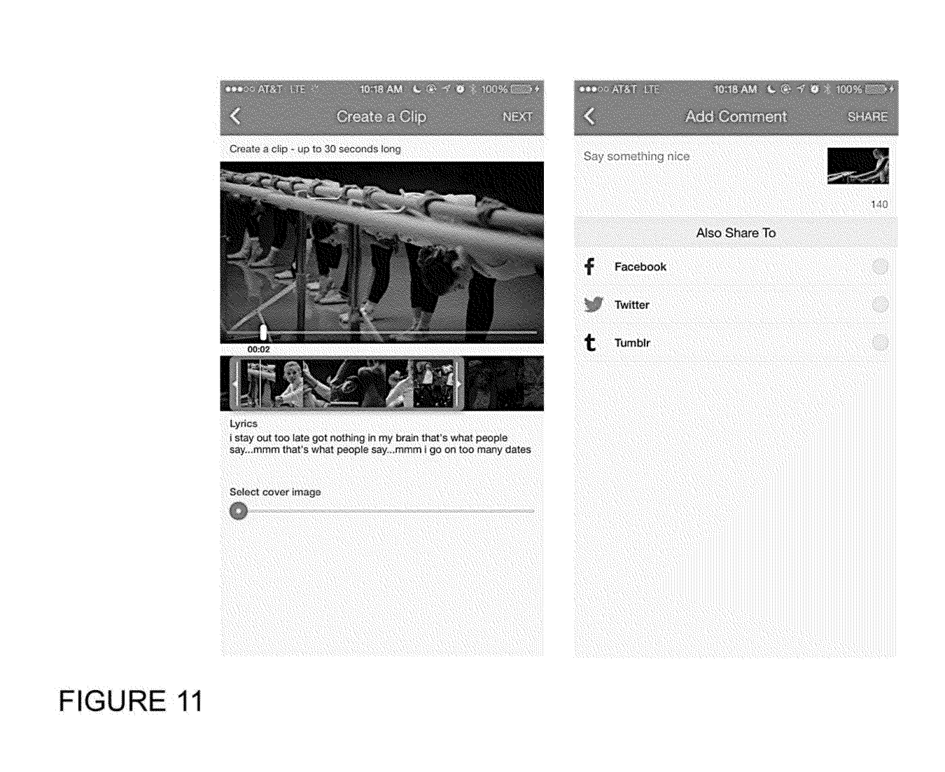

An end-user may create a clip and share live and past TV shows or music. An example of this can be seen in FIGS. 10 and 11, in which a clip form live TV is created using a clipping tool. A progress bar below the thumbnail is also presented. The clipping tool may display the most recent minutes of the current broadcast, as defined by the content owner in the clipping rules. It may also be possible to set up notification in order to be notified when a specific TV show is airing live next. A clipping tool may be presented with sections of or the entirety of TV shows or music video available to scrub.

A window plays the content in the clipping tool between scrubbers as shown in FIGS. 10 and 11. Features of the clipping tool include: tap the window to start playback, tap the window again to pause playback. As the video is playing, a white bar and counter on the video moves and updates. The white bar may be dragged along the timeline to accelerate play or skip around the clip. The scrubber is the oblong, rectangular window underneath the main video window.

### Scrub End Points

Modify the clip by adjusting the in-point (left) and out-point (right) along the film strip.
When you enter the clipping screen the orange scrub bars do not fill up the entire film strip.
The default will set the in-point (Left) bar to 0:30, and set the out-point (right) bar to the point where you hit “clip” from the search screen.
Drag the orange scrubber in-point (left) to select when you want the clip to begin (default 0:30). Drag the orange scrubber end-point (right) to select when you want the clip to end.
The black numbers above each end-point represents the timestamp of the video at that point. the timestamp will update as you drag the end-points.

### Transcript

Is the written representation of the TV program, similar to closed captioning.
In the clipping tool you will see the transcript below the film strip and orange scrubber
the transcription will update as you move the in-point (left) over the film strip. The transcript will consistently represent the dialogue of the clip at that point.
Because clips have these transcriptions, searching for dialogue will return results of TV programming where that dialogue was spoken. (Ex: Searching for the name of a famous sports athlete will return clips of shows where that name was mentioned.)

### User Comment

When you create and share a new clip you will be prompted to add a comment. This comment will be present with your clip when sharing on Whipclip or through social media (Facebook, Twitter, etc.) An example of this can be seen in FIG. 11, wherein it is possible when sharing a clip to also share to Facebook, Twitter or Tumblr.

The mobile application may also present functions that are standard within social media platforms. Functions may include searching for people (by name, email or username for example), tagging people, looking at the end-user own profile, reviewing notifications, sending feedback, reviewing the terms of service, reviewing the privacy policy, and logging out. Notifications of likes, comments, share and follows may also be given.

A profile page may display a profile photo, description given by the end-user, shared clips, followers, following or likes.

Selecting “Notify Me” will send you a notification when that TV show is airing live next.

Every time there's a mention of your favorite celeb, sports star, etc. on TV, you get a notification.

### 1.7 Time Zone Awareness

When a clip is created live by an end-user, the end-user clips what is airing live in your time zone, if the end-user is connected on the West Coast and a program has not aired in the current time zone, all posts from that program does not show up in the end-user feed or “trending” till it airs. Videos (posts or programs) are not shown if they have not aired in the end-user time zone. Program or post results are not seen in search till it airs.

On FB/Twitter or other similar, if the show has not yet aired in an end-user time zone, a Soft block warning is implemented if the content owner has not selected Time Zone (TZ) Blocking for that show.

If TZ blocking is set to yes, the end-user cannot see the video.

At the Channel level: Default to No.

At the Show level: Allow for override.

### Ad Suppression

Both national and local ads may also be suppressed. When clipping live TV, if the end-user is on an ad-break, the most recent (for example 1-minute) clip before the ad is returned. When clipping from non-live TV, ad breaks are skipped over (similar to how ad breaks are skipped when watching shows on Netflix).

### 1.9 Additional Features

Search
Live show. If an end-user searches for a show airing now in his time zone, the top ranking search result is the most recent 2 minutes aired (provided we have rights).
Live channel. If an end-user searches for a channel name, the top ranking search result is the most recent 2 minutes aired (provided we have rights to the content airing).
Trending searches.
Trending channels. These are the channels from which the most clipping is happening right now. For every episode, it may be useful to see the peak moments. Each peak moment is represented by its most popular post sorted by peak height (i.e. the number of posts/shares). This helps alleviate the dupes (i.e. multiple clips of essentially the same moment). After the most recent episode, we move on to the previous episode.
Search vs. List. It is more efficient to find a channel or show by starting to type it, and use auto-complete, than find it in a long list. The channel/show EPG is not scalable and that is why it is not dominant on VOD sites like Hulu or Netflix.
Current vs. Library. The views and social activity around TV tend to decay rapidly as the vast majority of view and social activity happens within a couple days of airing. Given this fact and the fact that we don't have rights to library content (past seasons), our initial UX isn't optimized for finding specific season/episodes like a Hulu or Netflix.

### Audio Fingerprint

This is a solution for live and on-demand (DVR or VOD), but doesn't have a 100% success rate, particularly with ambient noise. We implement this in the background—similar to Facebook—and when we have a successful match, we present it to the user (e.g. Are you watching Glee?). This prevents a bad UX scenario where you initiate the audio fingerprint and we're unable to find a result/match.

### Social Graph Awareness

If anyone on an end-user social graph engaged with a clip—e.g. liked, commented, liked, watched, the end-user is made aware of it within the context of using different feeds on the app.

### Muted Auto-Play

Additional features include the implementation of auto-play and muted autoplay.

### In-Line Playback on FB, Twitter, Etc.

Inline playback can be low friction from a user experience perspective, but it can be matched on the web (i.e. a single click plays the video clip on our web page), but not on mobile (where 2 taps are required). In some scenarios (i.e. on some FB enabled platforms), muted auto-play lowers friction to start videos even more. Hence in-line playback may result in x number of views.

Social activity around video clips (like/comment etc.) may be on FB/T. If it is in the Whipclip mobile app, we can get incremental views and greater engagement. Plus, we can entice users with more related/trending clips. Hence playback on Whipclip mobile app/web page may result in y number of views.

Therefore inline may be played if x is greater than y. Driving traffic to their own apps/web pages is the model. If our goals are to maximize uniques and engagement (views per visit x frequency of visits), we can work on an a/b test to help us figure out which approach is better.

### 2. Whipclip Embed Widget

The Whipclip Embed Widget is an embed code that enables content partners to populate their websites with collections of embedded clips served by the Whipclip Player. The widget can be populated for example with trending clips (“Trending Now”), or clips from a specific program, show or network. Additionally, the Whipclip Embed Widget can be configured to feature one or more than one clip(s), and have either a horizontal or vertical orientation. The size of clips may be configured. Titles and captions of the clips may be defined. Branding elements may also be customized.

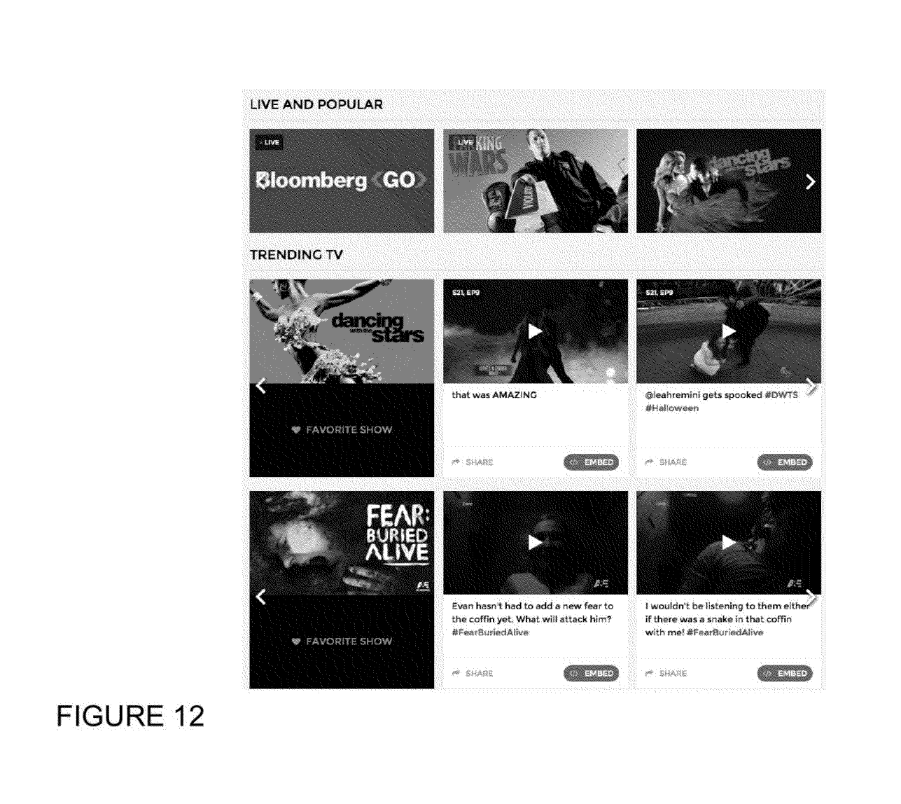

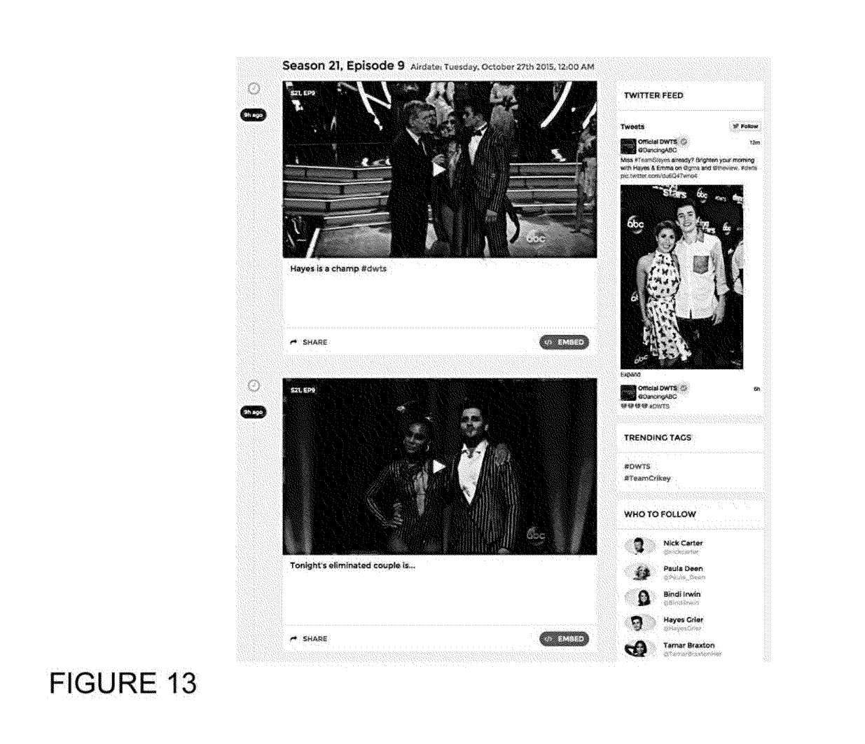

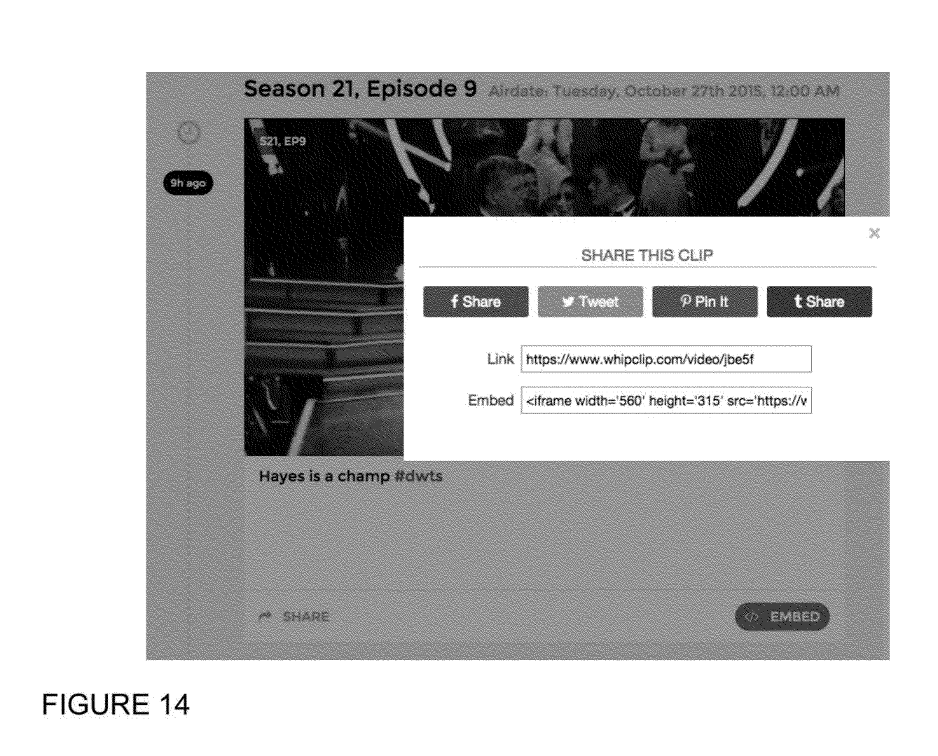

An example of web design can be seen in FIG. 12 wherein Live and Popular channels are displayed at the top of the page, followed by a list of trending TV shows and their associated popular clips. An embed link may also be displayed below each clip published wherein a link may be created to embed the clip. FIG. 13 shows a screenshot example for a web design for a particular channel, in which the twitter feed of the channel is also displayed as well as the trending tags and recommendations on who to follow. FIG. 14 illustrates an example on how a specific published clip can be either shared from the web, or alternatively a link can be created to embed the specific clip.

User can configure embeddable widgets to use on websites. While a majority of our partners leverage the embed product in the context of actual stories/recaps, we have identified a market for partners to maintain static real estate with dynamic content. This allows partners to showcase content and to increase traffic, views, etc.

### 2.1 Share Clip

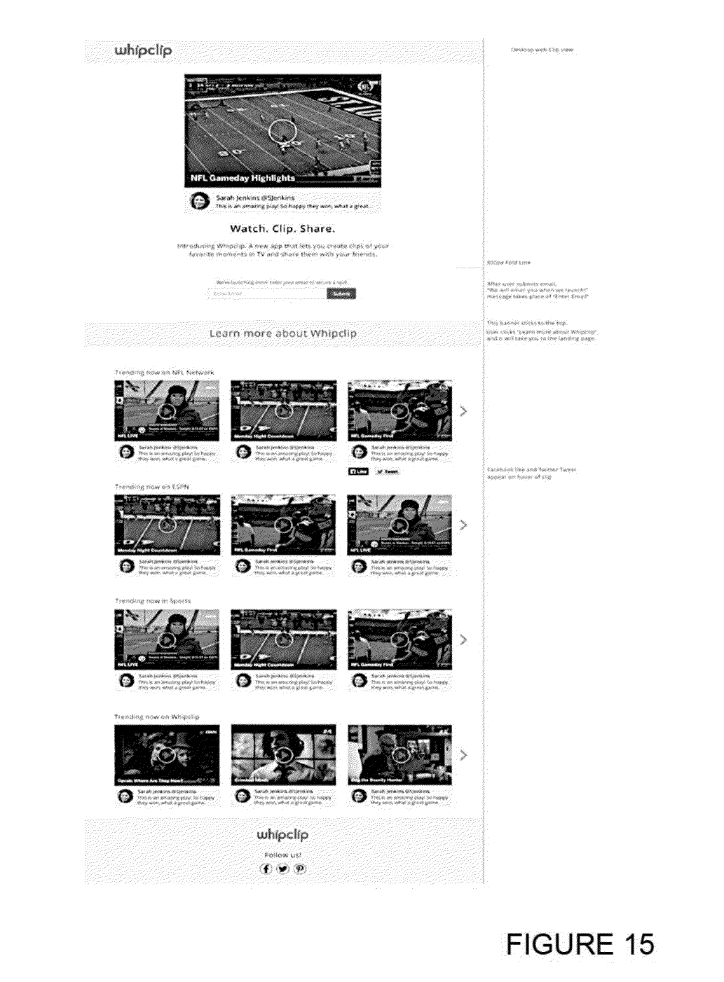

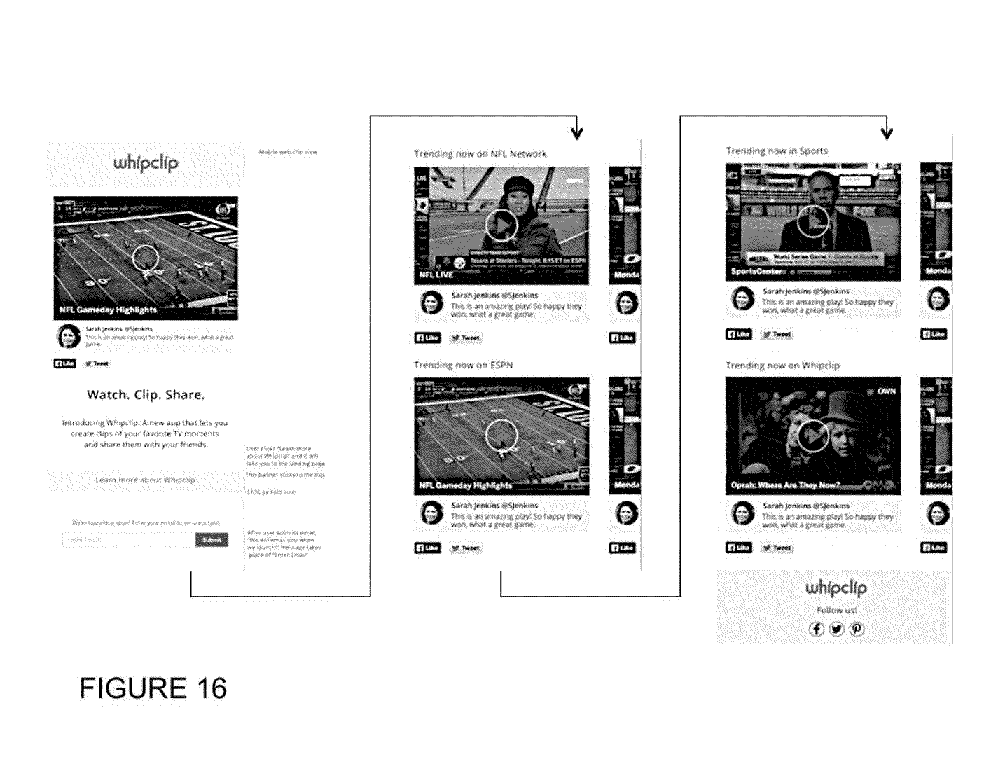

FIG. 15 displays an example of Share Clip Web Design. Below a main video screen at the top of the screen, there are four rows (called ‘Trays’ below) of smaller screens, each row showing three trending clips (Trending now on NFL Network; Trending now on ESPN; Trending now in Sports; Trending now in Whipclip). FIG. 16 shows this in more detail for a mobile-web design. In this example, Trending Clips may also be displayed similarly as described above.
When you navigate to the URL of a shared clip (from an email, text message, embed widget, Facebook, Twitter etc) you will be able to view and play that clip in your web browser.
You will be presented a webpage with the clip player and user caption (enabling you to play the clip).
Below the player you will have several social functions similar to the app. You can Like, Comment, Re-share on Whipclip, Share of Facebook, Tweet, or Pin it.
Below the clip and social options you will see four trays of related clips, starting specific and moving away. You can scroll through these. (On mobile devices you can swipe through) to promote further engagement.
Tray 1—Clips from the specific show (e.g. NFL Network).
Tray 2—Clips from the specific network the show is from (e.g. ESPN).
Tray 3—Clips from the genre (e.g. Sports).
Tray 4—Clips trending on Whipclip.

### 2.2 Embed Widget

An embed code can be generated for your website to incorporate trending Whipclip videos from your show or channel, to scroll in a horizontal or vertical orientation.

Our Embed Widget for Web features popular clips created from programming from your participating shows or channels. The clips featured in these widgets will automatically refresh to surface your most popular clips at any given time. Users can click on these clips to watch them.

### 2.3 Creating and Customizing an Embed Widget

Embeddable content may be defined as follows:

playable media with defined start and end times

cover image (thumbnail).

user (Created by).

Title (caption).

Based on these, elements, die following may be generated:

Link to embed (whipclip.com/embed).
Link to Video (whipclip.com/video),
Inline Embed Code (<iframe width=>).

You will be able to generate an embed code through the Whipclip Partner Portal. Within the Partner Portal you will be able to select pre-set customization options:
Specify the list of channels and shows you want clips from.
Select if you want to include user clips or only clips you the content owner have created
Specify the layout (horizontal or vertical orientation)
Choose the number of clips you want displayed at a given time (e.g. row of 3 clips, 2 clips or a single clip).

Note: We will provide you the ability to modify the CSS making it very easy for you and your team to customize the widget to fit your branding preferences.

### 2.4 Reporting

Under reporting tools or website, you will be able to see the performance of your widget:
Number of views per day/week/month.
Number of end card impressions and traffic driven to your destinations per day/week/month.

The Embed Widget will work on all major browsers and platforms on web, tablet, and mobile devices that support HLS streaming.

### 3. Partner Portal (PP)

The system allows for a full online control by the content owner over its media content using a dedicated portal after the media content has been published, or while it is airing.

The Whipclip Partner Portal is a commercial clipping tool that is provided to content partners. From the Whipclip Partner Portal, content partners may create clips and share them to social media platforms (e.g. Facebook, Twitter, Pinterest, and Tumblr), embed widgets, and email. From the Whipclip Partner Portal, content partners may also set clipping rules that govern the clipping activities of both internal (content partners) users and external (Whipclip Mobile Application) users. Clips created by content partners in the Whipclip Partner Portal also appear in the Whipclip Mobile Application. Through the partner portal, partners may also control the properties of the clip(s) by choosing for example clip(s) or portion of the clip(s) they want to suppress.

Examples of key features of Whipclip Partner Portal include, but are not limited to:
Create clips:
   Select in- and out-points by time code.
   Select in- and out-points by second.
   Preview clip.
   Select thumbnail.
   Mark as spoiler.
Suppress clips or control of the properties of the clips:
   Suppression rules at episode, season, or show levels.
   Suppress by time code.
   Suppress by time zone.
   Suppress by geolocation (e.g. DMA-based instead of time zone, to comply with regional sports networks agreements (e.g. NBA) or Geo-targeting to the level of zip code).
   Expire clips after specified period.
   Suppress commercials.
   Suppress internal clips.
   Suppress user clips.
   Suppress user comments.
   Suppress specific portions of a clip (e.g. the last X minute of a show).
   Age-gating to prevent minors from seeing adult content (e.g. nudity).
   Suppress clips after a certain amount of time (e.g. Season one clips no longer allowed during Season 2) Ability to limit number of clips per show. For example, a limit of the percentage of an episode that a user can see across all episodes can be set. As another example, ‘Holding bins’ can be set so that clips of shows aired in US Eastern time zone aren't spoilers for Western time zone (e.g. Mark as a spoiler).
   Customizable messaging for user experience in cases of suppression.
   Delete any video clip that was already created from the suppressed part of the stream:
      Define expiration time on specific video clips.
      Define expiration on the media metadata level, e.g., for all clips created from a channel, or all clips created from a show, or from all clips created for a specific episode of a show.
      Delete specific video clips—the result is that any embedding of this clip will no longer work.
Sharing features:
   Share to Facebook.
   Share to Twitter.
   Share to Pinterest.
   Share to Tumblr.
   Email link.
   Embed code link.
   Accounts may be pre-populated to users accounts based on what information they have provided in settings for social log-in links.
End cards:
   Customizable end card with image, clickable link, and link text.
   Modify the end-card of clips at any level. This can be set to affect the end-cards of published clips and/or future clips.
Advertising.
Integration with third party ad servers (e.g., FreeWheel, Google DFP).
Metrics Reporting.
Customize account settings for specific channel(s), show(s) and episode(s).
Set rules and restrictions for how Whipclip app users (consumers) can interact with content.
View list of shows available for live clipping.
Browse EPG metadata tree to find shows.
Search EPG metadata to find shows and clips.
Create clip within established clipping rules.
Content owner adds labels to clip.
Content owner sets cover image (thumbnail) for clip.
System attaches EPG metadata—including label—to clip.
System creates embed available for distribution.
Add “sunset clip” setting per channel or show.
System sunsets clips automatically based on channel or show setting. “Sunset” means “clip is deleted from Whipclip”.
System replaces sunset clip with cover image (thumbnail) in embed.

Additional features may include, alone or in combination:
Video views are attributed to the content owner for comScore/Nielsen or other similar purposes.
The content owner's Content Management System (CMS) can ingest clips created on Whipclip, such that the clips can be published on the content owner's site, YouTube pages, etc.
API to export user data to Content Owner's own data warehouse.
White label integration for Content Owner's own sites/apps (Using the embed widget).
Ad server integration with Freewheel.
Ability to feed Whipclip specific timecodes via API to create specific clips from their existing segments.
Giving partners the software to store feeds on their premises (if the partners are concerned about control, particularly from a rights perspective).
Adding lightweight editing tools like graphics, dissolves, etc. to help particularly with sports clipping.
Making the process of blacklisting specific shows possible via API, so for example a sports league with hundreds/thousands of games could apply rules quickly or at scheduled intervals.
Viewers who are not allowed to see a specific clip don't see that clip in their feed.
Ability to send Whipclip files of shows before they air, so a partner can pre-clip moments they know they want clips for.
When creating a clip from search, the auto-populated transcript text can be removed easily (simple X-out).
Ability to ingest and clip libraries of VOD content as files, not as a feed.
Ability to include Omniture tags for tracking views.
Ability to place a tracking pixel when a user views a clip.
Ability to create GIFs.
Ability to deliver EPGs to Whipclip via JSON.
Ability to use APIs instead of embed codes for white label app integration.
Ability to send tweets from Twitter partner platforms (like Hootsuite), instead of from Whipclip.
Ability to schedule tweets/posts ahead of time.
Ability to geotarget restrictively rather than just inclusively (i.e., blacklist certain geos).
Ad stitching.
Ability to add graphic overlays (e.g. lower thirds).
Ability to select a different thumbnail for a clip.
Ability to marry sports game time clock data with video timecode to automate the suppression of the final X minutes of a game.
Ability to limit the number of times a Twitter/FB link works to send a user to the live stream (i.e., prevent people from clicking on same link over and over to keep accessing the live stream for free).
Ability to limit the number of times the “clip live” link works (i.e., prevent people from clicking on “clip live” over and over to keep accessing the live stream for free).

### 3.1 Accessing the Partner Portal

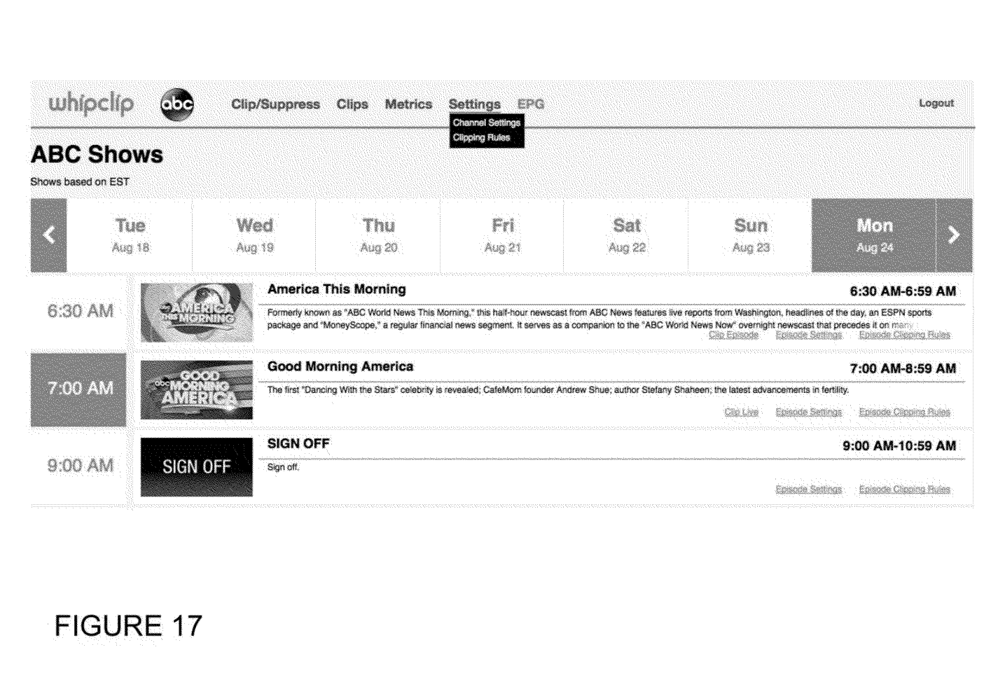

The Partner Portal is accessed via web-based tool. Accounts for the team members of the content partner may be created. In addition, permissions and access rights to the partner content may be granted. FIG. 17 shows an example of a web-based tool available to the partner portal. Partners may access their own customized tool, in which the schedule of their upcoming and past program may be displayed. From the main menu header, different settings are available as described in the following sections.

### 3.2 Settings

The Settings menu, which can be accessed from the Partner Portal main menu header as shown in FIG. 17, consists of two sub-sections:
Channel Settings allows determination of how clips from channel, shows, and episodes will appear to end-users when a clip is created in the Partner Portal or consumers create a clip using the app (e.g., what end card is displayed at the end of your clip). It is also where the content partner can access the embed widget to incorporate clips created from the partner content into the partner website.
Clipping Rules is a sub-menu where rules and permissions that impact how Whipclip app users can interact with specific content can be set. The rules and permissions can be applied at a channel, show, and/or episodic level (depending on the rule).

Within the sub-sections of Channel Settings and Rules for Clipping Rules, settings can be applied to a channel (meaning all shows that air on that channel), a show (meaning to all episodes within a show), and to specific episodes.

A Partner may also select the network logo they want to appear within the app on the overlays of their clips/content. A default logo may be taken from the EPG data.

### 3.3 Channel Settings

### 3.3.1 Channel Level

Channel Settings is where partners determine how clips from their content will appear to end-users (e.g. what end card is displayed, what the tune in message says). It is also where partners may access the embed widget to incorporate clips created from their content into their websites.

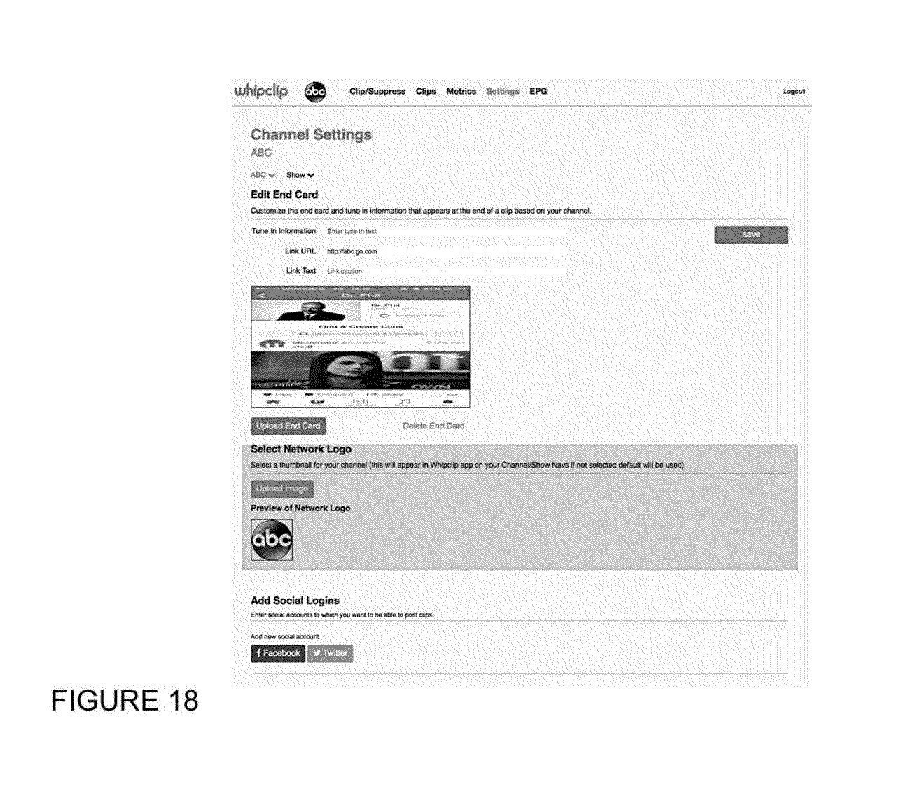

At the channel level, as shown in FIG. 18 there are different settings that the content partner may set in Channel Settings. Social log-in account credentials for Facebook and Twitter may be added and the end-card for the content on the content partner channel may be customized. By default, the end-card settings applied at the channel level will apply to all shows on the content partner channel (and episodes of that show) unless settings for specific shows or episodes have been changed.

Partners may select what end card they want to appear at the end of clips (they may also select the end card at a channel, a show [season] and episodic level). The end card can be created along with the end card messaging. The end card is what users will see after watching a clip. The end card may appear with the following features, alone or in combination:
“Tune-In Information” is what will appear on the first line of the partner end card (example: “Watch [Show Name] on [Network Name]”).
“Link URL” is the destination to which users will be directed to after clicking (example: direct to www.whipclip.com).
“Link Caption” is the readable copy associated with the link (example: “View more great content on Vaiipclip.” and will appear as a line of text under the “Tune In Information” line.
“Upload End Card” allows the upload an image for the end card. The partner may select and upload specific key art. If no key art is uploaded the default may be that the Tune in Information and Link Text (if entered) appears on an overlay on the last image of the clip

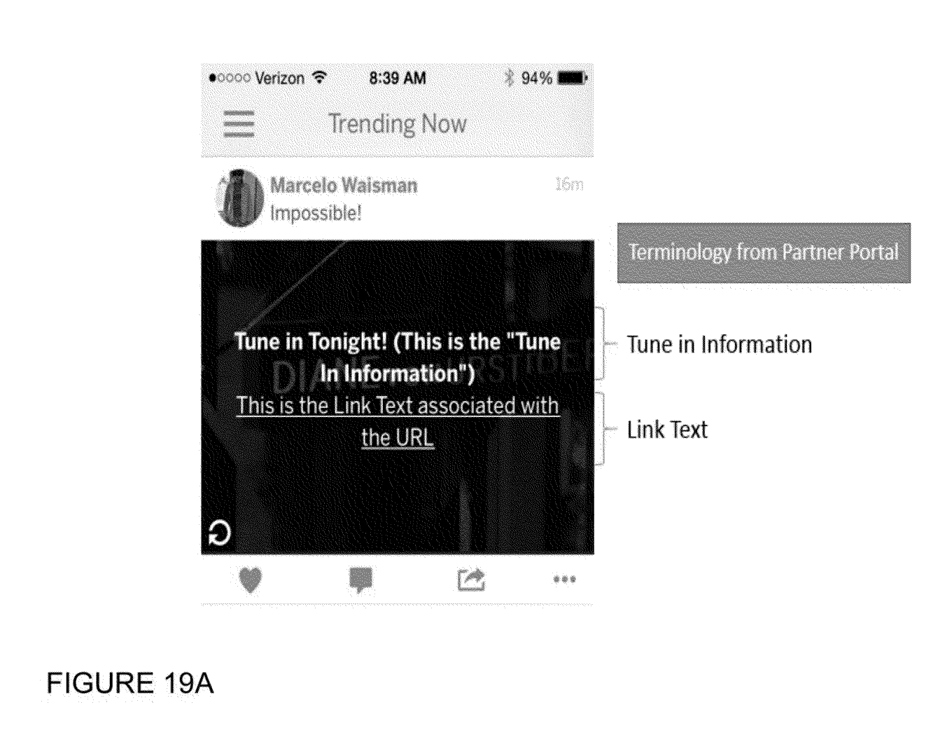

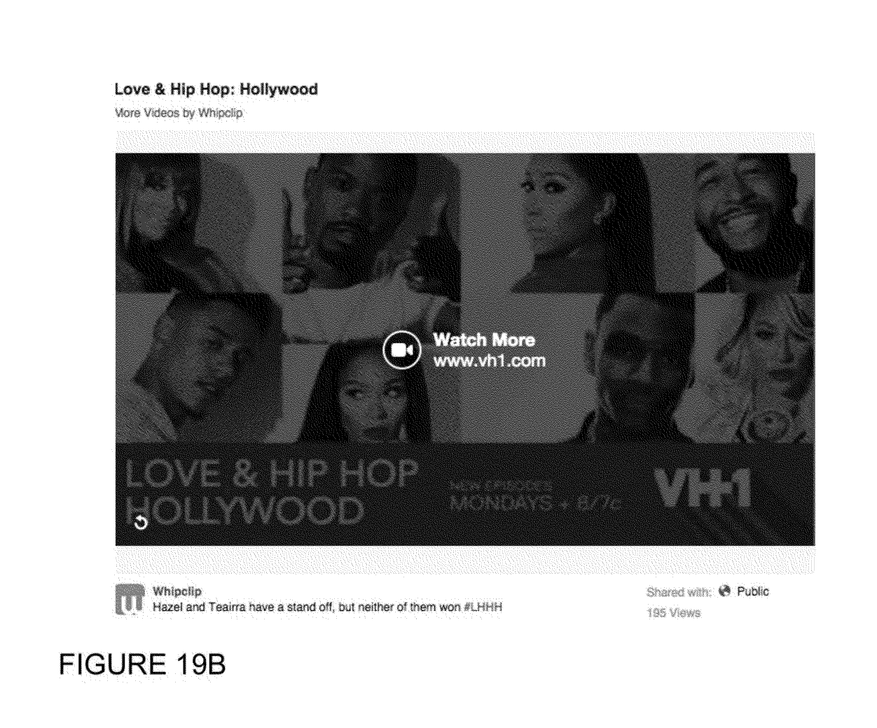

FIG. 19A shows an example of the Tune In Information and Link Text as appeared on the Whipclip app at the end of a particular clip, as previously set by the content partner on the Partner Portal. FIG. 19B shows an example of the end-card display and tune in information when a clip is shared on Whipclip Facebook page.

If no information is entered, the default Tune-in message will say, “Watch {Show} on {Channel}.” This means that all fields are optional. However, a Link URL is entered an associated Link Text is required.

In addition, content owners may also pre-populate their social accounts such as Twitter, Facebook, Tumblr, Pinterest on both a channel and show level so that when they go and create a clip from the Partner Portal they can easily share to the accounts they have pre-populated in Social-logins. These would apply at a channel and show level.

Adding social log-in account credentials for Facebook and Twitter will allow the partner to link to their Facebook brand pages and Twitter accounts such that they can share clips to these accounts from other parts of the Partner Portal. Standard procedures to authorize Whipclip to access Facebook or Twitter accounts may be followed. Whipclip may ask for an approval for an authorization to read tweets, see whom a user is following, and update a profile or post to Twitter on behalf of the user. A Facebook account may also be added and linked to associate the brand pages the user of the Partner Portal may wish to share to. A prompt will appear to allow the Partner Portal to post on behalf of one or more Facebook accounts. All accounts (personal and brand pages) may appear within the Partner Portal. Social accounts may also be removed.

An additional feature that may be accessed from the channel level of the Channel Settings menu is the ability to generate an embed code to incorporate Whipclip clip(s) on to chosen sites. For example, it is possible to create an embed code to embed trending clip(s) from Whipclip on to the content partner own site, with the option to decide for the scrolling to feature 3, 2 or 1 clips depending on preferences and the space available on the website.

A content partner may pre-select a number of features for an embed widget, such as for example:
a. Select if clips are only the clips partners have created from the partner portal or all clips created (users and partner portal clips).
b. Set the layout as either horizontal bar or vertical bar.
c. Select the number of clips the widget includes (3, 2 or 1).

Whiclip also provides the ability to modify the CSS, thus making it easy for partners to add their own customizations. Partner may further be able to select a combinations of shows that are included in the embed widget.

### 3.3.2 Show Level

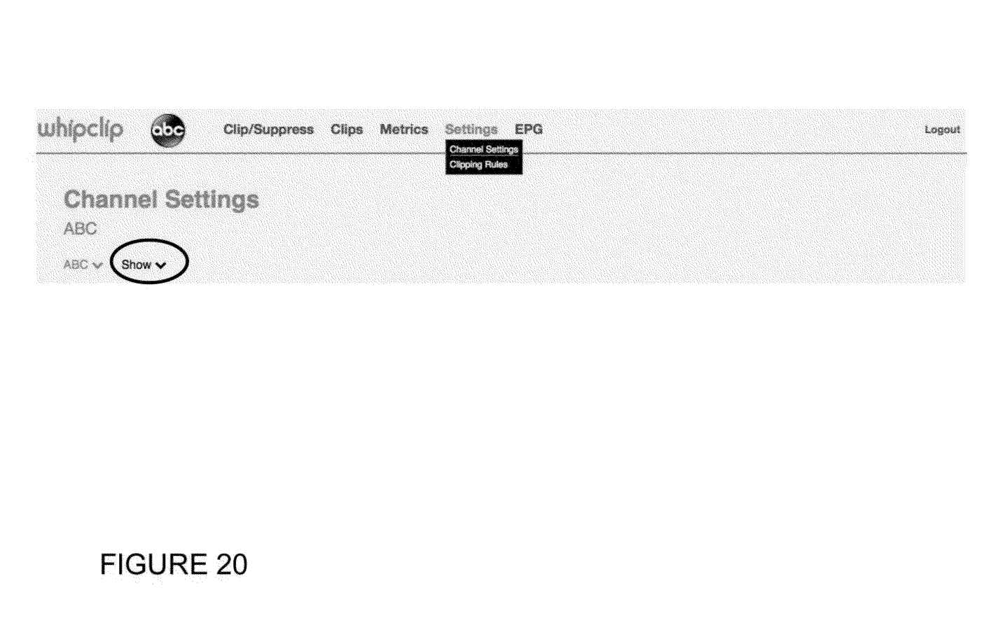

FIG. 20 shows an example of the webpage to modify channel settings, in which the settings for specific show(s) can be modified. In the sub-header, a drop down menu with the word ‘Show’ next to the drop down arrow is available. By clicking ‘Show’, a drop down list with all the available show for the specific channel will appear. All settings created at the show-level will also apply to the episodes within that show. Specific episode-level settings can be adjusted on the episodic level.

Within ‘Show’ settings, settings that can be applied to a show and may be the following:
Create end card messaging for the specific show. This has the same menu options as the channel level, but can be more specific to Tune-in Information for a specific show.
“Tune In Information” is the copy that will appear on the end card (example: “Watch more episodes of Storage Wars”)
“Link URL” is the destination users will be directed to if they click (example: direct to https://itunes.apple.com/us/tv-season storage-wars-season-1/id401446576)
“Link Caption” is the readable copy associated with the link (example: “Download Season 1 on iTunes today”
“Upload End Card” allows to upload an image for the end card (16:9 format for example)
Select a Thumbnail Image for the show (16:9 format)
   The thumbnail image is what will be used to represent the show within the app and may be displayed in the TV Shows tab and Music tab within the app
At the show level, it is also possible to generate an embed code to include clips of a specific show on your website.

### 3.3.3 Episode Level

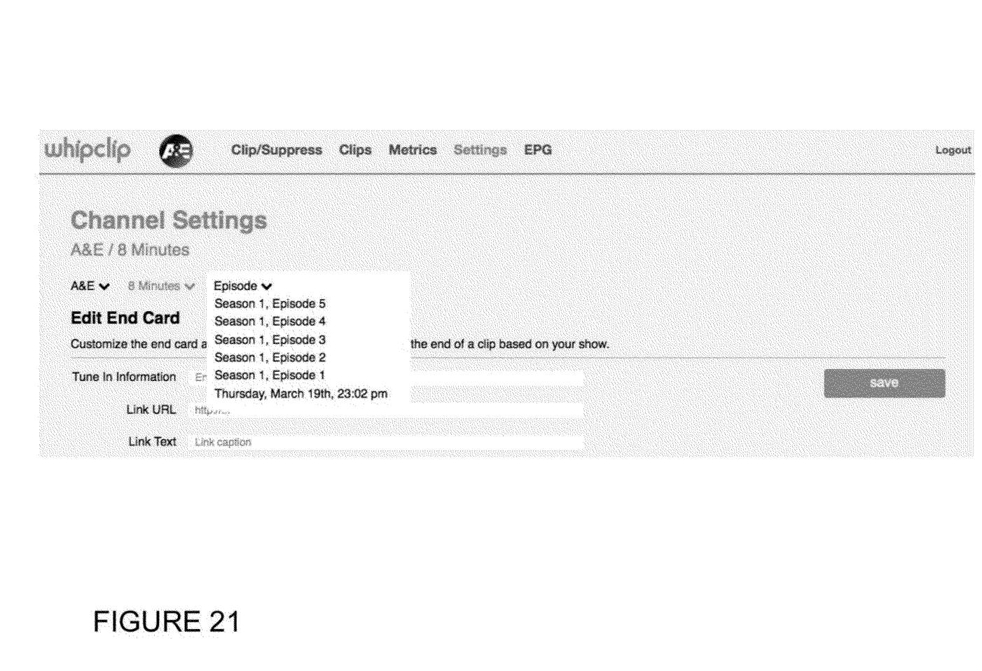

Settings specific to episode(s) within a show can also be set or modified. As shown in FIG. 21, after a Show has been selected from the drop-down menu, another drop-down will appear to select a specific episode within a show and set end-card information for the episode.

All show-level settings will pass down to episodes within a show, or in the case where no show settings were set, then channel settings will pass down to episodes within a channel.

An episode will become available in the Partner Portal prior to its airing, for example 13 days prior to the scheduled airing. Hence, an episode setting such as the end card will be able to be set or modified once it is available in the Partner Portal, which might be prior to the show scheduled airing.

The same menu options as the channel and show level are available, but it can be more specific to a particular episode. An end card for a particular episode can be updated:
“Tune In Information” is the copy that will appear on your end card (example: “Love this episode of Duck Dynasty?”).
Link URL is the destination to which you want to direct users if they click (example: direct to Error! Hyperlink reference not valid.).
Link Caption is the readable copy associated with your link (example: “Watch it again on AETV”).

### 3.4 Clipping Rules

Suppressions can be set in two different places in the Partner Portal. If a partner knows in advance that a portion of a show/season/episode needs to be suppressed on an ongoing basis, they can set those rules in ‘Settings >Clipping Rules’. A partner may want to set specific suppressions to an episode or show, that is either currently airing or has aired or is available in the Partner Portal, using the Clip/Suppress Tool as discussed in Section 3.5.

Within the Clipping Rules section, content partners can pre-set show and episode level suppression rules for all of their content. For example, an episode of a show may become available 13 days prior to its airing and therefore rules for the episode can be pre-set.

Clipping Rules is a sub-menu within the main settings menu. This is where Partners can set rules and permissions that impact how Whipclip app users can interact with their content. The rules and permissions should be applicable to a channel (meaning all of the shows on that channel), a specific show on a channel, [a season of a show]) and a specific episode of a show.

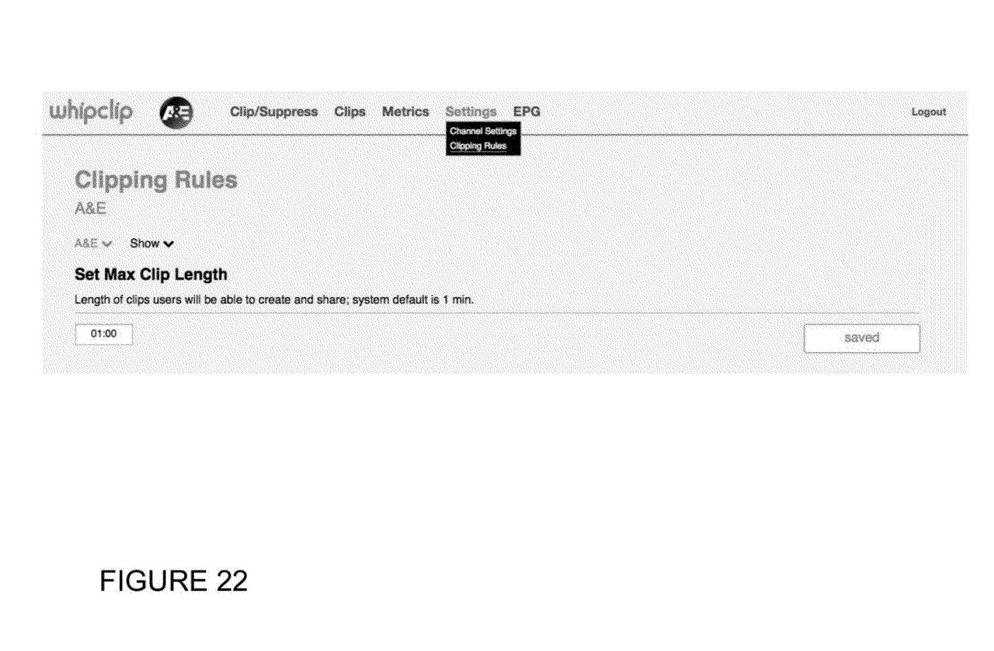

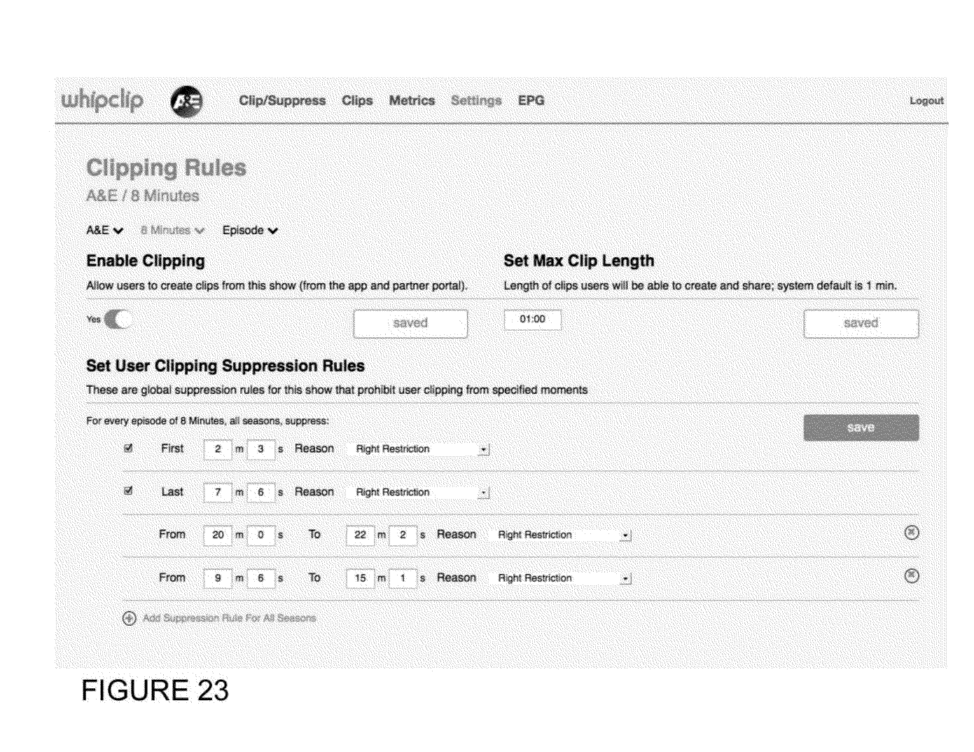

As seen in FIGS. 22 and 23, examples of Clipping Rules for a specific show, or an episode within a show include, but are not limited to:

Enable Clipping:

This is a yes/no toggle that can be applied to the channel (meaning all shows that appear on that channel), or specific shows on a channel, [or specific seasons of a show that airs on that channel], or specific episodes of a show (that belongs to a season/show/channel). Yes means that consumers can see the content in the app and create clips from it. [“No” means that the content should ONLY be available for the content partner to create clips from the partner portal. The clips are not editable from within the app]

Set Max Clip Length:

This is the maximum clip length that app users will be able to create. They will be able to create that clip from 2× the max clip length—padding of 1+ is added to either side of a search term (in the case of getting a result from search). So, if the max clip length is 60 seconds (default), then in the compose screen the user can preview 120 seconds. The minimum clip length is 2 seconds.

### Set User Clipping Suppression Rules

In addition to being able to suppress specific segments of an episode using the Clip/Suppress menu, partners should be able to pre-set suppression rules that apply to specific shows, [seasons of specific shows] and specific episodes of shows. This suppression rules mean that those specified segments are never clippable or viewable. [If a user is watching a show on TV and then tries to create a clip from a segment that is suppressed, they should see a message that “Due to Content Rights restrictions this segment is not available for clipping. Create a clip from the most recent {2} minutes of the show that have been cleared for clipping” (similar to Commercial Break Mess aging)].

Additional settings include the following:

Timezone Blocking for Clips

This is a setting/rule that impacts when a clip will appear within the app based on what timezone they are in. Outside the app (meaning on 3rd party platforms) it impacts whether or not the clip will be playable based on users' timezone. Yes means that clips created from content on this show that have not yet aired in a consumer's timezone will not be playable until that content has aired locally (i.e. it will be blocked). No means that the clip will still be playable, but will have a warning “This clip has not yet aired in your timezone” before the clip starts playing.]

Expire Consumer Clips

Partners can set sunsetting rules for clips that consumers create (meaning that after the specified date clips created from a channel/show or episode) will be viewable. In our app the posts should be suppressed so users don't see posts where the clip will not play. On 3rd party platforms (facebook, Twitter) the messaging should be that “This clip is no longer available due to a content restriction imposed by {Channel Name}”].

Suppression rules may also prevent the content from content owners from being clipped by both consumers using the app and partner using the Partner Portal. If a suppression rule is set after a content/show/episode has aired, any existing clips form the content/show/episode will no longer be viewable.

In the Whipclip app any posts previously created from content that has later been suppressed will disappear. On third party platforms, such as Facebook or Twitter, the posts will be visible, but the associated video will no longer play and a message will appear saying, “This clip has been removed by the Content Owner.”

In addition, partners may also select a reason for suppressing a clip. Choices may include “Rights Restriction” or “Spoiler Alert”. The reasons for suppressions may also be stored on the backend such that trays of suppressed segments from channels/shows/seasons based on reason for suppression] can be re-surfaced at a later time. An option may then be chosen such as “Suppress Clip” to confirm.

### 3.4.1 Channel

At the channel level, as shown in FIGS. 22 and 23, a high level rule of maximum clip length can be set. The clip length set will apply to all shows for a channel unless settings for particular shows at a show level has been changed.

Max Clip Length is the maximum length that consumers will be able to clip and share using the app. The segment time from which they will be able to create their clip will be set to 2× the “Max Clip Length”. Example: If Max Clip Length is set to 60 seconds, a consumer will be able to view 120 seconds of the content and can clip up to 60 seconds from that content to share.

The default clip length is set to 60 seconds (1 minute). In this version of the partner portal, the maximum clip length applies to both how long clips consumers can create from within the app and how long clips partners can make using the Partner Portal.

### 3.4.2 Show

After Rules for Consumer Clipping have been set on a Channel level, rules for specific shows can be set as shown in FIG. 22 and FIG. 23. In the sub-header next to your channel name you will see a drop-down menu with the word “Show” next to the arrow. If you click on “Show,” a list of your shows will appear. All settings created at the show-level will be applied to the episodes within that show. Rules to target only specific episodes from an episodic level drop-down can further be set.

At the show level, examples of rules that can be set are:

Set Max Clip Length
Set User Clipping Suppression Rules for a Show: suppression rules prevent users (meaning both consumers using the app and partners using the Partner Portal) from creating clips from specific time-codes within a show due to issues like rights restrictions or your desire to prevent important moments from being spoiled (“Spoilers”).
The first and last “x” minutes or seconds of a show can be selected to be suppressed. At a show level, this means that every episode of that show will have that suppression.
Specific moments within the show can also be suppressed (e.g. from minute 10:00-12:30, because you know that there are always music rights issues due to live performances during that two-and-a-half minute block).

The time codes displayed are currently for the broadcast timing, such that if the content is 22 minutes and airs in a 30 minute time-slot and the last 2 minutes of the show need to be suppressed, the timing for the suppression rules should be set from 28:00-30:00. As another example, if minutes 10-12 are to be suppressed, the time for ad-breaks also may need to be taken into account. The start of episode {+ad break time} may need to be accounted for in this case.

### 3.4.3 Episodes

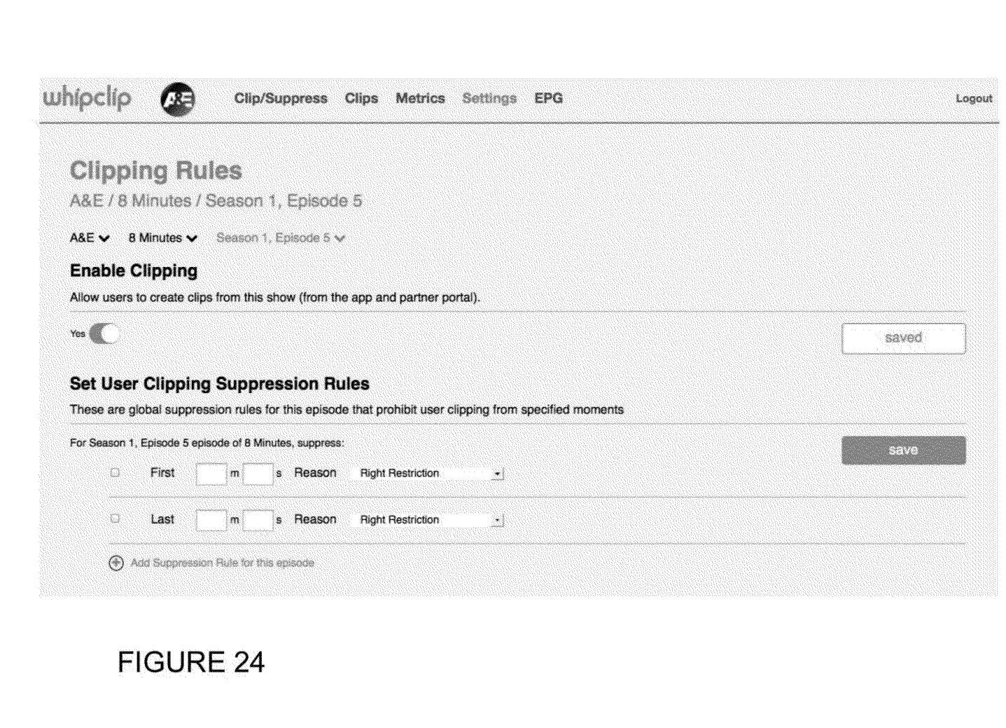

The rules set for Max Clip Length at the show level will apply to episodes within that show, as shown in FIG. 24. Pre-set additional Suppression Rules that will apply only to specific episodes can be set. At the episode level, an example of rule that can be set is: Set User Clipping Suppression Rules for an Episode: for example, the first and last “x” minutes and seconds of the episode can be selected for suppression. Specific minutes and seconds within an episode can be selected for suppression as well.

The suppression rules that were set to the entire season will impact every episode within that season.

### 3.5 Clip/Suppress

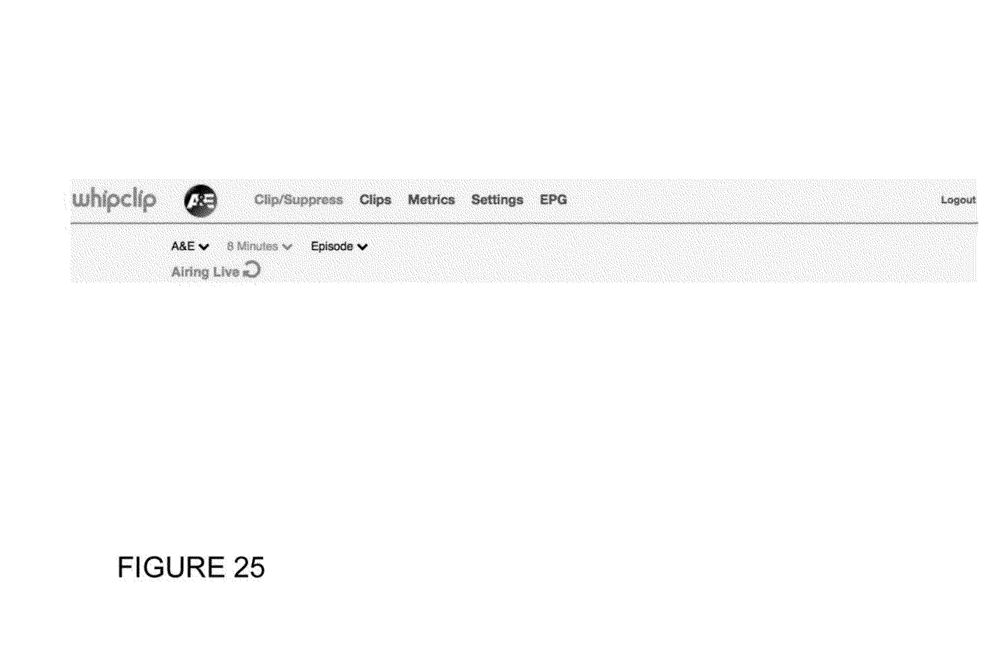

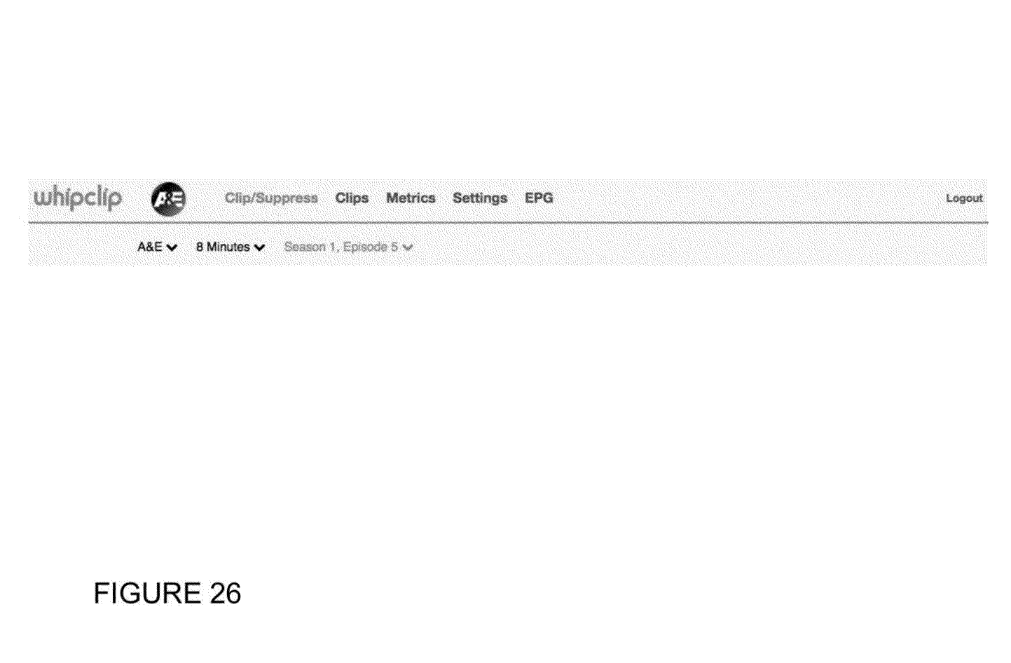

From within the Clip/Suppress menu, partners can navigate to a specific episode or program that is either airing live or has aired in the past to create and share a clip or suppress a specific segment. If a channel currently has something airing live, the live program will be pre-populated when the Clip/Suppress tab is entered. If the program is airing live, there will be an “Airing Live” indicator and a refresh button that allows updating of the feed, as shown in FIG. 25. FIG. 26 shows an example of the feed when no ‘airing live’ show are currently available.

Suppressing segments may also expire the underlying media from within the Whipclip ecosystem, meaning that users (both consumers using the app and you the Content Partner) may not be able to clip from that segment. Any existing clips that were created from that segment may no longer be seen in the Whipclip app. For clips that were created from that segment and shared to a third party platform like Facebook or Twitter, the video may not play and be replaced with the message “This clip has been removed by the Content Owner.”

### 3.5.1 Navigate

If a partner has a show that is currently airing live (default is EST) and that program has been cleared for clipping (i.e. the rights have been granted by the content owner to enable the content for either Consumer Clipping in the app or Content Partner clipping in the Partner Portal) and the user clips on “Clip/Suppress” in the main header, the clipping tool opens with the Live show populating the portal. The “Channel”, “Show” and “Season & Episode” (or “Original Air Date” if the Show is one that does not have a defined “Season & Episode”) drop-downs are automatically populated with the information for the live show.

If the partner does not currently have a show airing live, the video frame is empty with messaging to select an episode by using the drop-down navigations

A partner can select an episode of any Show/Season/Episode that has been approved for clipping by using the drop-down menus in the header. Partner must select a “Channel”, “Show” and “Season & Episode” to navigate to a specific episode to create a clip from.

### 3.5.2 Selecting a Segment (to Clip or Suppress)

Once the program to create a clip from has been selected, the media will appear within the preview panes. For a previously aired program, the entire program timeline may be seen (e.g., a 30-minute program will appear as 30 minutes, an hour long program will appear as 60 minutes). For a currently airing program, what has aired up to the point that the page was entered or refreshed may be seen. For example, if the page was entered at 7:10 PM for a program that began at 7:00 PM, 10 minutes of available media may be seen. If after 2 minutes on this page, the orange refresh icon has been clicked, 12 minutes of media may be available.

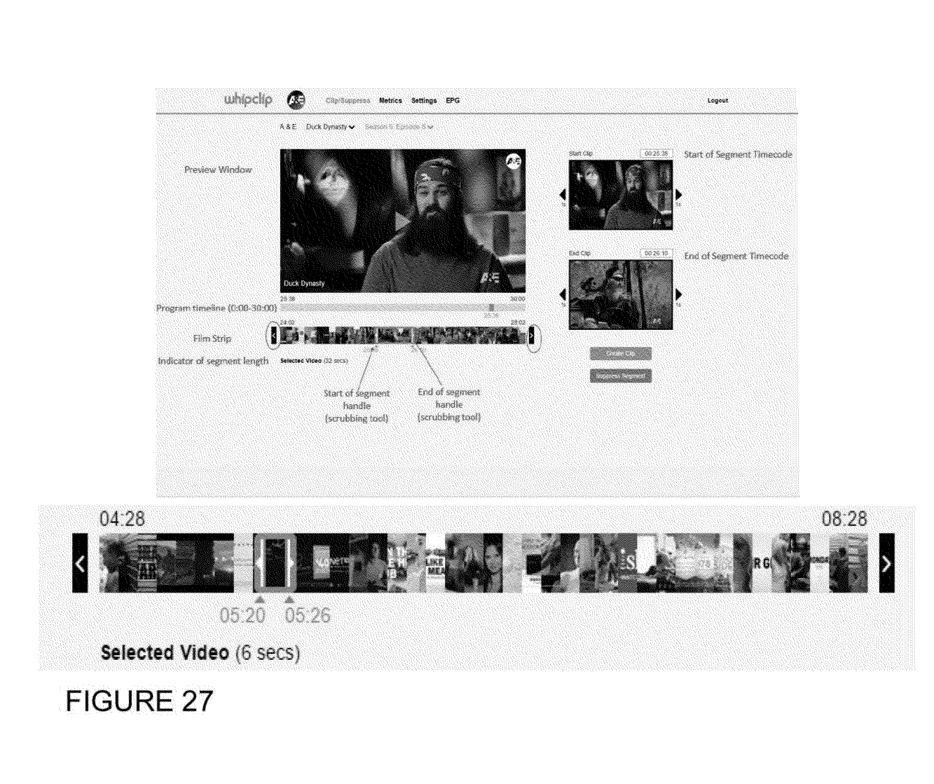

An example of the Clip/Suppress feed is shown in FIG. 27, with the following annotations:

Preview Window: the thumbnail that corresponds to the starting frame of the segment selection. This is also where you can preview your selection by clicking the play icon.

Program Timeline: a timeline representing the length of the program. The orange bar indicates where within the program timeline your selection is.

Film Strip: this is a more granular sub-segment of the program timeline from which segment may be selected (to clip or suppress). The arrows on the end of the Film Strip allow moving forward and backward within the program.

Scrubbing Tool: an adjustable orange rectangle in order to select a segment from within the film strip. The scrubbing tool has a left handle that can be dragged to change the start point of the segment and a right handle that can be dragged to change the end point of the segment. The entire scrubbing tool can be moved along the film strip by clicking and dragging the top or bottom orange bars:
The maximum width of the scrubbing tool corresponds to a pre-set maximum clip length (default 60 seconds).
The minimum clip length is 6 seconds and represents the “smallest” the scrubbing tool can go (see above).

Start and end times of a segment may be selected by, for example:

Entering the timecode

If an exact timecode for either the start or end of your segment is known, the Start and End timecodes can be entered in to the fields on the right-hand side of the portal (in hh:mm:ss format). Entering one of these fields will automatically update the Preview Window, the Film Strip and the Scrubbing Tool.

Timecode may correspond to the broadcast time not the underlying content, meaning it includes advertising and promotional breaks.

Using the Scrubbing Tool on the Film Strip

Film Strip may be updated by either using the left or right arrows at the end of the film strip or by clicking on the grey part of the Program Timeline to get to the approximate time period that needs to be selected. The scrubbing tools can then be used. Partner can scrub the start and end points by clicking the arrows to the right or left. The points may be scrubbed at a sub-second frame-rate level.

Once a segment is selected, it may be further refined the Start point by one second (forward or backward) by clicking the left or right arrows on the right hand side “Start Clip”. Using the left or right arrows on the right hand side may also refine the End Point.

### 3.5.3 Create and Share Clip

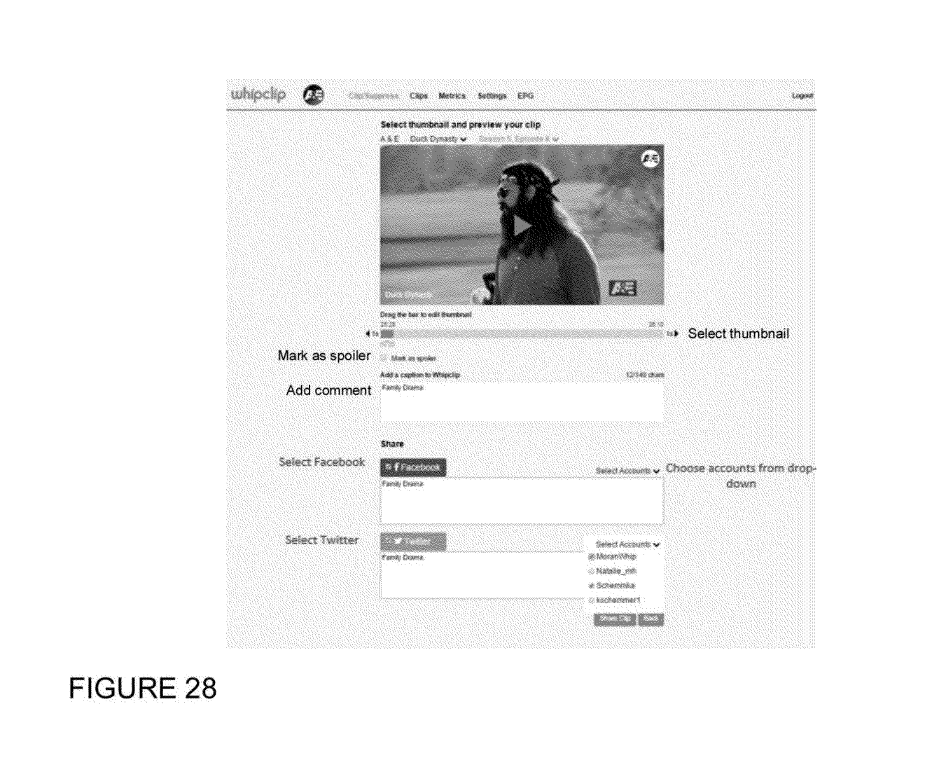

After selecting a segment, the green “Create Clip” button may be clicked in order to view another window where customization of the clip may be done, as shown in FIG. 28, with the following features:

### Customize Clip:

A thumbnail image may be selected from the different frames from within the clip (preview the images by hovering on the grey bar). Users may also be warned that this clip might be a spoiler by selecting the “Mark as spoiler” box. This will put, for example, a dark overlay over the clip with a red warning “Spoiler Alert” in the top corner, so that fans that do not wish to see a spoiler are appropriately warned. This view may also be updated within the preview screen and when partner shares the clip it has the dark overlay and spoiler warning on it.

### Add a Comment (Required)

Partner can then “preview” the clip. Partners may preview clip along with the end card that is based on the end-card settings they have created for this particular Episode in Settings.

### Share Clip:

After a thumbnail has been selected and a caption entered, additional third party sites such as social accounts like Facebook and Twitter may be selected for sharing, as seen in FIG. 28. If nothing else is selected after selecting ‘Share Clip’.

### Sharing to Facebook and Twitter:

Select which Facebook and Twitter accounts to share the clip to. (Please note these are the accounts that have been authorized in Settings>>Channel Settings at the channel level.) Once the checkmark next to Facebook and/or Twitter is selected, specific accounts may also be selected from the right dropdown menu.

### Additional Sharing Options

Further sharing options may include, but are not limited to:

Share to Pinterest

Copy Embed Code

Copy Link to Clip this can be sent via e-mail

### 3.5.4 Suppress a Clip

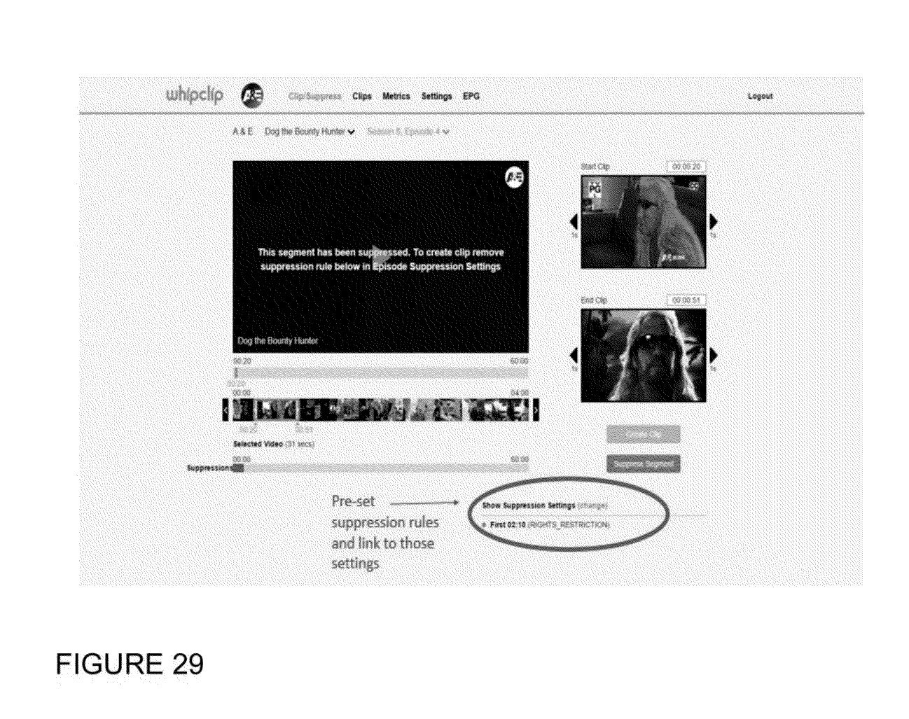

Similarly that a segment may be selected in order to create and share a clip, a segment may also be selected for suppression, as shown in FIG. 29. Any pre-set suppression rules (set in Clipping Rules) may appear under the filmstrip as suppressed. These rules will be listed below the filmstrip. A link to the pre-set rules will direct to the Clipping Rules where pre-set suppression rules may be removed or changed.

Suppressing segments may expire the underlying media from within the Whipclip ecosystem, meaning that users (both consumers using the app and you the Content Partner) may not be able to clip from that segment. Any existing clips that were created from that segment will no longer be seen in the Whipclip app. For clips that were created from that segment and shared to a third party platform like Facebook or Twitter, the video will not play and be replaced with the message “This clip has been removed by the Content Owner.”

### Suppressing Additional Segments

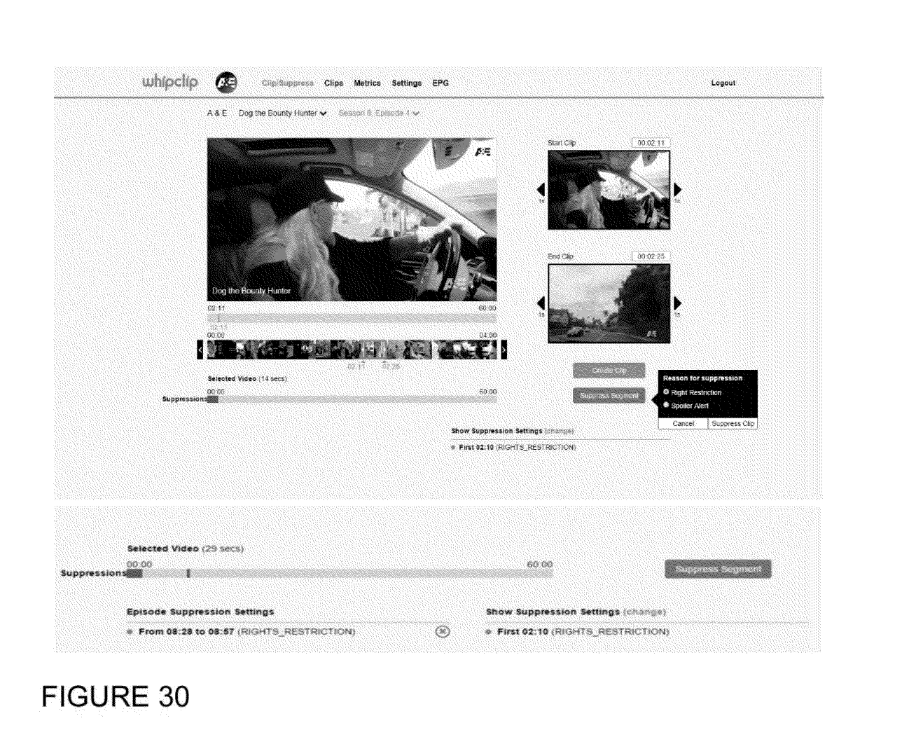

Either the time codes on the right-hand side of the page may be used or the film strip in order to navigate to a specific segment of a program as seen in FIG. 30. Once the segment to suppress is selected (represented by the content within the orange bars on the film strip) “Suppress Segment” can be clicked to suppress that specific segment. A reason for the suppression will be asked (for example, Rights Restriction or Spoiler). This information may not be viewable to end-users in the app, but may helpful for the Support Team to understand Content Partners' different needs.

As soon as the particular segment is suppressed, the rule may appear as an Episode Suppression Setting on the Clip/Suppress page. Suppressions may be removed by clicking on the corresponding orange X.

Once a segment is suppressed, the results are:
The exact timeframe that is defined as suppressed may be suppressed. Or the entire minute that is included in the segment may be suppressed: Example: if I suppress 4:58-5:04 then the entire minute of 4:00-4:59 is suppressed AND the entire minute of 5:00-5:04 is suppressed.
Behavior once a segment has been suppressed:
   In the app: the suppressed media context cannot be searched/previewed/clipped by users. Any previously existing posts created from that media context no longer appear in users' feeds (Trending Now or My Feed) EXCEPT for the clip creator's My Feed. For the Clip Creator they can still see the post, but the clip does not play and there is messaging “This clip is no longer available due to a content restriction imposed by {Channel Name}”. A notification may be sent to the creator of a suppressed post that “Due to {rights restrictions/spoiler} your clip has been suppressed” sent to Notifications.
   If suppression is removed, the post re-appears in the app feeds. A notification may be sent to the creator if a clip is unsuppressed.
On third party platforms such as Facebook/Twitter if a user tries to play the clip the clip does not play and a user sees the messaging “This clip is no longer available due to a content restriction imposed by {Channel Name}”. If the suppression is removed, the media is restored to the clip.

### 3.6 Clips

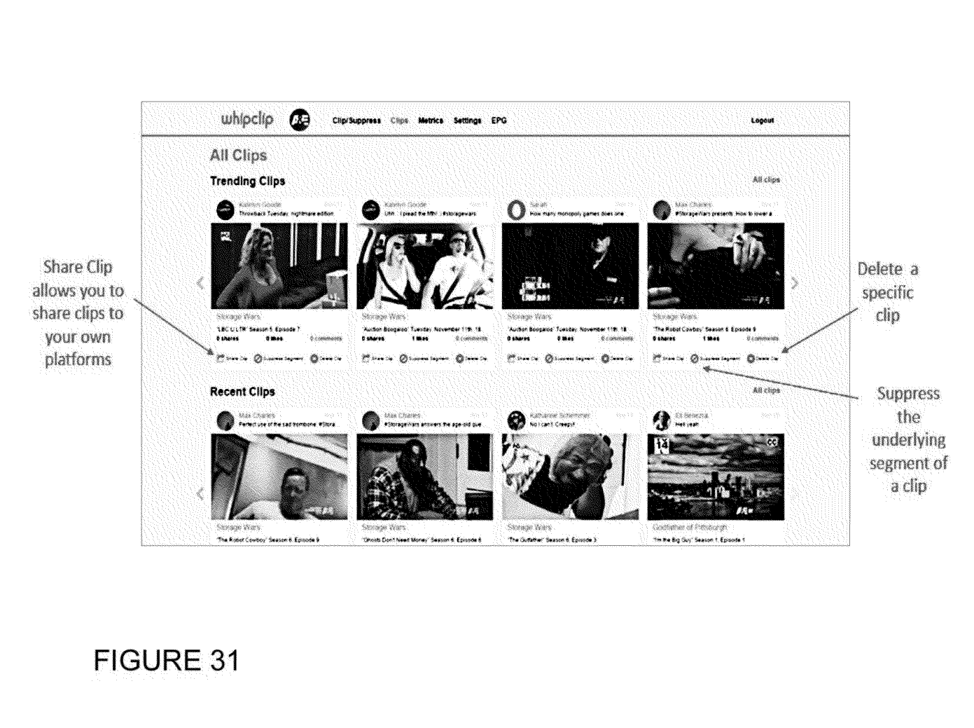

This is the section of the portal where partners should be able to view clips created from their content as shown in FIG. 31, where partner may be able to:
share clips (e.g. share user's clips or share their own clips to additional platforms like facebook)
   share user-generated clips to social accounts. The clip will include the original creator's picture and comment.
   share clips partners have created to additional social platforms.
suppress or delete a user post (i.e. the post is no longer visible to users).
suppress the underlying media segment (meaning making a full suppression of the content if needed) (this may be a global suppression for the underlying content that may then appear as a suppression rule. Nobody may be able to create clips from this segment and previously created clips may disappear from within the Whipclip app and no longer be playable on third party platforms (e.g., Facebook or Twitter).
remove or edit comments in a thread of a post.
Delete a clip: deleting a clip applies to only that particular post, meaning that the post may vanish from within the Whipclip app. On third party platforms, the post may remain but the video may no longer be playable.

In this version of the Partner Portal the clips that are displayed will be from all of the partner shows available on Whipclip. Navigation to specific shows and episodes may also be possible.

At MVP—the minimum requirement is that Whipclip employees and partners may review any clips that have been flagged as inappropriate or spoilers and be able to either remove the flag and unsuppress the clip or suppress posts that are problematic (due to bad user comments/language, etc.—see Moderation part of document)

The clips page should be navigable by Partner Clips, User Clips and All Clips. From within the Clips tab, partners should be able to navigate to see All clips from All shows on their channel, or to specific shows and specific episodes of shows.

Clips from the selected content should be displayed in trays based on:
Most Views
Most Shares
Most Likes
Most Comments
Clips that have been “deleted” (meaning the content partner or Whipclip decided that the post should not be viewable) or suppressed (meaning the clip was created and then the underlying media was suppressed).

Content partners (and Whipclip) may search for specific words or usernames to navigate to posts that contain those search terms in either the User Caption or User Comments (or the User himself).

### 3.7 EPG

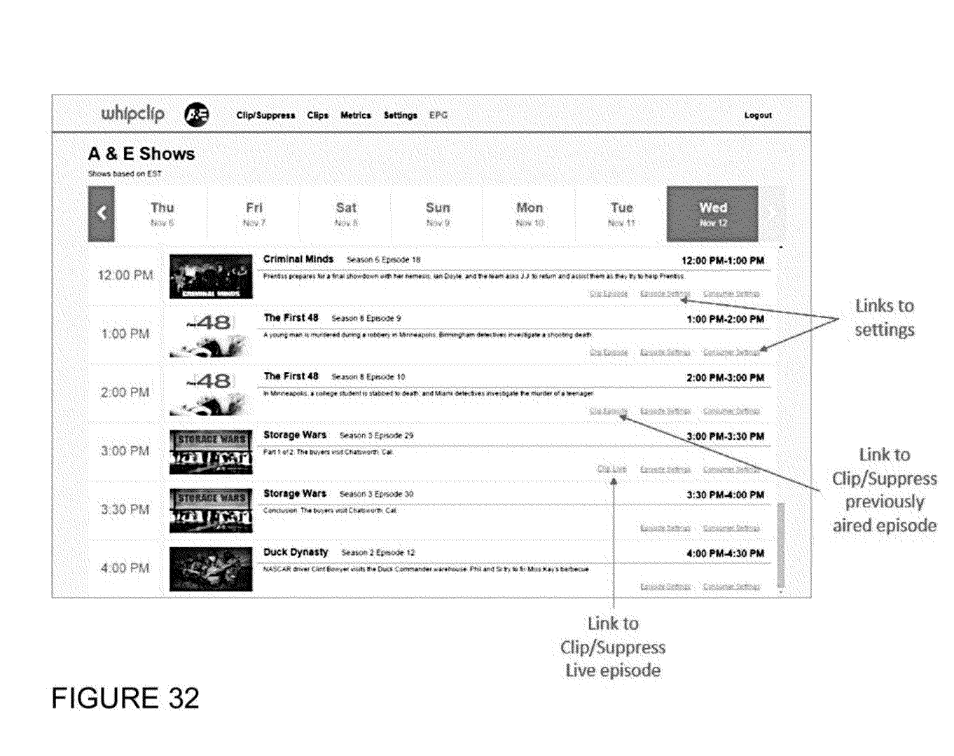

The EPG, as shown in FIG. 32, is where content partners can view the upcoming and past shows from their channels. Shows that have not been approved for consumer clipping have an overlay over them that are dark. From within the EPG, it is possible to navigate to:
An episode's settings (where you can edit the end card information for that episode).
An episode's Rules for Consumer Clipping (where suppression rules for this particular episode can be set).
Clip episode (if the episode has already aired or is currently airing live).

The EPG (Electronic Program Guide) provides the last four-week's of programming information and the upcoming 13 days schedule. The EPG can be used as a navigational tool through which partners can find the shows approved for clipping based on schedule. The EPG and the Partner Portal are always set to Eastern Standard Time. This enables to ensure that the first airing of a show is seen so that a clip and suppress from an episode's premiere can be set.

For episodes that are airing live or have aired in the past the partner can go to Clip/Suppress (to create a clip) or to Channel Settings or Rules for Consumer Clipping for that episode of a show. The layout also has a few metrics that can be glanced at (number of clips created from that episode, number of views generated from those clips)

For shows that have not yet aired, the partner can navigate to Channel Settings or Rules for Consumer Clipping for that show.

### 3.8 Moderation

Flag foul language in user comments (including user captions) with a profanity filter, so that a moderator can bulk review the comment and the associated clip, and if appropriate:

suppress just that comment.

block comments from a chronic repeat offender.

And build a home for clips flagged inappropriate and spoilers functionality in the partner portal.

A Moderation tab to the partner portal is added that is only visible to Whip admin users (i.e. Whipclip employees with access).

Under this tab there are sub-tabs for:

Comments flagged by profanity filter.

Clips flagged inappropriate by users.

Clips flagged as spoilers by users.

Comments (including user captions) flagged by a profanity filter:
Comments may be listed in chronological order from top to bottom, the oldest un-reviewed comment should be at the top.
Comments may highlight the profanity so it can be spotted at a glance.
Suppressing a comment will hide it from public view, but the user will be unaware.
We display the number of times the user's caption and comment has been suppressed in the past, so the moderator can determine whether they should be banned. Banned users aren't aware they are banned but have their comments auto-suppressed.
After reviewing all 25 comments on the page, selecting Next will tag all comments as reviewed.
Page layout/fields: Comment (with profanity highlighted, hover to see the entire post), Username, number of past suppression (hover to see a list of past suppressed comments), time stamp, link toggle to suppress/un-suppress comment, link toggle to ban user/remove ban.

Clips flagged inappropriate by users:
We list user posts that have been auto-suppressed (when the threshold number of user flags has been reached).
You have the option to review the post and un-suppress it.
Page layout/fields: User caption (with ability to see entire post, including clip, on hover),

Username, number of past suppression (hover to see a list of past suppressed posts), time stamp, link to un-suppress, link to ban user.

Clips flagged as spoilers by users:
We list user posts that have marked as a spoiler (when the threshold number of user flags has been reached).
You have the option to review the post and remove the spoiler alert.
This does not include anything marked as a spoiler by CPs in the PP.
Page layout/fields: User caption (with ability to see entire post, including clip, on hover), Username, time stamp, link to remove spoiler alert.

### 4. SDK

The Whipclip SDK enables content partners to embed certain features of the Whipclip Platform into the content partners own mobile applications (e.g. live TV/VOD apps such as for example HBOGo, Netflix, and Fios TV.) Clips created using the Whipclip SDK also appear in the Whipclip Mobile Application.

The key features of Whipclip SDK include:

SDK to integrate user clipping and sharing from partner's content on the app
Embed code to integrate clip search
Search partner's content (keyword search)
Search clips created by the partner
Search clips created by users from the partner's content

Embed code to serve trending clips
Serve trending clips from specific network
Serve trending clips from specific show

### 4.1 First Time Users

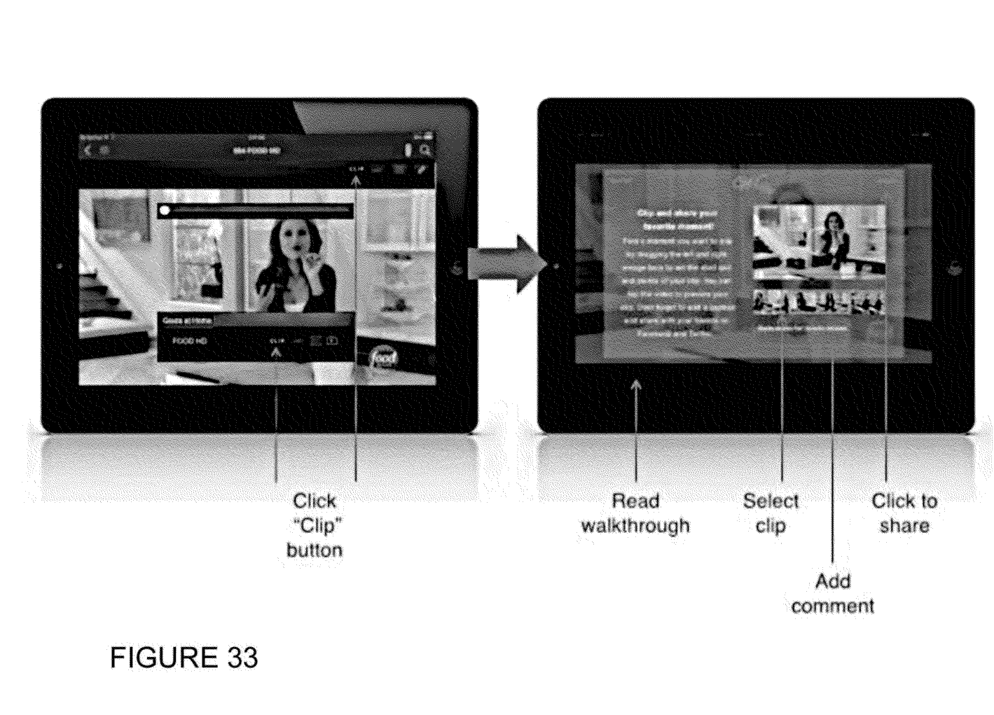

Clip as Shown in FIG. 33:
Within the (Fios TV) app you will see a “clip” button available to select in the player.
Selecting “clip” will present the clipping tool with a short walkthrough of how the clipping tool works.

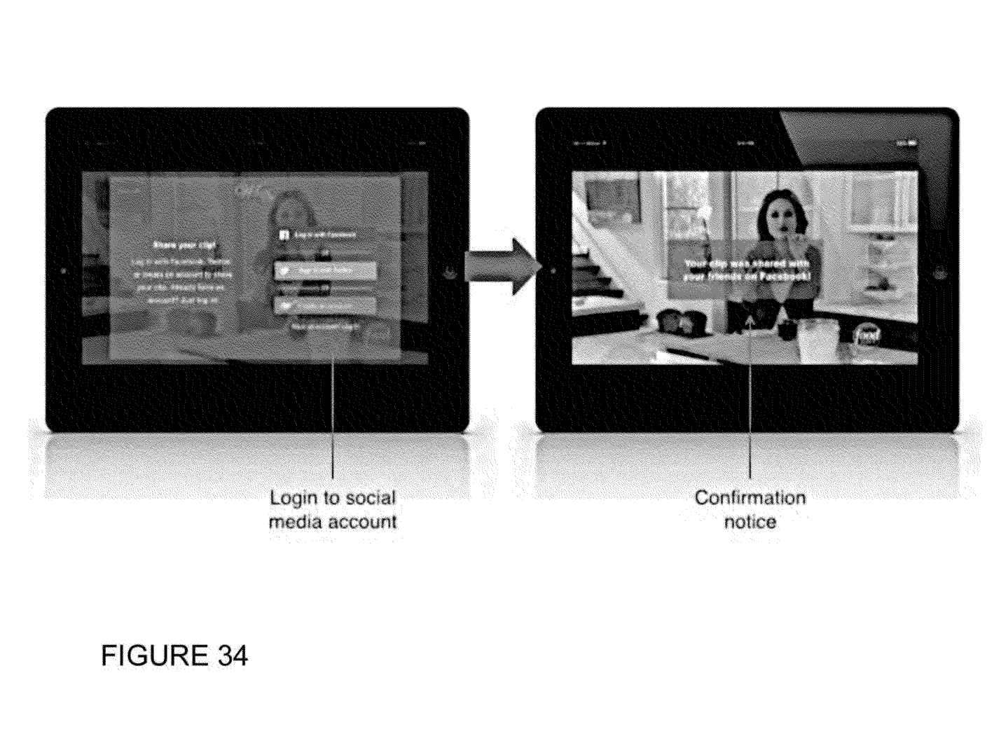

Share as Shown in FIG. 34:
After creating your clip, you will select the “share” button.
You will see a new window asking for your login credential, there are several ways to login.
You will receive a confirmation message that your clip was shared over the your desired social networks.

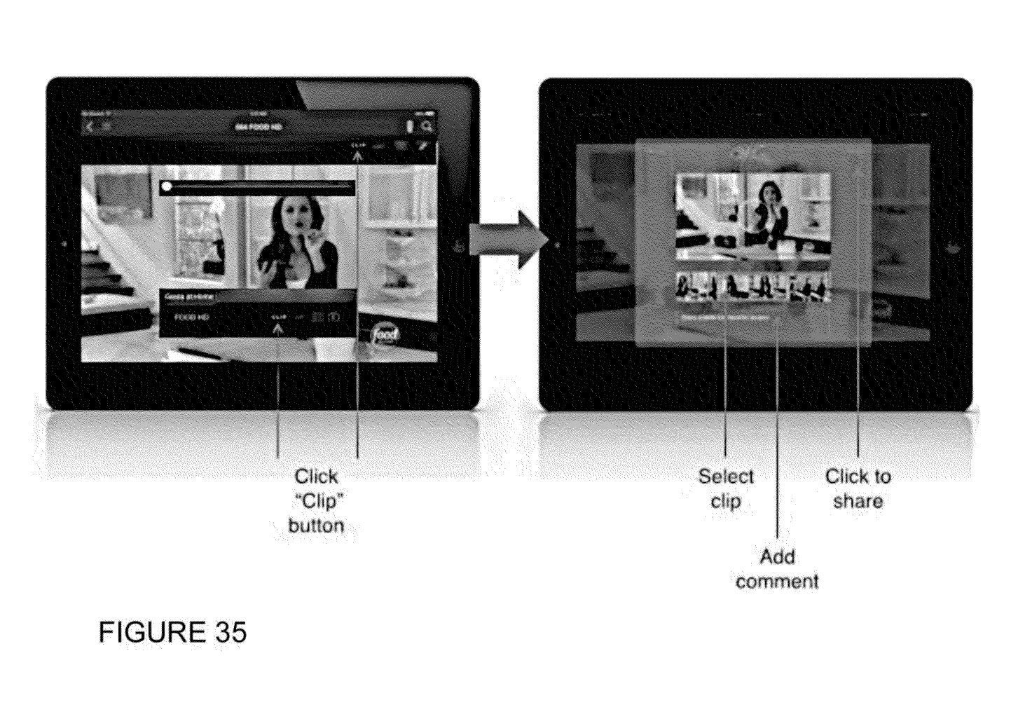

Selecting the Clip Button as Shown in FIG. 35:
Selecting “clip” will present the clipping tool. Once the section of the video is selected for clipping, a comment may be added and the clip may be shared.

Selecting the Share Button:
Selecting “share” will prompt you to share on your connected social networks.
You will receive a confirmation message that your clip was shared over the your desired social networks.

Once the clip is shared to a social media platform there are several opportunities for promotion:

### Show Name and Network Bug

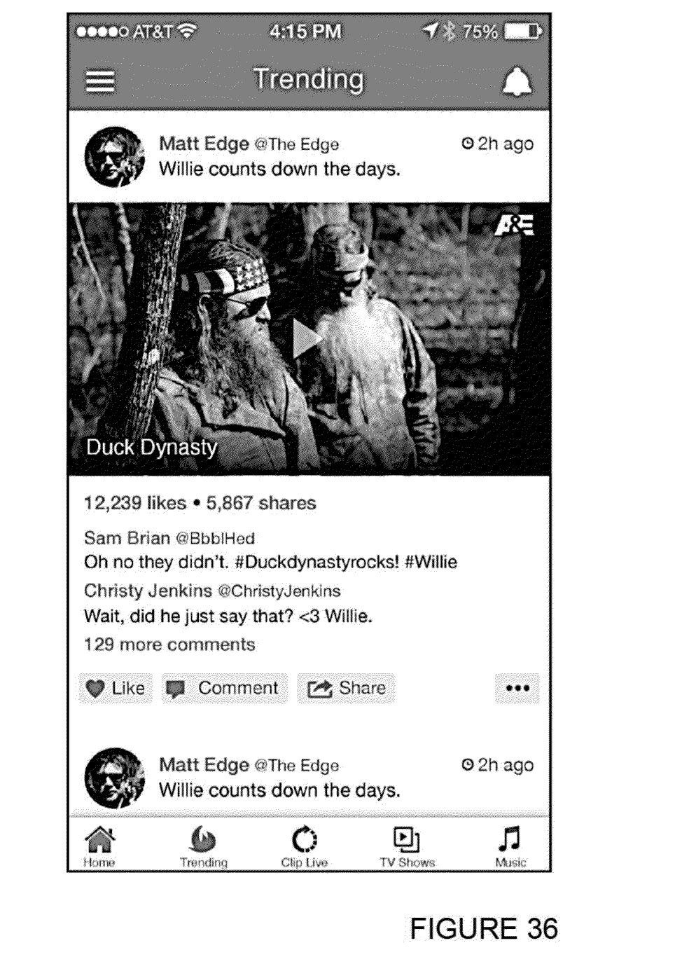

FIG. 36 shows a clip as displayed within the Whipclip application. When a clip is displayed or when it is played, the network logo may be present in the top corner of the screen. The show name may be listed below the clip.

### Branded Billboards

Before the clip begins to play there could be a branded page promoting the sponsor of the clip.

### Clickable End Cards

You can click the end card and get directed to a pre-specified destination.

### 5. Back End Architecture

The back end architecture establishes a system that allows content owners to prevent (suppress) clipping and/or viewing of specific parts of the video. The suppression can be done either in real time during the initial airing of the video, or at any later point in time, even if clips were already created for the parts of the video that should be suppressed. The content suppression ensures that no additional clips can be created on the suppressed content, and any clip that was already created cannot be viewed as long as the suppression is in effect. The back end architecture also establishes the system that provides the efficient storage of the media metadata, and that enables the realtime creation of clips from these videos. The storage also facilitates playing and searching the clips under dynamic constraints that can be added to the media metadata after the clip is created.

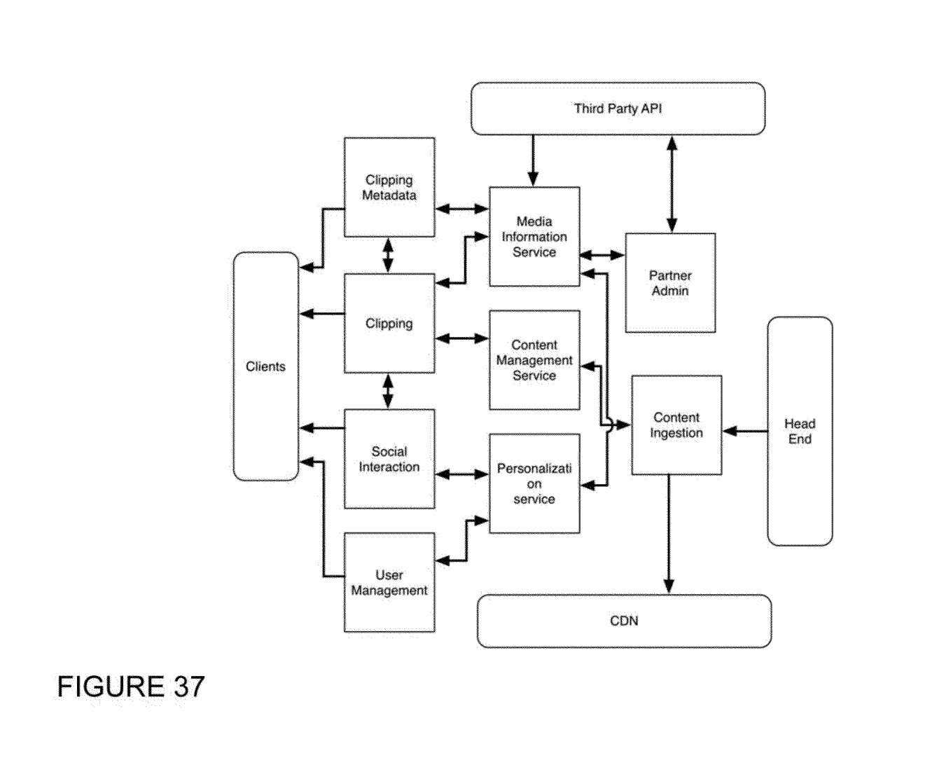

FIG. 37 is a diagram of the high-level functions and components of the system.

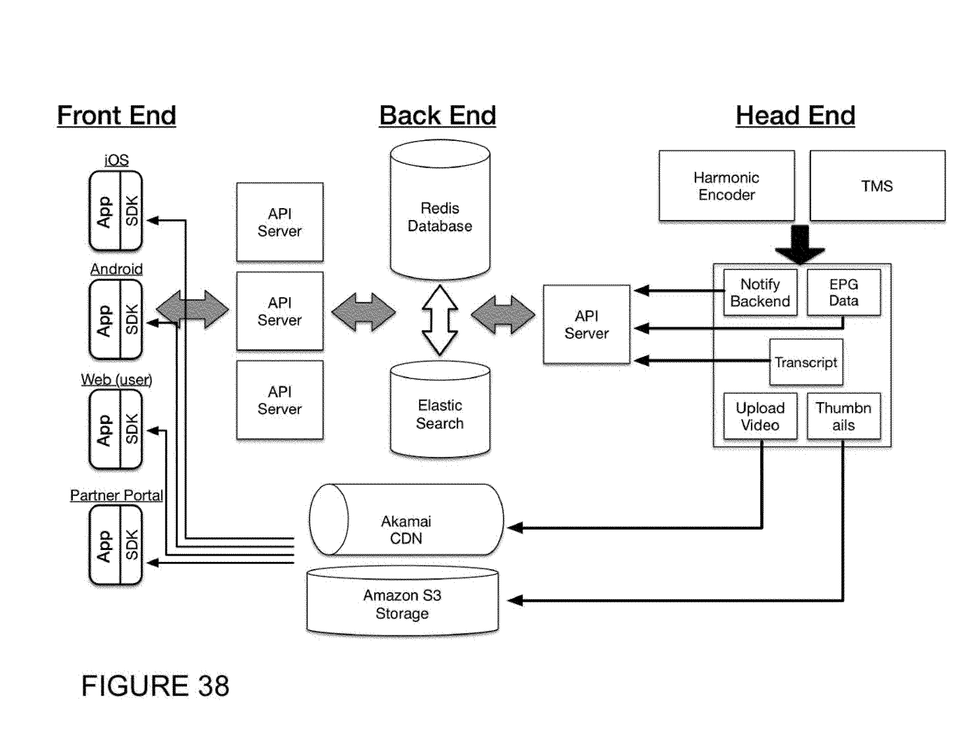

FIG. 38 shows a diagram of the system architecture.

Several new methods and systems have been created in order to allow users to share TV moments legally and in order to allow content partners to control the properties of the TV moments being shared. These methods and systems are described in details in the next sections.

### 5.1 Media Context

A media context is a token issued by Whipclip Backend APIs that temporarily grants access to a limited time window of recordings of a specific channel/show. Media contexts are issued for short clips only. There is no continuous access allowed at any point.

User devices can get access to video files or other media only by presenting a valid media context to media APIs of Whipclip Backend. Whipclip servers can verify the authenticity of a media context by examining a cryptographic keyed hash digest embedded within the token, generated based on a secret known only to Whipclip servers.

In exchange for media contexts, Whipclip servers then return a fixed HLS playlists that contain secure, token-protected and time-limited URLs referencing video files in the cloud storage and CDN.

User devices can obtain media contexts, but never for arbitrary time ranges. The rules for obtaining media contexts are outlined in the next section.

### 5.2 Access Control

Whipclip media contexts are comparable to access control licenses: they are signed documents that specify content rights within a given channel/show and time range of recordings under certain limitations (e.g. expiration time).

Whipclip Backend servers can further implement a variety of access control features by denying access to media contexts, or by granting access to further restricted media contexts. For instance, selective blackouts can be implemented based on various criteria, such as geo-location etc.

Media contexts and the solution presented in this invention allow meeting the design goals listed above. Future device types implementation will be supported by current architecture

### 5.3 Obtaining Media Contexts

User devices can obtain media contexts for the following entities:
Posts short clips created by users. Posts are accessible to other users via various leaderboards, news feeds and search results. In such case, the media context corresponds to the time range selected by the author as part of the clipping process.
Program excerpts time range short clips returned by Whip Servers as search results. In this case, the media context will be provided for approximately the time when the text spoken during the program (the closed captions) matches the search query terms. For search results that are matched based on data other than closed captions, the media context will cover the first 1, 2 or 3 minute(s) of the program.
Near-live excerpts short clips just recorded from the live feed, used for clipping new posts.
In all three scenarios, the user has no control over the start and end times covered by the media context.

### 5.4 Vulnerabilities and Mitigation

There are two major potential vulnerabilities. User devices need the help of Whipclip Backend API servers to get secure, token-protected URLs to video files. However, can the API be abused to get access to complete and unlimited content? This section analyzes two particular vulnerabilities with the goal of assessing whether the vulnerabilities are attractive attack vectors.

Can Search for Program Excerpts Be Used to View Entire Programs?

If a user has independent access to the entire text spoken in a program, the user may be able to issue search requests for every line spoken in the program, and then glue the secure URLs into a single HLS playlist covering the entire program.

However, this approach has multiple drawbacks from the perspective of the user. The playlist would be playable only for a limited time, since tokens have expiration time. Furthermore, the user experience, e.g. during gaps in spoken text due to music playback or silence, would be sub-optimal. Finally, the number of search requests needed to assemble the needed URLs into a single playlist is high, and will be blocked by server-side request quotas.

This vulnerability is not very efficient as an attack vector, relative to other methods of piracy and will be easily denied.

Can Search for Near-Live Excerpts Be Used to View Entire Programs?

A user can continuously request media contexts of near-live excerpts for post composition, but use them to assemble a long HLS playlist covering hours of broadcast.

This approach, too, requires multiple requests to Whip Backend that will be blocked by server-side quotas. The resulting HLS playlist will only be playable for a limited time.

Nevertheless, to make this vulnerability less compelling as an attack vector, the following means are taken by the Whipclip Backend:
(1) Aggressive server-side quotas on near-live excerpts address the vulnerability by making it harder to obtain enough consecutive HLS playlists to be able to assemble significant portions of entire programs.
(2) Media contexts for near-live excerpts will be restricted to lower-quality profiles of the video stream. This approach makes the vulnerability less appealing as an attack vector relative to other forms of piracy that can be used to obtain high quality streams.

Since in Whipclip user devices use the HLS playlists only for post composition (as opposed to playback), the effect on user experience will be insignificant.

Whip's video protection methods were designed to meet the following goals:
Video files should be accessible only with time-limited (Minimum/Maximum, preset by content partners) tokens provided by Whip servers via Whip Backend APIs; No other access will be allowed.
Whip Backend APIs provide access to video files (via tokens) only for limited clips, and never to an arbitrary time window provided by users device;
Whip Backend supports various access control features, and is architected in a way that enable additional features to be add/developed over time, per future devices supported.

The design is based on philosophy of consistent x-platform (except when there's a compelling case to deviate). It also demonstrates how Whip protects and mitigates potential vulnerabilities.

### 5.3 Cloud Storage & CDN

Whip stores video recordings in the form of segmented Transport Stream files. Whip supports several cloud locations and CDNs for storing the files. These locations are configured to grant access to video files only to user devices presenting a valid token.

For example, files stored on Amazon S3 are accessed using S3 secure tokens. Files accessed via CloudFront CDN are accessed using CloudFront secure tokens. Cryptographic means in each of these token schemes restrict the ability to generate such tokens only to Whipclip servers.

The tokens are generated by Whipclip Backend servers, but only for user devices presenting a valid and authentic media context token. Any other request will be denied.

### 5.4 Micro-Service Architecture

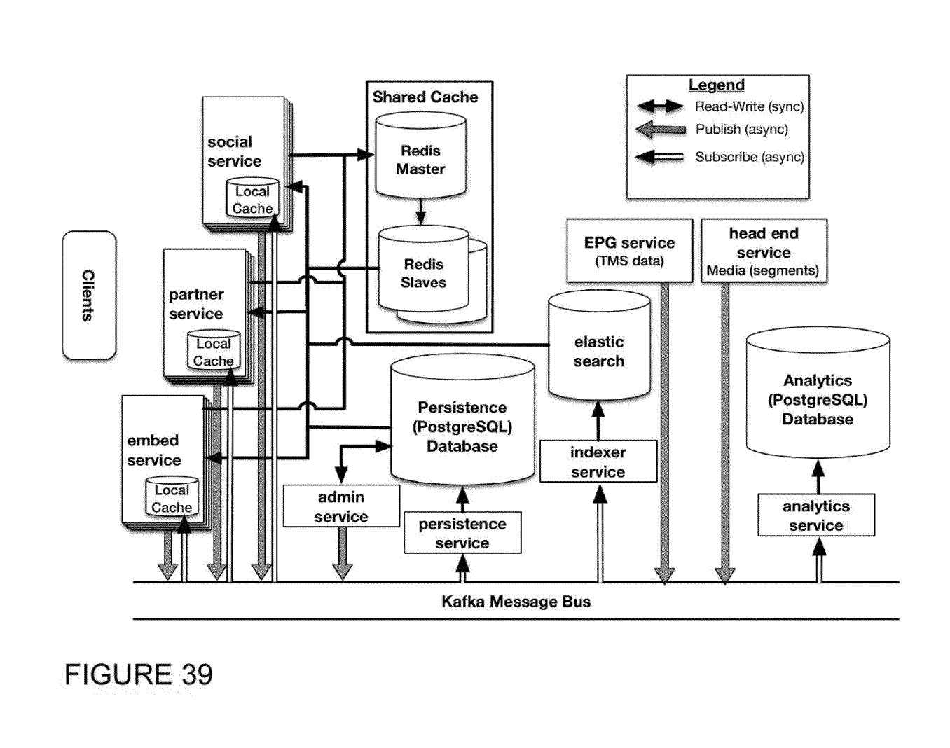

The logics around the video are handled by a scalable architecture. FIG. 39 shows the diagram of a horizontally scalable architecture that may be able to support a very large number of users. The architecture uses a micro-service architecture including multiple services, each of them independent of each other. Each service may either subscribe or publish to a message bus, and it is therefore easy to add or change any new service that can subscribe to the message bus. The services may be categorized into 3 different levels: local, shared or persistence cache. Whenever a state changes within a service, the change of state is published and the information is synchronized across the relevant services. All of the data related to Whipclip video sharing system is saved in a persistent database. The persistence database subscribes to all the services available and hence may find the correct state when a conflict happens in the system. The multiple services access in real time a shared cache, which stores all of the social data (likes comments etc). In particular, the EPG service, head end service and admin service may publish to the message bus. The persistence service, indexer service and analytics may subscribe to the message bus. The social service, partner service and embed service may subscribe as well as publish to the message bus.

The message bus is primarily used to reduce or even eliminate system bottlenecks.

### 6. Live Tune in

A System for clipping of live TV shows with automatic tune-in clips is described. Automatic tune-in clips are clips from live TV shows that automatically refreshes to the most recent defined time frame of a live airing program. The clip refreshes according to the time a user requests to view the clip; that is, instead of capturing a specific absolute timeframe in a program, the clip captures a timeframe that is relative to the time the viewing user requests the clip via a viewing client.

The defined time frame refers to the length of a live tune-in clip as defined by the content owner. The absolute time frame refers to a timeframe that is defined in respect to the start of a program.

### 6.1 Overview

A video clipping system allows its users to create a vast number of video clips from live TV shows. Usually, clips are defined by content owners or by users based on specific timeframe that has been aired; in more advanced systems, the timeframe can be defined in the future even before the airing.

A live tune-in system provides a more sophisticated functionality: content owners or other authorized users can define live tune-in clips, that are defined as clips that automatically refresh to the time they are requested by a viewing user. If, for example, a sports game begins at 12:00 and will last two hours, the content owner may want an end-user to see the most recent and relevant 30 seconds of the live game followed by a specific tune-in message. Creating an automatically updating clip means that an end-user who sees the clip 5 minutes after the game starts, will see the most recent {30} seconds of the game (i.e. 04:30-05:00). An end-user who sees the clip 10 minutes after the game starts, will see the most recent {30} seconds of the game (i.e. 09:30-10:00).

### 6.2. Scenarios

Live tune-in clip definition from partner portal: Partner portal provides easy graphical tool for creating clips. The regular functionality allows creating clips from the actual video. Live tune-in functionality provides access and browsing of the Electronic Programming Guide (EPG), the selection of a particular airing, and the definition of an abstract timeframe (normally between 30 seconds and 2 minutes, but not necessarily) for that airing. This timeframe is defined as a live tune-in clip for the selected airing.

Live tune-in clip definition by authorized end-user: an end-user normally uses a mobile client, hence an access to the EPG is less convenient. However, users can access a list of upcoming on-air programs; from there, they can select the option to create clips. If the show is before its airing time, the user receives a UI to select an abstract timeframe as above and this is again defined as a live tune-in clip for the selected airing.

In the two scenarios above, the clip creator can publish the live tune-in clip in the same way regular clips are published by a clipping system: either within the system, or through his/her account with a third party social network.

Live tune-in clip viewing: an end-user uses a client (either mobile, web, or through a third party social network). Live tune-in clips that were defined for a program that was not aired yet have no effect. Live tune-in clips that were defined for a program whose airing ended have no effect either. Live tune-in clips that were defined for a program that is currently aired appear, and represent their defined time frame relative to the current time. To avoid breach of content rights, the system must record the event that a particular user received a live tune-in clip, and if the same tune-in clip is requested again by the same client it does not refresh according to the current time, but the same physical clip the user have already watched is returned.

We also distinguish between two cases:
Autoplay systems: if the user receives the clip in an autoplay format (a common format in social networks user feed), the dip begins to play according to the time the page was loaded.
On-Request play: the clip starts playing only if and when the user clicks the clip covet picture. In that case the time of play is relative to the time the user clicked the clip.

In both cases, the clip ends with a message that allows the user to follow a link provided by the dip creator.

7. Creation and Playing of Large Quantities of Video Clips with Efficient Storage of Media Metadata in System RAM

A system for realtime creation and playing of large quantities of video clips is described. The system provides the efficient storage of the media metadata, enabling for the realtime creation of clips from the video. The storage also facilitates playing the clips under dynamic constraints that can be added to the media metadata after the clip is created.

The media metadata for the videos contains information that is essential for both creating and playing clips. It is essential for creating clips because it includes the set of video segments that the program consists of. In order to create a clip, the system must retrieve the set of segments and their duration from the memory.

Additional dynamic informations about a clip are also essential in order to play the clip. For example, the content owner may suppress the rights to playing a part of a program, and in that case any clip that overlaps that part cannot play the suppressed part.

In this embodiment of the invention, suppression rules are represented with a fixed length per time unit and are stored via a tree structure of constant depth.

### 7.1 Overview

A video clipping system allows for the creation of a vast number of video clips from live TV shows and on demand videos. Video streams are constantly supplied to the system, while they are aired in real time. The system stores the video itself in a Content Delivery Network (CDN); but to play a specific pan of the video on mobile devices, the system must provide a playlist, which is a list of URLs to video segments, and the duration of each segment. This information is called the media metadata. In essence, the system captures the stream of data from a source and turns it into small segments of data in order to present it to the user.

A clip is therefore stored as a playlist, and to create a clip the system must quickly come up with the list of segments and their duration. It needs to retrieve this information from memory, according to the channel and the time endpoints of the clip. The system must therefore store in memory the media metadata for any program that can be clipped; this spans months of video from each of dozens of channels that the system supports. As each segment is typically just a few seconds long, the system must, at any time, store information regarding millions of segments. The length of segments is not exactly constant even within a channel or a specific program, and the exact duration requires up to our decimal digits to represent. Moreover, in order to avoid the need to linearly search the segment storage of a channel to reach a desired second, the amount of storage per second of video must be constant (and then the system can calculate the exact location in which the segment information is available for any particular second). One example of media metadata includes the start point and end point of a segment,

Therefore, a naive implementation would store at least 20 bits for each second in order to indicate the duration of the associated segment. For three months of video and 100 channels this means a storage of 16 trillion bits (˜2 GB). This amount of memory cannot be spared for this purpose when the system RAM must at the same time store playlists for millions of clips. The system proposed facilitates the efficient storage and retrieval of media metadata information, and thus the quick creation and playing of clips.

Another example of media metadata stored is a naming habit for the URL (a link for the segments is built for example to CBS channel), The Ingestion tool gives streaming of videos from the TV channel; and the stream data is put into CDN. When the segments are created and put in the CDN, the same naming habit can be used such that the URL does not need to be saved.

Whipclip captures all this media metadata in memory and each segment has a reference to a media metadata. A special purpose algorithm is used to compress and quickly retrieve this part of the media metadata.

When someone asks to play the list, the playlist is written (in the APT). The RAM is used to generate the lists which is then stored in the CDN, in which each segments duration is given, as well as the URL with the timestamp, the channel name, resolution of the image, etc.

Furthermore, when playing a clip, the system must also retrieve dynamic information per each second of the clip; this dynamic information is required to determine whether this particular second can be played, Parts of video may be subject to content right restrictions according to their time zone, geographical location, and also according to manual restrictions imposed by the content owner at any time and potentially after clips were created.

In one embodiment of the present invention, this restrictor, information of fixed length per time is stored efficiently. This may be referred as suppression metadata The suppression information is given by the partners. As an example, a user creates a clip of a program in NY, which has not aired in CA yet. The partner may decide to “suppress” the clip until the program has been scheduled to air in CA. This information will be available in the suppression metadata associated to the segments

### 7.2 Video Reception

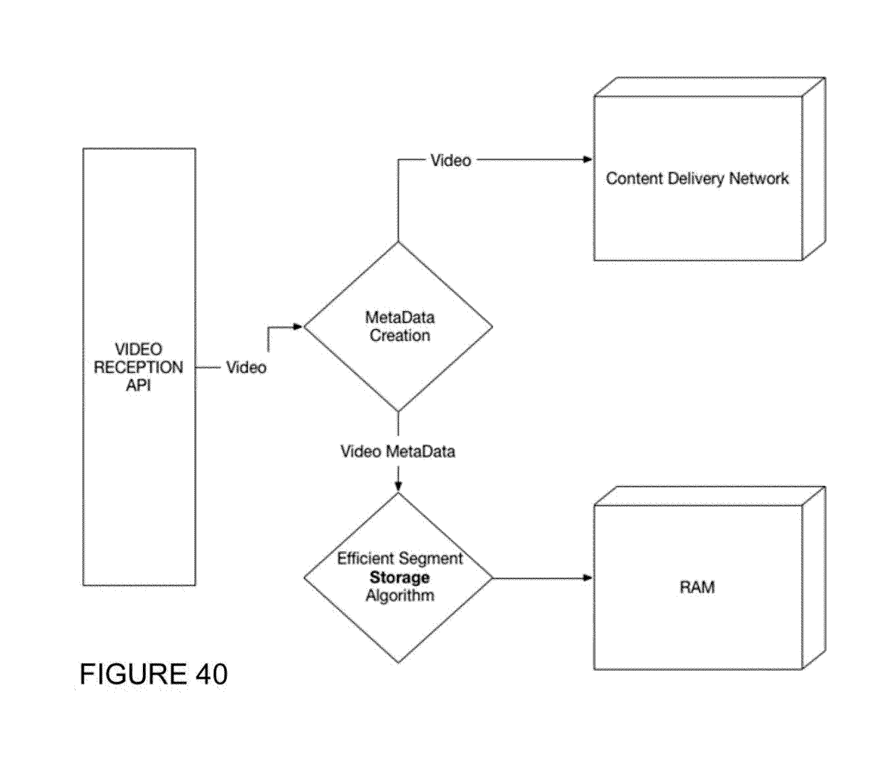

A diagram of an example of the system architecture for video reception is shown in FIG. 40. Video stream per channel is constantly received by the system. The video is transferred to a media metadata creation module that generates a list of segments along with their duration. The video itself is stored within a CDN, and the media metadata is given to the efficient storage algorithm. The algorithm generates compressed representation of the video segments and stores it in the system RAM.

### 7.3 Clip Creation

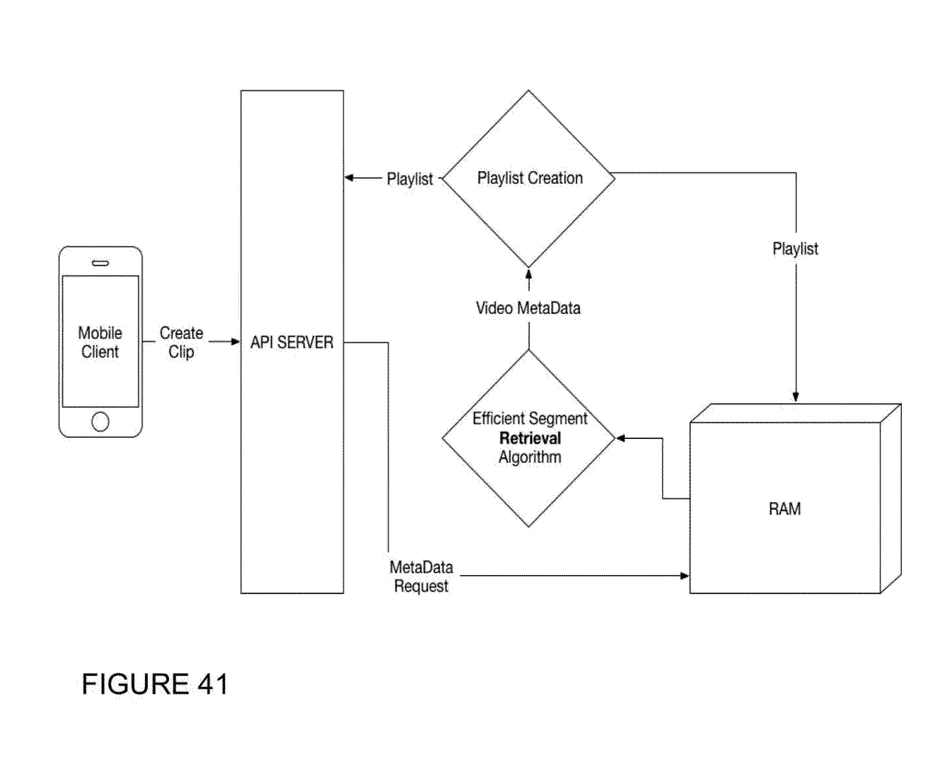

A diagram of an example of the system architecture for creating a clip is shown in FIG. 41. A mobile user creates a clip within a mobile app. This is translated to information regarding channel, start time, and end time of the clip, and sent to the API server. The API server retrieves from the RAM the media metadata for this video chunk, and the efficient retrieval algorithm re-creates the complete media metadata. Then a playlist is created according to this media metadata, and stored in the memory as a new clip.

### 7.4 Playing a Clip

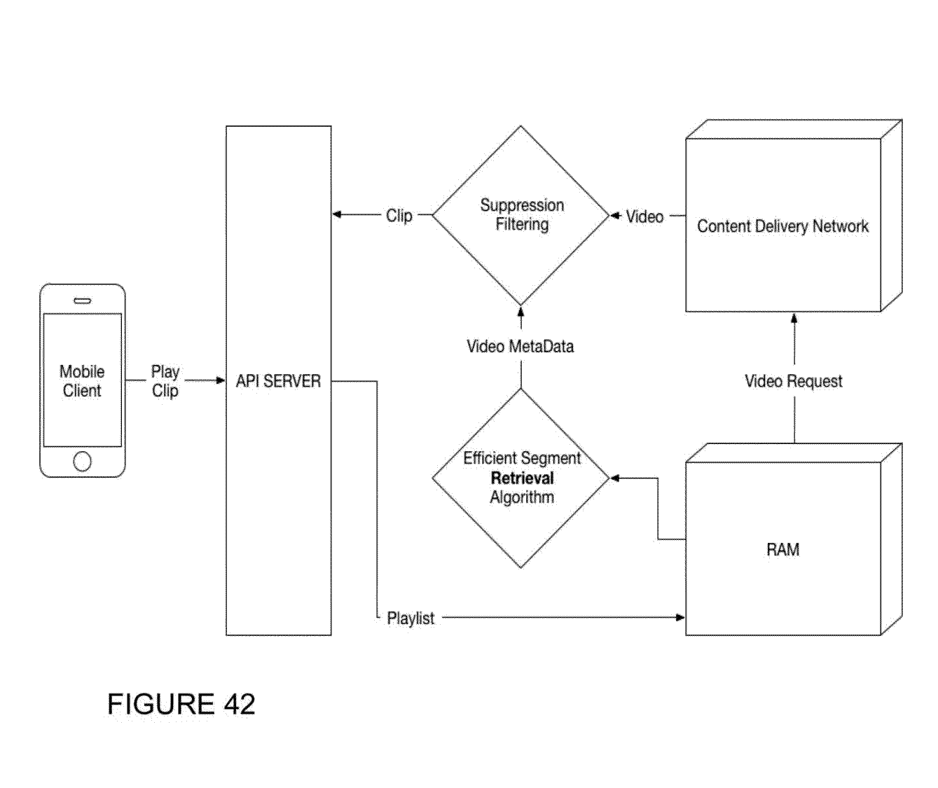

A diagram of an example of the system architecture for playing a clip is shown in FIG. 42. A mobile user requests to play a clip. The request reaches the API server, that in turns creates the playlist and requests media metadata for the playlist of the clip from the RAM. The response in its compressed form is sent to the segment retrieval module, that recreates the media metadata, and sends it to the suppression filtering module. In parallel, the playlist is used to retrieve the actual video from the CDN; the video is filtered, if needed, in the filtering module according to the suppression information it received, and the resulting clip is sent back to the API server and from there to the mobile client. Thanks to the efficient media metadata storage the entire process occurs in RAM and CDN (which is very fast as well), and therefore the user does not experience any delay.

### 7.5 Algorithms Description

The efficient storage of media metadata and suppression metadata while preserving access and insertion operations in constant time is achieved by two types of data structures, and a specialized algorithm for each. For both data structures, the data is keyed by a relative timestamp.

The two data structures and their associated algorithm are explained in detail in the following sections.

### 7.5.1. Tree Representation Algorithm for Storing Suppression Metadata

Suppression metadata of fixed length per time unit such as suppression flags, availability of various segment resolutions etc. is stored via a tree structure of constant depth where at each node, there is an array that stores an aggregated state for the time window it represents.

The aggregated view can either be a simple value to represent that all segments in this time window have a specific state (this mapping is static and application specific) or a reference to children nodes with more accurate information about slices of that time window.

This data structure takes advantage of the fact that the suppression metadata tend to be repetitive for large sections. The suppression metadata can therefore potentially be represented at higher level in the tree without having to be represented in the children nodes.

In particular, the root of the tree points to several nodes, and the nodes are defined by a divider that depends on the size of the array (e.g. a node might represent every 1000 seconds with a child node representing 200 seconds as an example). In most cases, the stream of data gathered has repeating patterns, and the efficient representation and storage of the repeated patterns using a tree representation can save around 40 to 50% of the memory. As long as a pattern can be predicted, the tree representation will save some memory. In the worst case scenario, the stream of data collected is random and it is not possible to predict any patterns. This is also the case at the end when no more repetitive patterns can be extracted and the random data is then presented.

Once patterns are predicted, the data available in the suppression metadata can be compressed more efficiently. For example, suppression metadata relating to commercial breaks during a show might always be very similar; hence it is possible to predict the segments when suppression occurs and therefore it is possible to predict the suppression pattern of the suppression metadata. One piece of data may also be labeled as either suppressed or not suppressed, but the question of suppression does not always have a simple yes or no answer. An array is constructed with a bit allocated for each segment. A bit may also be assigned to the geographical location, with for example one bit for the west coast and one for the east coast.

Several representations for the suppression information are possible. For example a small number of bits can represent a larger number of bits, wherein the small number of bits indicate that either all the bits are suppressed, or that none of the bits are suppressed, or it can also indicate a pattern with a combination of suppressed and unsuppressed bits. (e.g. for example a pattern of 1 0 may be chosen to indicate that all the bits are suppressed. As another example a bit 0 could further represent a 1 0 1 0 pattern, and therefore the bit 0 would not need any child nodes resulting in the reduction on the size of the memory).

The tree representation is not limited to the representation of suppression information; it can also represent for example the availability of the segment. The representation of the availability of the segment proves useful in the case that the segment is lost and it is not possible to retrieve it. The availability of the segment informs whether the segment is available or not, and where the segment starts.

An example of the algorithm of the tree representation is given by the following:

At construction we define capacity at each level of the tree.

total capacity is multiplication of all capacities for all levels.

indexDivider for every level is defined as the multiplication of capacities for the lower levels or 1.

(In the algorithm below: “/”=integer division operation, “%”=integer mod operation).

```
- get(timestamp) :
  node <- tree root
  node.get(timestamp);
- node.get(timestamp) :
  value = get(timestamp / indexDivider)
  if (value is reference to child node)
    return child_node.get(timestamp % indexDivider);
else
    return value;
- set (timestamp, value):
  node <- tree root
  node.set(timestamp, value);
- node.set(index, value)
  value = get(timestamp);
  if (value is reference to child node) {
    child_node.set(timestamp % indexDivider, value);
}
else {
    child_node = new child_node( );
    child_node.set(timestamp % indexDivider);
    set timestamp value to reference child_node;
}
```

### 7.5.2. Segment Duration Algorithm

Media metadata relating to segments duration are potentially different in length and requires a special handling to avoid wasting memory.

Here as well a data structure, which is keyed by the relative timestamp, is used.

In this case the data is typically represented as a double number (the duration at the time point where the segment starts) followed by a few zeros (the time points where no segment starts).

The segment size is also larger than our defined time unit and the duration precision has a fixed size in the video protocols used (to 4 digits beyond the decimal point).

A data structure with a fixed length per time unit is used. A single bit is used to indicate whether a particular entry is a start of segment or not and the rest of the bits are used to represent the segment duration (even if those bits are not part of the cell that belongs to the segment start time point).

Defining a fixed length which is too small to represent the entire duration double number will only hurt its precision and the number will be rounded to such a number that can be represented by the available bits.

An example of the algorithm is given by the following:

The array is first constructed by being given a static fixed size per time unit in bits. One bit for every time unit from the allocated number of bits is used to define segment start or continuation.

Every durationValue below is the integer representation of the actual duration (e.g. This is mainly due to the fact that the maximum precision is known and the number of the actual duration can be multiplied by a constant factor).

First, the number of bits to represent a specific duration is chosen.

```
get(timestamp):
  int index = timestamp;
  // go back to start of segment
  while (value[index] is segment continuation) {
      index = index−−}
```

The size of the segments: time

As an example a segment of 2.13 seconds need to be represented. First, the number of bits to be allocated per second is decided and chosen to be 4, hence every second will be represented by a 4 bit sequence. The first bit of every 4 bit sequence indicates whether it is a start of a segment or not, where 1 means that it is the start of the segment, and 0 means it is not the start of the segment. In order to represent a segment of 2.13 seconds, 2 sequences of 4 bits will be used (in total 8 bits), where the first 4 bit sequence will start with 1 and the second 4 bit sequence will start with 0 in order to represent 2 seconds (8 bits). As 2 bits already have a value, the rest of the 6 bits are empty and are used to represent the remaining 0.13 s.

Depending on the number of empty slots left to encode the duration after the decimal point, the accuracy can be changed. Smaller segments tend to be less accurate, while larger segments will be more accurate.

8. System and Method for Content Owners to Prevent Access to Specific Parts of a Video Stream in Real Time within a Clipping System

A content rights respecting system for real-time creation and playing of video clips is described. The system allows content owners to prevent (suppress) clipping and/or viewing of specific parts of the video. The suppression can be set by content owners either in real time during the initial airing of the video, or at any later point in time, even if clips were already created for the parts of the video that should be suppressed. The content suppression ensures that no additional dips can be created on the suppressed content, and any clip that was already created cannot be viewed as long as the suppression is in effect.

### 8.1. Overview

A video clipping system allows its users to create a vast number of video clips from live TV shows and on demand videos. The system operates under explicit content rights provided by the content owners, and under these agreements the system is required to provide content owners with granular control over the video; it must allow content owners to suppress specific parts of the video (indicated for example using one second granularity or single frame granularity) due to various reasons (for example, to prevent dipping of program parts that are, considers spoilers, or containing adult content). The content owners access the system using a graphical user interface (GUI) where they can view their video stream and mark specific parts of it as suppressed. Specific suppression rules for an episode or new series can be set from the point it is available in the Electronic Program Guide (EPG) (which is typically 13 days in advance of the linear media broadcasting for the first time), or after it has aired (on demand). This has two effects: first, when users access the stream to clip it the suppressed parts are not shown and thus cannot be clipped. Second, if any clips were already created in the system that includes a suppressed part, those clips are not shown to any user, including the user who created them.

Content owners also have the ability to remove suppression rules. The result of removing i suppression rule is that those specific parts are again available for users to search, preview and clip and any clips that were previously created from that segment will be restored and resurfaced in the client applications.

The partners or content owners can be for example the TV channels or music provider. They are able to control the suppression information as well as the display of a particular clip.

Examples of suppression parameters they are able to control are but not limited to:
specific portion of a show: this suppression in is contained in the media metadata. For example, the control owners might want to suppress a particular season/show or specific part segment of the clip to be suppressed: for example they may not want a spoiler element to be shown and may want it to be suppressed.
Geolocation properties
Timing separation: the content owners may decide they are not going to allow sharing of a specific program until a certain period of time.

Geographical restrictions can be provided using either timezones or zip codes. That is, content owners can (i) mark certain videos (shows, episodes, etc) as blocked for a Specific list of zip codes, and (it) specify time restriction according to timezones; either by blocking specific timezones from accessing the video, or specifying exactly at what time each time zone can gain access to the video, or by specifying that each time zone can access the show only after it is aired in that timezone (or in a specific timeframe after it is aired).

The content owners can also control the display of a particular clip. For example they can insert an endcard. The endcard may be an image at the end of the clip with a link to a specific address, such as for example the website of the content owner itself. The endcard may also be tailored to the specific details of the user, such as his current location for example.

Content owners can delete specific user clips. Deleting a specific clip removes it lion: the app and prevents the video from being loaded or watched for clips that were shared outside of Whipclip,

### 8.2. Method

Video streams are constantly supplied to the system, while they are aired in real time. The system stores the video itself in a Content Delivery Network (CDN), but to play a specific part of the video on mobile devices, the backend of the system sends the mobile client a playlist, which is a list of URLs to video segments, and the duration of each segment. The idea is that suppression is managed through a stored list of segment metadata. For each real video segment, the system stores a segment metadata, that includes (among other data) the indication whether this segment is currently suppressed or not. When the content owner suppresses a part of the video through the GUI, the metadata for each segment of the video that was suppressed is marked as suppressed. When a mobile device requests a certain part of the video (and this can be either in order to create a new clip, or to view an existing clip), the system assembles the list of segments to create a playlist. Before generating the playlist, the metadata is checked per each segment. If one or more of the segments is suppressed, an em message is sent to the client instead of the clip,

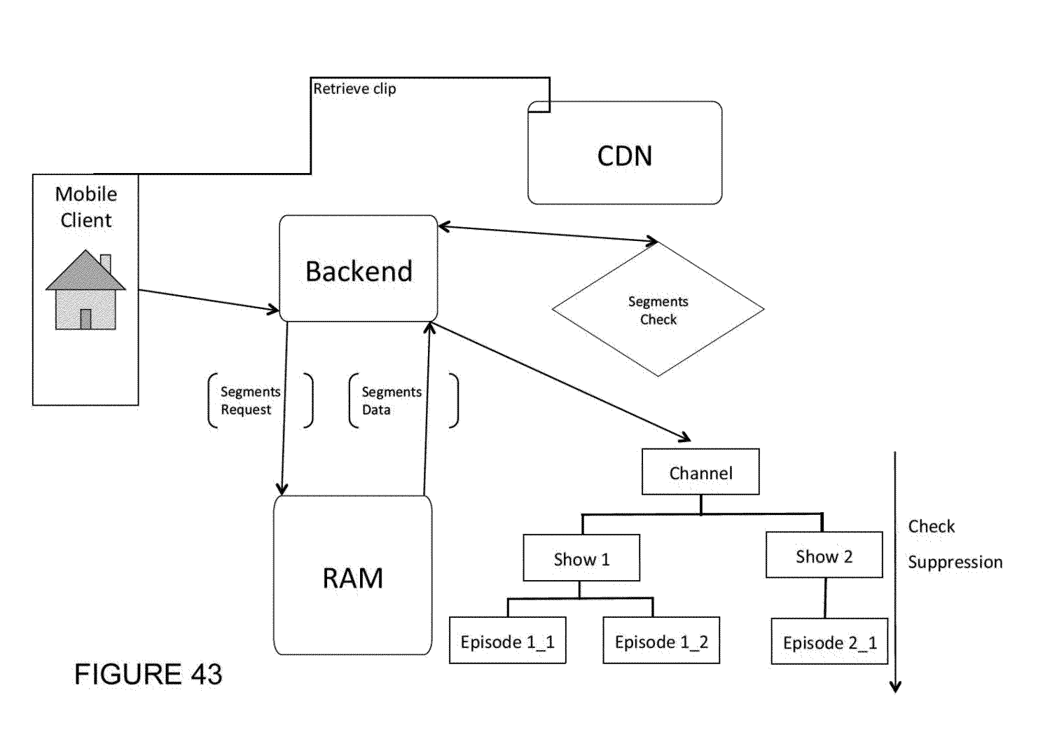

seen in FIG. 43, an end-user asks to create a clip, mobile client sends the backend a request that includes source (channel or VOD) and time frame. The backend retrieves segments metadata from cache, and checks if any of the segments is suppressed. If not, it returns a list of segments as a playlist to the client (which, in turn, retrieves it from the CDN). In another scenario, the backend prepares a list of clips to show the user, and checks current suppression information for each using a similar method.

### 8.3. Hierarchical Suppression

Often, content owners need to suppress a certain part of a recurring program. For example, the last five minutes of every episode is considered a spoiler. Or, suppression can be required at the series level (e.g., suppress the second part of the last episode of each season), To that end the system supports hierarchical suppression. The GUI allows the content owner to select the suppression level (channel, show, season, episode, airing); this information is sent to the backend, which organizes the metadata of the according to the hierarchical structure. The suppression information is then stored in a hierarchical manner (as seen in FIG. 43): each metadata object (show, episode, etc) contains its own suppression information (with time relative to its own beginning); when the segments are retrieved, the backend examines the metadata hierarchy top-down and checks each level for suppression. For example, a request is received from the client along with its timezone and zip code information. The timezone and zip code are searched for in a quick hierarchical lookup tree that is organized according to the show's metadata (channel->show->season episode->airing) . . . .

At each point in the hierarchy, suppression parameters may be given. The hierarchical suppression is not limited to TV channels but can also be extended to other content owner providers such as for example Amazon prime, Google: Play, Netflix, or music video providers.

For music video providers, the hierarchy would be similar but may have information about artist/song etc. for the case of the music video, the only difference is that there is no broadcast of a live tv show. However, the video will still have segments, and the content owner have similar control over suppression,

### 9. A Video Clipping System Allowing Content Owners to Control Online Properties of Clip

A content rights respecting clipping system allows users to create clips from live TV shows and on demand videos. The system allows content owners to control various aspects of any clip created by users of the system. In particular, the system lets content owner tune the maximal length of any clip, and set an automatic expiration time.

A novel aspect of this invention is that the properties are verified while a clip is loading just before being published. This is done automatically and in real-time as it is crucial for example to check whether a clip that has been created has expired or not. A default sunset period may also be set which defines a specific amount of time for a clip to exist within the system.

Partner portal sends an instruction for dip expiry: any dip on metadata X (where metadata is any level in the hierarchy) must expire within Y minutes of its creation. The information is stored in the channel's metadata, Any clip that is created for that channel has access to this metadata. When a client requests a clip to play, the clip is loaded from RAM or dB, and requests the expiration defined in the metadata hierarchy (this is implemented by going down the tree, and updating expiration at each level, so the lowest level for which expiration is defined is taken as the truth). The clip is returned to the client only if it is not expired.

10. A Video Clipping System Allowing Content Owners to Restrict the Maximal Aggregated Time a User Views from a Show

Content owners are able to restrict the maximal aggregated time a specific user can view a particular show. This may prove useful to prevent a user to watch a whole show by watching all the clip(s) that make up the particular show.

A content rights respecting clipping, system allows users to create clips from live TV shows and on demand videos. The system allows content owners to limit the amount of time that a given user is allowed to watch from a specific TV program, or from a specific TV series. This restriction is affected to the accumulated time the user is watching, including video watched while creating a clip, dips created by the user, and clips created by other users. Moreover, some parts of the video may be served to a user as search results; the system must track which part of the search results were Viewed by the user and take it into the time count of the respective program,

The various viewing activity by a user is recorded and aggregated with quick lookup according to user id. This must all be extremely quick; the writing of the information is asynchronous, the update of the user-aggregated data roust be completed within a few seconds. The time after airing for which this restriction holds is configured by the content owner; the information therefore needs to be saved for a period of time accordingly.

As an example of implementation, a table that potentially covers all pairs of users and programs is created, and an entry is added only when a user watches a part of that program (so we do not hold redundant pairs). This data has to be retrieved very fast, therefore must be stored in RAM, at least for those users that are active daily. This means that the data must be very compact. For example, with 100,000 active users and 1000 shows per two weeks, each byte needed per entry requires 100 MB of RAM. With these numbers, if the amount of RAM allocated is capped, there is a total of 10 bytes per user-program pairs. An explicit representation of each chunk of rime watched by the user is therefore impossible.

Instead, for each pair a list of program chunks is saved. The length of a chunk is a fixed portion of the program length; for example, 1/80. One bit for each chunk in this example, 80 bits or 10 bytes) is kept for each user program pair (for which the user have watched some part), and the bit is marked as true if the user watched some of that program chunk.

### 11. Clipping Live TV in Realtime and Scheduling of Automatic Realtime Clip Creation

A content owner may program automatic scheduling for creating and publishing clips from live TV broadcast. A content owner defines a scheduled time frame for a dip to be created and published in real time. The content owner may define automatic scheduling in respect with the time a user logs into the sharing application. The content owner may also define automatic scheduling for defined portion of a show/season/episode/program/game.

A live clipping system that allows content owners and users to create dips from live TV shows as they are being broadcast is described. The system provides a live stream of a show. A user (in most cases the content owner), can specify a time frame on the show, which can be partly or entirely in the future. Once the program reaches the end of that time frame, a clip is published. Furthermore, in nano cases content owners wish to create recurring clips, from recurring TV programs; for example, publishing the first minute of each sports game in realtime can defined traffic to that game. This clipping system lets content owners schedule the automatic creation of live TV clips; again, a dip is released the moment the program reaches the end of the timeframe, defined for the clip. As segment duration of HLS feeds may not be fixed and may not be known until a feed is received, playlists may not be prepared in advance.

An end-user may also setup a notification for TV programs that are scheduled to air at a later time or date, and that have not aired. A notification will be sent to the end-user when the TV program is airing live, next.

12. Identify Hot TV Moments from Users' Clipping Activity

A system to identify key TV and video moments is described. The System allows users to create video dips from TV programs, films, and other video material, and share it with their social network. A segmentation algorithm is used to aggregate the clipping activity and to segment the program around activity peaks (the description of the algorithm and the sources of data that it uses are below). The key moments of the program are, detected according to the level of activity around each peak.

Hence by gathering clipping activity for a TV show, a TV show is segmented into moments, which are then further analyzed, key or hot moments may therefore be identified. The output of the segmentation algorithm can also be used for example in the trending algorithm, in the search functionality as well as to customize user feed.

### 12.1 System

A dipping system provides an end-user the ability to create clips from live TV shows and on-demand video programs, using their mobile devices. A clip that an enduser creates is placed in the clips database, and becomes available for other users to view, and perform social actions: like, share, or comment on. In the background, a process segmentation takes place for each program that is on the air or available on demand. The segmentation algorithm described below uses the exact places in which clips are created to segment the program into a series of “moments”. The segmentation occurs again after each dips that is created.

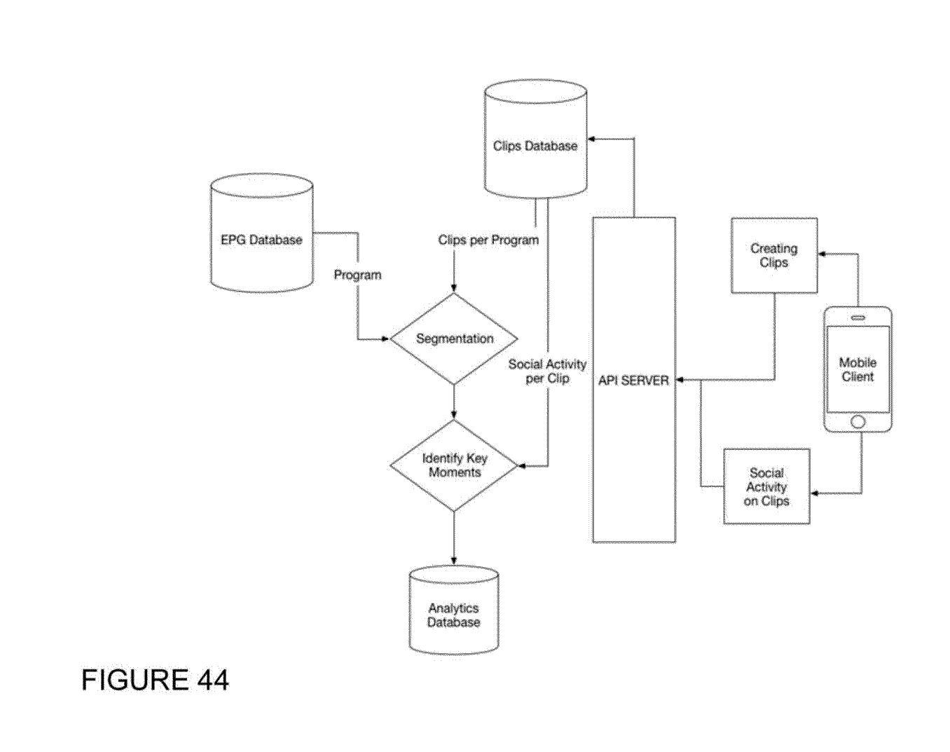

FIG. 44 shows a diagram of identifying key moments for users clips. After each time the segmentation changes, or whenever a user performs a social action on a clip that is from the program, a second algorithm is activated: the identification of key moments in the program. The algorithm scores each segment (or “moment”) based on the number of clips that where created from it, and the volume of social activity it generated, it then sorts the moments according to their score, and stores the results in the analytics database; which provides an unprecedented source, of information about the program.

Purpose: the concept of moment comes to capture the fact that sometimes multiple clips are created for what is essentially the same TV moment; that is, the main event in the set of clips is the same. We would like to identify such moment for few ends:
De-dup: we need to avoid showing multiple clips of the same moment in the same list.
Scoring: there is value in aggregating the social score of clips that refer to the same TV moment, in order to promote that moment in our feeds and searches.
Analysis of TV show which are the strongest moments, and how popularity changes over time.

### 12.2. Segmentation Algorithm

Parameters:

θ: maximal length of a moment

We define a program clips vector as a list that includes a score for each second of the program. The program moment vector is calculated for every clip that is created, published or shared.

Steps in calculating the program moment vector:

1. The clip vector: the score of second r within clip i; its meant to increase the significance of the middle of the clip in comparison to the beginning or ending. This is mainly due to the fact that an end-user, when creating a clip, tends to start the clip a few seconds before an important moment and end the clip a few seconds after. Hence a bell-shaped curve distribution may be used such that the score is higher in the middle of the clip. For example, the following distribution is used where the score of second r within clip i is defined as

$${s}_{r}^{i} = \frac{1}{\sqrt{2 π}} {e}^{{( \frac{{L}_{i}}{2} - r )}^{2}} \qquad ( 1 )$$

Where Lᵢ is the length of the clip i. Note that the vector sⁱ would be identical for any pair of clips of the same size.

2. Next, the scores for every clip are aggregated. The score of second j is defined as a sum

σⱼ=Σᵢ₌₁^{k}s_{j-b}_{ᵢ}ⁱ (2)

Where k is the number of clips that include second j, bᵢ is the second in which clip i starts (hence j−bᵢ indicates the offset of second j within clip i).

3. Smoothing: remove small, insignificant bumps. For example, we can take

$${σ}_{j} = \frac{{σ}_{j - 1} + {σ}_{j + 1}}{2} \qquad ( 3 )$$

Equation (3) may need to be parameterized, to determine how aggressive the smoothing should be.

Next, we segment the program clips vector into moments in such a way that the moments are centered where maximum clipping activity occurred:
1. Create a list α of all the local minima of σ (in case a minimum lingers more than a second, take center). Add the start point and the end point of the program to α.
2. Segment the program according to the points in α. Hence the local minima may be used to find the border of the moments.
3. Create a list β of all the local maxima of σ (treat series as above).
4. Repeat
   For each point bεβ,
      Calculate the average starting points (l_{b}) and end point (u_{b}) for clips which contains b (this may be the weighted average, where s_{b}ⁱ serves as the weight of clip i),
      If l_{b} is later than the current beginning of the segment of b, segment at l_{b}. If u_{b} is earlier than the current end of segment of b, segment at u_{b}.
   If no new segment was created at the previous step, exit loop
   Otherwise, create a new list b, including the center points of each new segment that was created above (the new segment is the one between the previous break point and the new one).

### 13. Using Mobile Scrolling Data for Information Stream Personalization

A method for personalization of information streams for mobile devices is described. An information stream serves a set of personalized items for an interacting user. The user's preferences towards the served items must be inferred according to the user interaction with the system. If a user views an item and does not click on it, it provides a negative feedback of that user towards this item. The longer the user viewed the item, the stronger this signal is. The system must therefore know whether the user viewed each item and for how long. To do that, scrolling information is used; the system tracks the user's scrolling during his interaction with the information stream, and infers based on that for each item on the list, whether the user reached that item, and if so, how long it was present on the user's mobile screen.

Every bit of data available on the users is used (implicit observations, explicit feedback, signals internal to the Whipclip mobile app or external from places like FB) to personalize the user experience and serve up more compelling, engaging and relevant content. Signals refer to any of the behavior of an end-user providing information on whether or not they like or not a post.

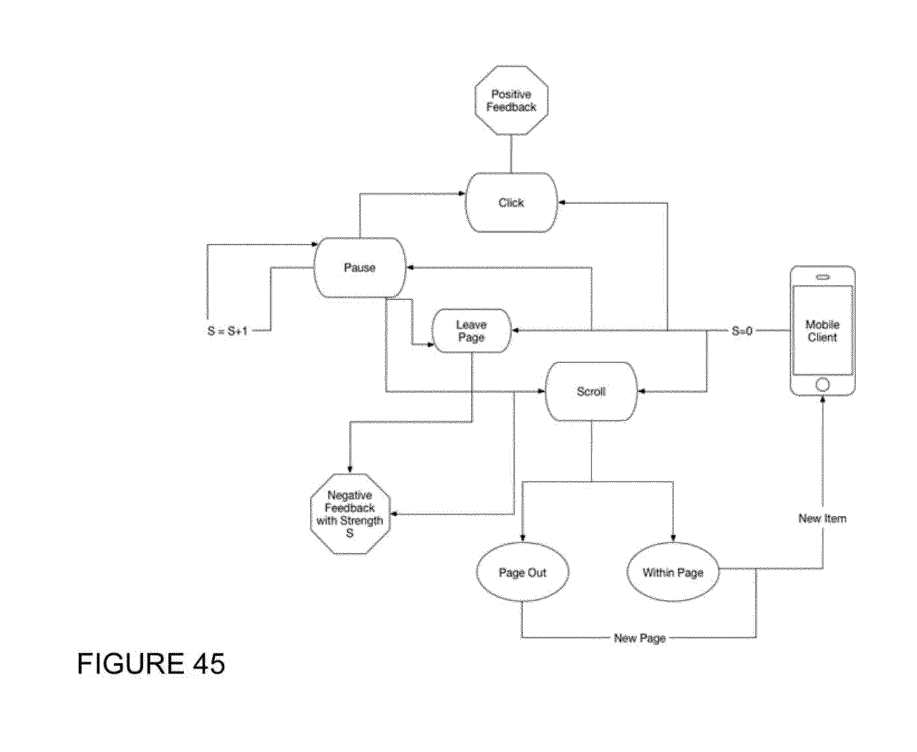

FIG. 45 describes the process of tracking user actions and generating positive and negative feedback out of it. Consider a mobile client screen that displays one or few items at a time from an information stream. The user has three possible actions: pause, click on an item, scroll down, or leave the page altogether. If the user clicks on an item, it provides the system with positive feedback regarding the affinity of this user to the item. If the user scrolls down or leave the page immediately, before having time to view the items, it provides no feedback regarding the items. Once the user pauses for a time unit, the signal starts to increase and it keeps increasing the longer the user pauses. At this point, a scroll down or leaving the page without clicking provides negative signal regarding the current items, with its strength according to the current signal S.

Note that the client receives the input in batches called pages. A scroll results in new items from the feed served to the client; this might cause the page to end, requiring the client to request another page.

In FIG. 45, the scrolling action on the mobile client is sent to the API sever; it provides both the speed of scrolling and the time (length) that the user performed scrolling; this is sent to the scrolling analyzer that translates this information to the number of items that were scrolled out of the screen in this operation, thus revealing which item became visible. This is the data that is used in order to provide the feedback to the database. When an end-user is presented to a new item on the Whipclip mobile app, the signal S is set at 0 and the end-user may either scroll (within the same page or on another page), leave the page, click or pause. A click returns a positive feedback, whereas leaving the page returns a negative feedback. If the end-user scrolls, a new item is presented and the signals are analyzed in the same manner.

When an end-user pauses, the strength of the signal S increases. If the user leaves the page following the pause action, a negative feedback is returned with strength S. Hence the strength of the negative feedback depends on the scrolling information and a strong signal is returned when an end-user scrolls slowly and do not engage with the content item.

When an end-user pauses and then scrolls, a new item is presented.

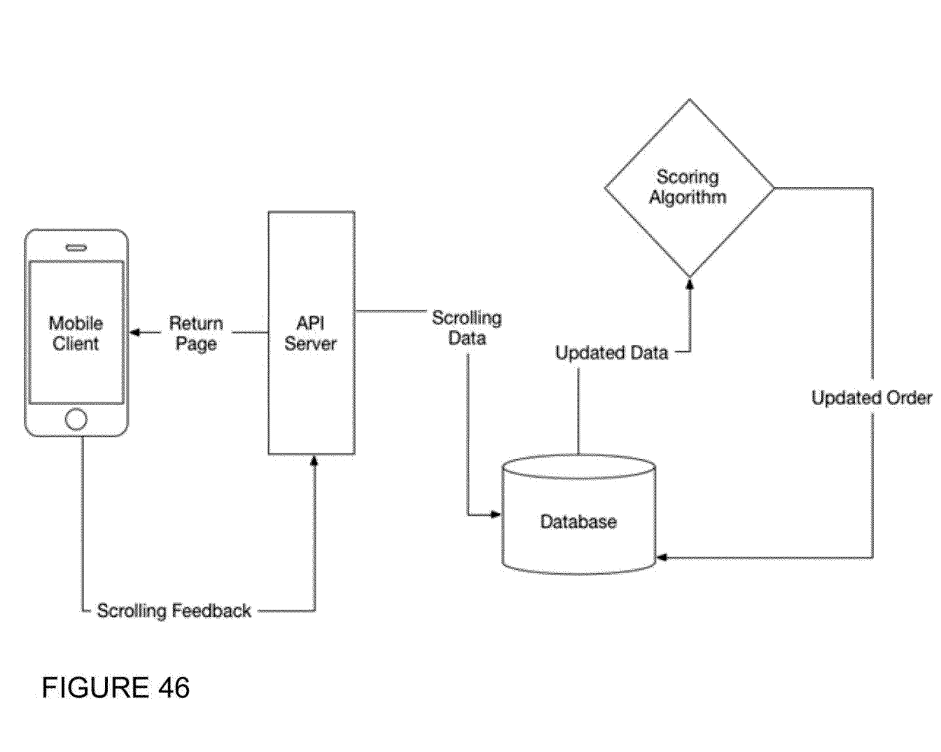

A high level view of the feedback process is described next. The feedback is generated according to scrolling and pause feedback, within the API sever, as described above. The feedback is updated in the database, and this invokes the scoring algorithm that scores the relevant items again, and provides an updated order to the database as shown in FIG. 46. This in turn affects the pages that are sent to the mobile client upon request.

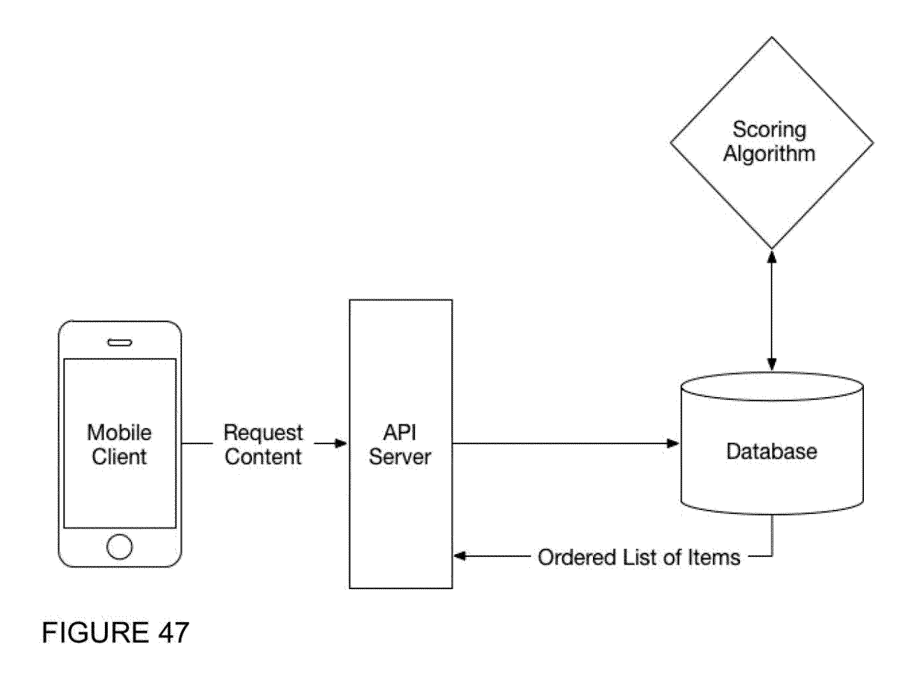

FIG. 47 describes the content request from the mobile client. The client sends the request to the API server. The API server requests a list of ordered items from the database. The items in the database are constantly sorted by the scoring algorithm.

### 14. Embed Portal/WHIPCLIP PRO/Controlling Content Rights and Permissions

### 14.1 Overview

Embed portal is a solution for Distribution Partners that will drive faster adoption of Whipclip embeds.

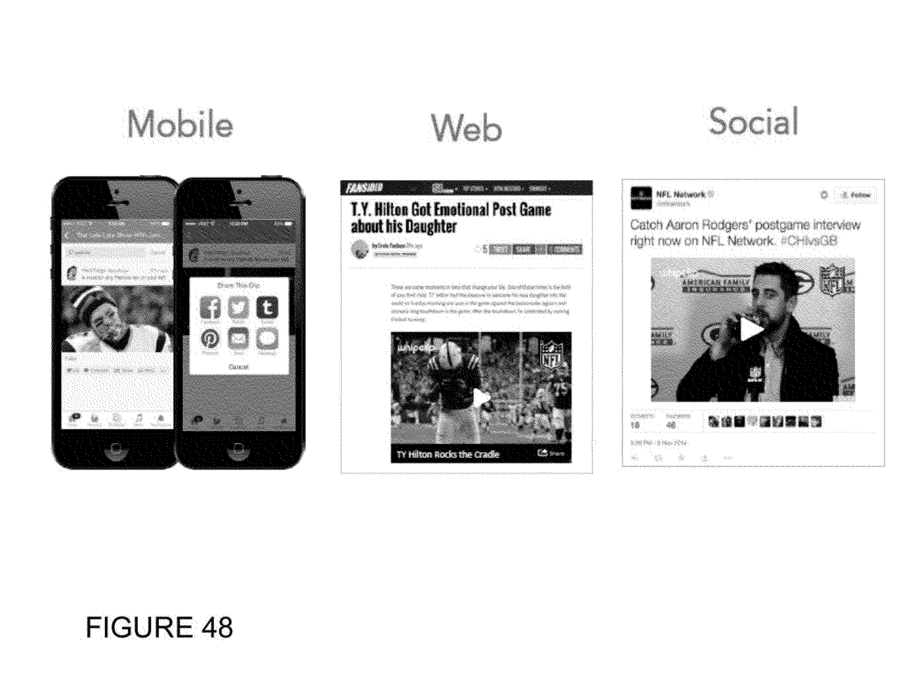

FIG. 48 shows examples of social and web distribution of media content.

Mobile distribution offers the ability to, for example:
search past clips which enables fans to find in order to relive key moments.
search across multiple programmers' content to follow characters, cast members, artist, players on other appearances on TV.
push notification for specific shows.

Web distribution may enable, for example:

post clip-based articles and lists to keep media content fresh and preview the week ahead.

curate content to focus on specific moments.

clip legally media content, therefore replacing takedowns and allowing longer clip lifecyles.

Social distribution may enable for example:

celebrity clip sharing to spark conversations or to hype upcoming programs.

hashtag stunts to gather fans around specific themes

end cards to drive fans back to explore more

Business goals:

Grow library of content

Increase traffic

Convert users

Monetize community

Affiliate Network Objectives:

Leverage partner networks to drive incremental user growth

Incentivize publishers by allowing them to monetize their influence

Provide differentiated tools+content

Leverage monetization of incremental views to incentivize content owners

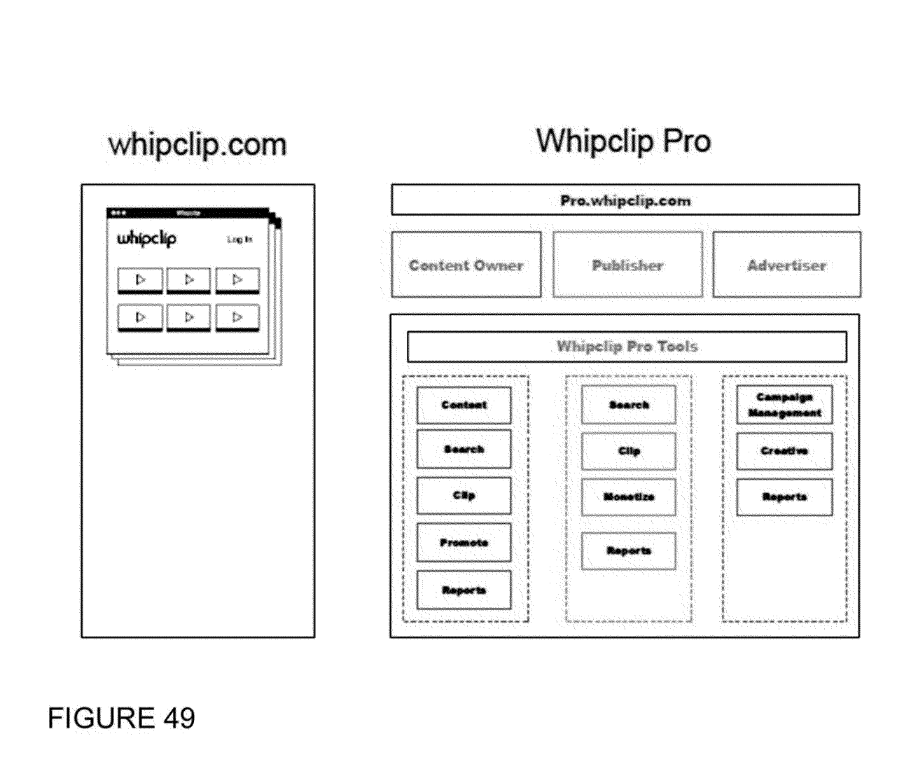

FIG. 49 shows an example of the layout of the different modules of the embed portal wherein content owner, publisher or advertiser may have access to a variety of different tools as detailed in the following sections.

### 14.2 User Profiles and Permission

Content owner: a content owner comes to Whipclip pro (WCP) to upload content, manage permissions, and enable clipping content. A content owner may also come to WCP to utilize clips to promote content and to monitor performance and insights of clip distribution and monetization.

Publisher or distribution: a publisher comes to WCP to search for content (raw, clipped) to enhance his or her own content communications. They may also use partnership with content owner as an additional way to monetize their content. A Distribution Partner can, for example:
browse metadata tree to find shows.
search metadata to find shows and clips.
Create a clip for a specific moment, publish the clip and share the clip (via the app, or third parties platform).
get embed code to insert Whipclip video player on her site (System includes unique id, clip, metadata and end card with embed).
Monitor end-user visits to get insights on social views, embed views or revenue earned for example.

Advertiser: an advertiser comes to WCP to connect them t content and audiences relevant to their brand. Advertising formats extend from pre-roll, in app sponsorships, and end card real estate. An advertiser may for example setup line item, such as flight dates for a specific targeting group (targeting or budgets). An adviser may also be able to monitor end-user behavior and analyze behavior data such as page views, plays, click through rate, percentage of complete, performance by content/category.

Reporting: a reporting user comes to WCP for insights on performance relative to a specific network or across all networks. This may be for example an internal user or a specific content owner or publisher user that should not have access to content management or clipping.

Programmer (editorial): an editorial programmer can use moderator tools to manage trending/top content. They also have access to content insights to help understand what to program.

Average user (logged in): an average user may come to the website to discover, view and clip content. User may also share new or existing clips with their social networks or via email.

None: when a user visits the website but has not logged in, they may discover and view existing content. No clipping or sharing functionality is enabled.

Admin: an admin user helps to manage users, accounts, etc. An Admin can, for example:

Log in with access to all channels

Use tool with same permissions as Content Partner

Create users with System access

Manage users with System access

Moderators work on behalf of the content owner to create and manage clips. They seek utility. (example: Whipclip freelancer). A Moderator can, for example: log in with access to all channels and use tool with same permissions as content owner. Moderator can manage content settings for playable media. When users have been assigned a moderator role, they will be granted permission to manage content settings for a particular network(s) or specific channels within a network, Once granted access, a user can manage content at three distinct levels. Network (N)—The network level settings are the minimum required. User may grant controls to manage at a more granular level. Series/Show (S)—Series/Show settings will override Network setting. Airing (A)—Airing settings are the most granular level of control; functionality may be limited at this time.

End-Users view clips on Distribution Partner sites and Whipclip.com. They seek a great viewing experience. End-users are catered to with adaptive bitrate streaming browsers. A simple fallback should be put in place for end-users without adaptive bitrate browsers.

### 14.3 Manage Users

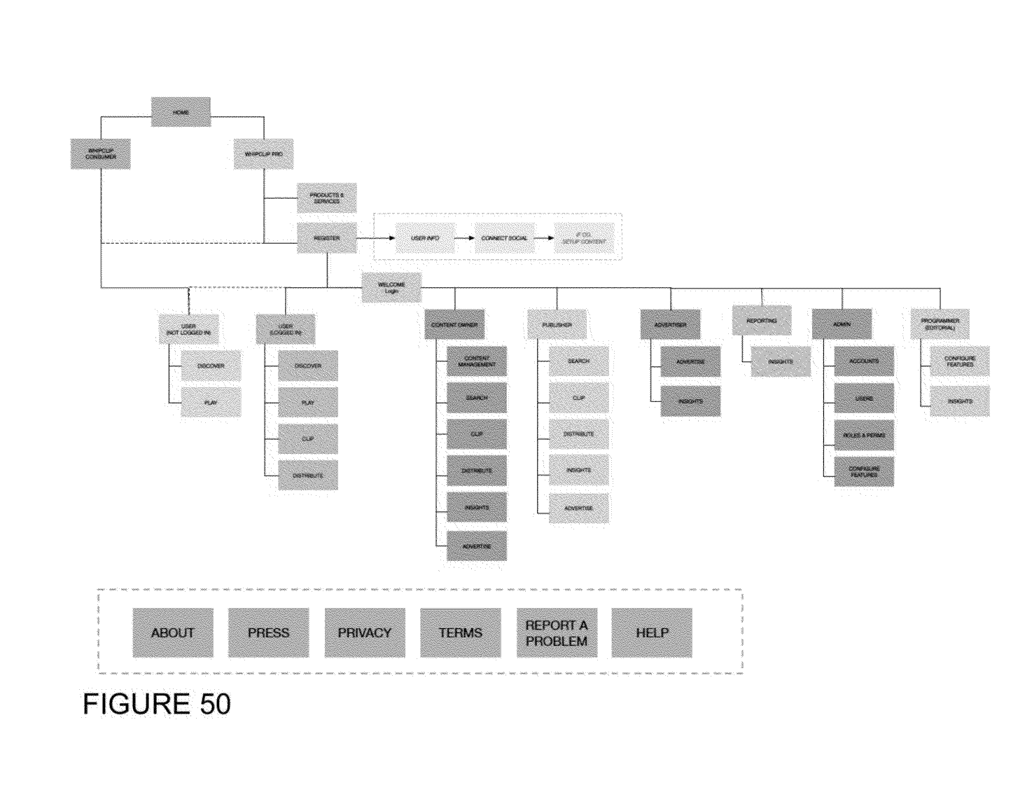

Admin may define and assign roles/permissions to users. User management (visibility and function controls) may be consolidated using role-based access control for consumer and partner users. Roles may be created for various ‘job’ functions. The system is designed such that additional roles and permissions may be easily added. The permissions and roles are organized to be in line with the Whipclip site modules as shown in FIG. 50.

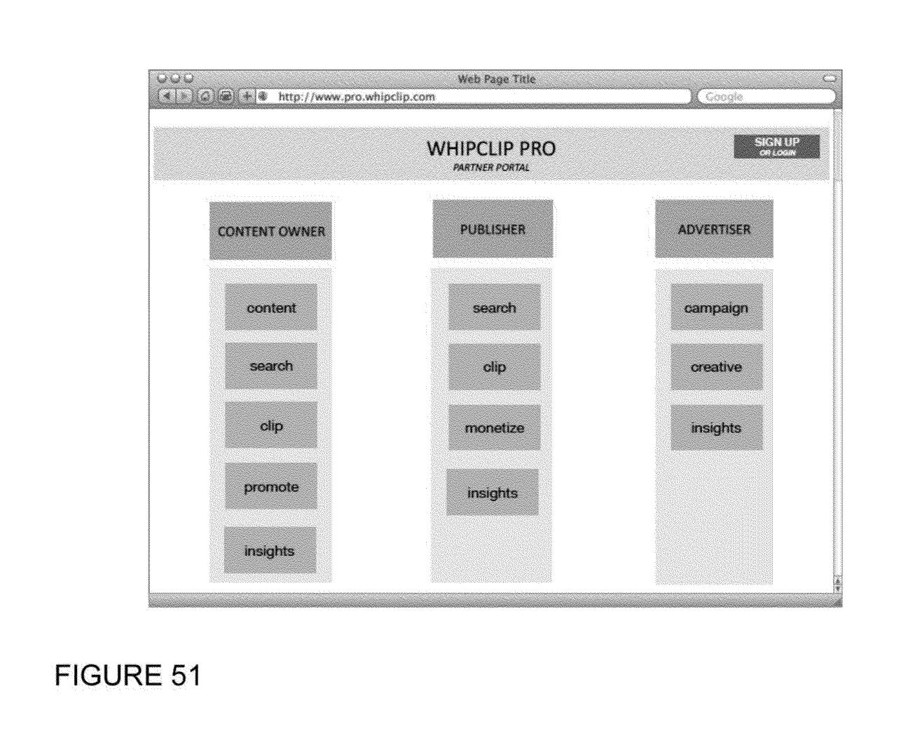

FIG. 51 shows an example of the features that may be available for different users within the embed portal.

### 14.4 Ads Distribution

Ads management platforms may be used to distribute ads through our player based on pre-negotiated deals.
All expected ads are played without visible defects.
Midroll ads are played at expected time,
Overlay ads are played at expected time,
Tune volume before/during ad plays, ad volume is tuned too.
Mute/unmute before/during ad plays, ad is mute/unmute,
Click all ads, cheek click through pages/webviews. Exit click through pages/webviews, verify player/app can correctly resume.
Go into Full Screen mode, verify all ads show properly, verify ad clicking.
[Mobile only] Check both landscape and portrait modes. Rotate device before/during/after ads play.
Seek content video while it is playing, verify midroll/overlay ads behavior as expected.
Different players may have different logic for scrubbing,
When content video completes: if there is postroll, confirm it's played.
When content video completes: if support playlist, confirm next video will start with preroll (if any).
When content video completes: if there is an “end card”, confirm it doesn't negatively interact with postroll.
Switch content after content video and postroll complete, verify it behaves correctly.
Switch content when content video is playing, verify it behaves correctly.
Switch content when in-stream ad is playing, verify it behaves correctly.
Test an ad configuration that doesn't return an ad, to verify that when ad trafficking presents a problem, player is not broken
Test that when ad blocker is used, content plays as usual,

Follow Up with Ad Server Config

Verify frequency capping is set.

Confirm series/airing configuration.

Configuration Rules should be Normalized where Possible:

Source (Network/Channel)

Ad Server (DFP/FW)

Production Network ID (from ad server)

Test Network ID

Production ServerURL

Test ServerURL

Series

Airing

Site Code

Video Asset

### 14.5 Brand Safety-Blacklists

Functions to allow content owners to block sites from embedding content or running ads on certain sites. Brand safety refers to the practices and tools that ensure an ad will not appear in a context that can damage the advertiser's brand. There are two buckets of objectionable content. The first is one we can all agree are bad for brands: hate sites, adult content, firearms, etc. The other is based on criteria that are specific to the brand.

Within those two cases, we must consider places were content owners do not want content embedded; and also, where brand/advertisers do not want their ads shown.

### Requirement:

Content Owner/Moderator/Admin may upload a .csv file of domains as a blacklist file.

User may select from a pick list for ‘Block For’ of the following values to apply to the blacklist (Content Only, Ads Only, Ads+Content).

If Block For=Content: When content is embedded on a website, player should make a call to verify whether the page exists on a blacklisted domain. If content is on a blacklisted domain, show default house card.

If Block For=Ads only, if content is embedded on website on ad blacklist, do not make ad call to freewheel.

If Block For=Ads+Content, do not make ad call and show default house card.

### 14.6 Mezzanine File Support

Mezzanine file support enables ability to ingest, manage and distribute library content. A mezzanine file is a digital master that is used to create copies of video for streaming or download. Online video services obtain the mezzanine file from the content producer and then individually manipulate it for streaming or downloading through their service. Enabling support for this type of file opens up the library of content available to us outside of live streaming TV.

Each piece of video content submitted to Whipclip requires at least four deliverables:

high quality mezzanine video file

video metadata

subtitles and/or closed captions

artwork

(optional) high resolution episodic thumbnails

In addition to content delivery, various high resolution images are required for shows, movies, branding.

Specifications below will cover the common case but there may be specific use cases that need to be addressed by the partner team on a case by case basis.

### Metadata

Ingest process may begin with a metadata file (xml or excel). It help define descriptive aspects the content delivered to Whipclip, including:

Information that describes content in the video (i.e. video title, series, etc.)

Information used by Whip CMS (sunset dates, ad segment timecode)

References to other individual deliverables that constitute a complete delivery

15. Social Network, e.g. Facebook, Integration

Common practice to share video via Facebook is to directly share the video to the page for which permissions have been obtained. However, in order to share a clip to multiple Facebook accounts, some constraints exist such as, for example:
rate limitations: restrictions exist on the number of shares allowed within Facebook.
whitelisting: content with rights such as TV content, or music content for example has to be whitelisted in order to be shared.

In order to overcome these constraints, an intermediate step is introduced in which a middle page (the Whipclip Facebook page) is created and all clips are first shared within the Whipclip Facebook page. In particular, the number of shares allowed within the Whipclip Facebook page is not restricted. Hence when a clip is shared via Facebook, it is first shared in the Whipclip Facebook page and then it may be re-shared to the appropriate accounts, such as for example a Facebook brand page or a Facebook individual page.

In addition, end-cards may be added since all clips are always shared first within the Whipclip Facebook page. When a video is shared within Facebook, the system triggers a functionality within Facebook to add a video end-card at the end of the clip that is shared and uploaded within Facebook, tune-in information specific to the program may also be displayed, as shown in FIG. 19B.

### 16. Reporting Tools

Our reporting tools can help estimate conversion to tune-in, for example:
the system is able to know the number of people who create clips while watching your show.
the system is able to know the number of people who watch clips while your show is airing live and estimate their conversion to tune-in.
the system is able to know the number of clicks on your end cards that drive to your Channel Finder.
the system is able to survey users during the season to determine the number of app users who tuned in after viewing a clip.
Automatic Content Recognition (ACR) technologies may be used to “listen” to whether or not app users are watching a specific show live.

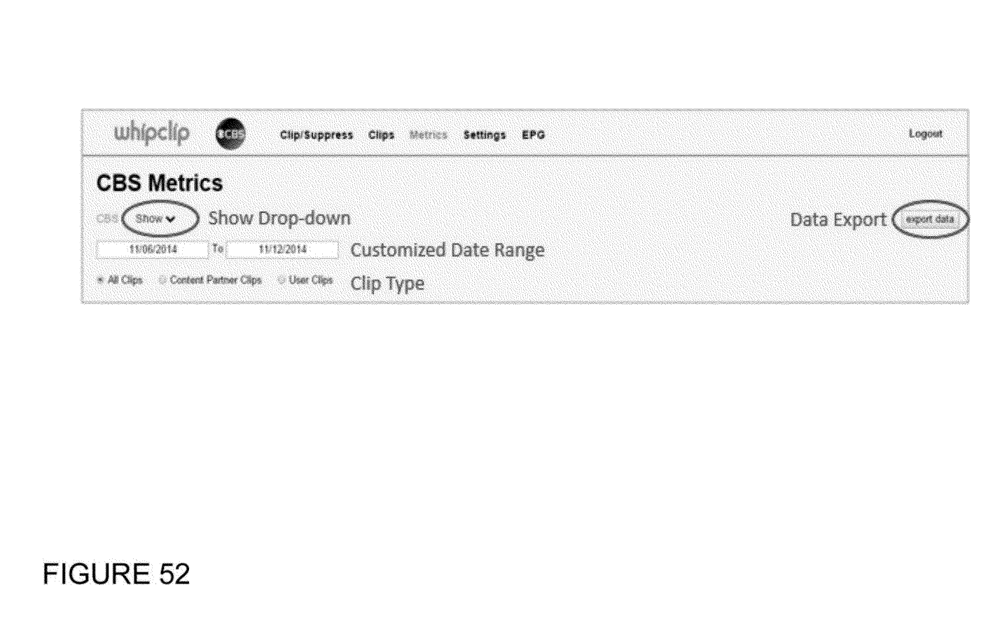

The partner portal contains a Metrics section, which provides an information dashboard on how specific content, has been performing from an engagement standpoint. FIG. 52 shows an example of a Metrics page. From the Main Header, it is possible to navigate to specific shows and episodes and specific date ranges, which will update the dashboard. Information may be exported in Microsoft Excel to perform additional analysis.

The main “at a glance” charts include metrics around, but are not limited to:

Top Views by Shows/Episodes

Social Engagement on your clips (Likes/Comments Shares)

End Card Impressions

End Card Click-Through Rates

Unique Clippers

The metrics area of the portal is where partners can go and view how their content is performing. (Note: security is extremely important, as ABC should not ever be able to see information on NBC's content, etc.) This is also where authorized internal Whipclip employees should be able to go to see data across all content partners (in the above example NBC and ABC).

Metrics has both a simple to glance and navigate dashboard and also have a way for partners to pull all of the raw data related to their content that they can then use to create their own charts/metrics/information.

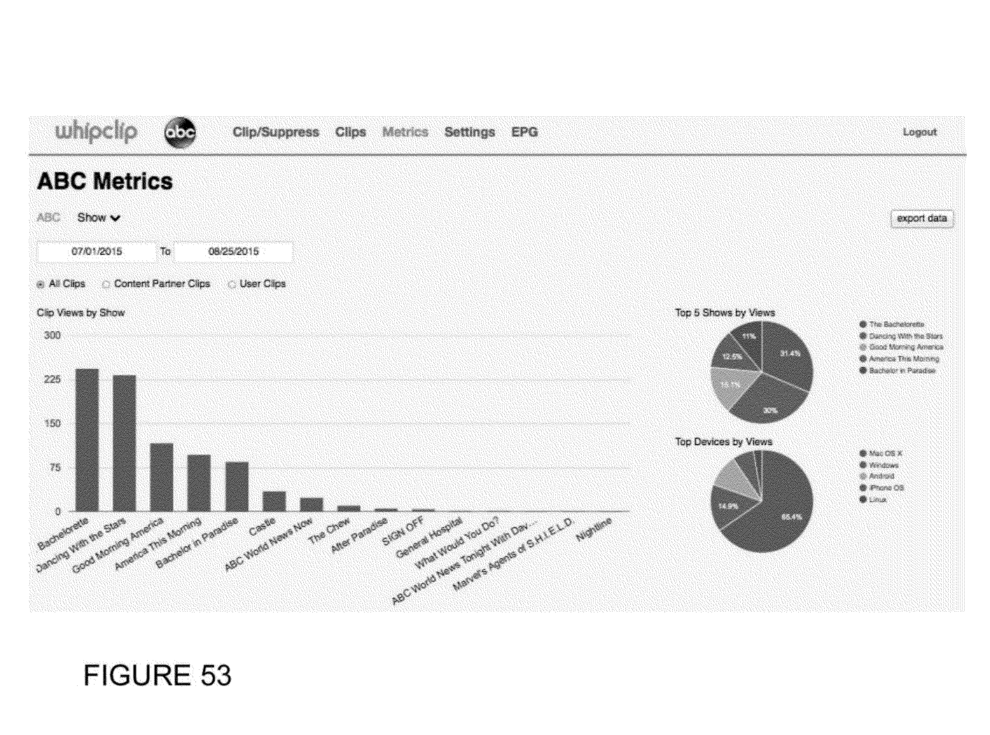

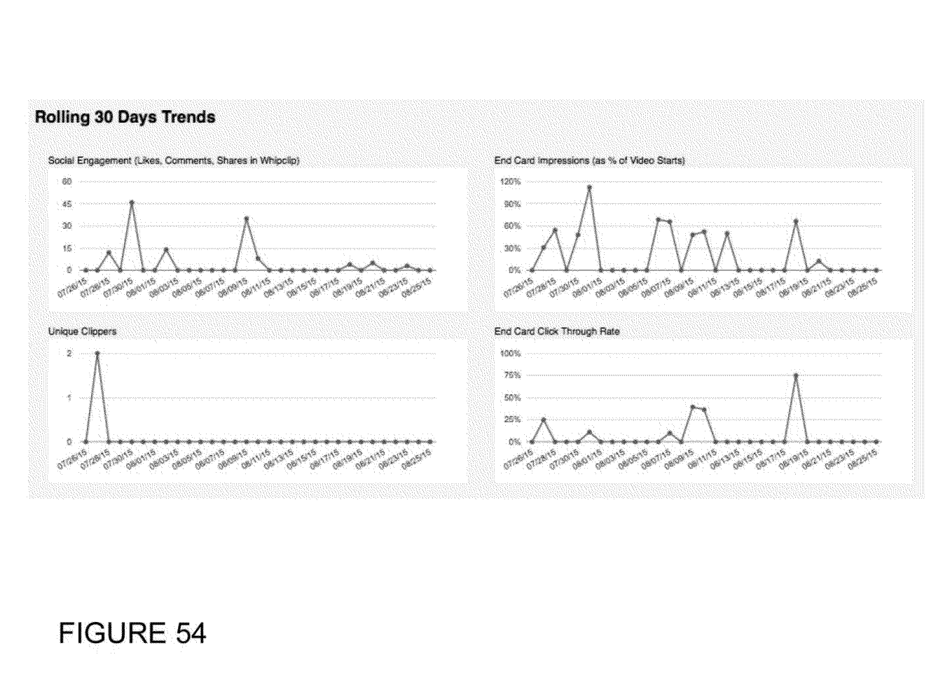

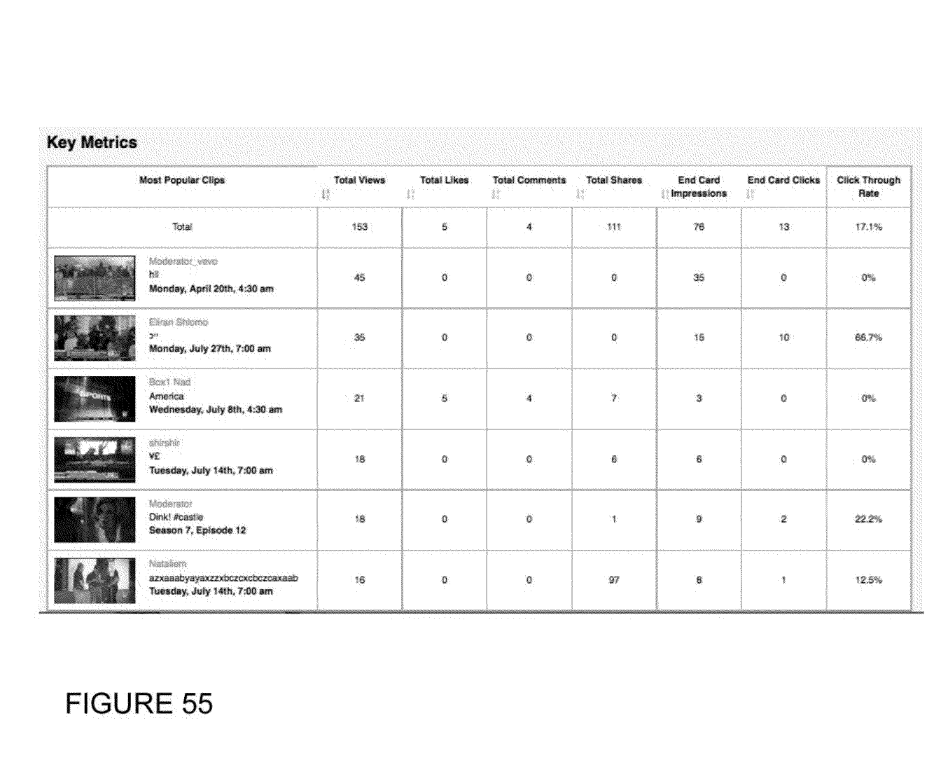

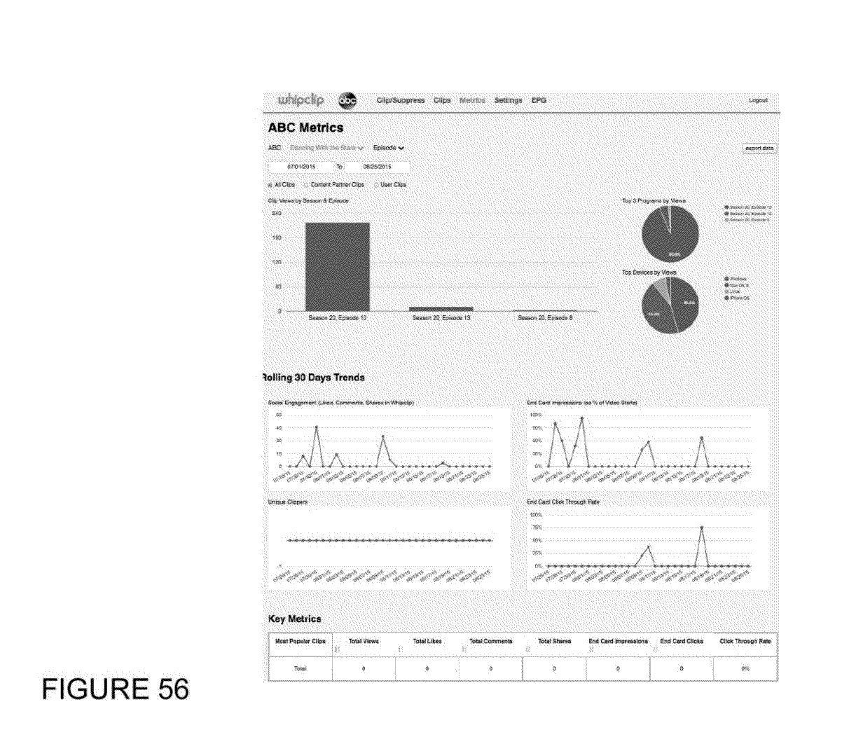

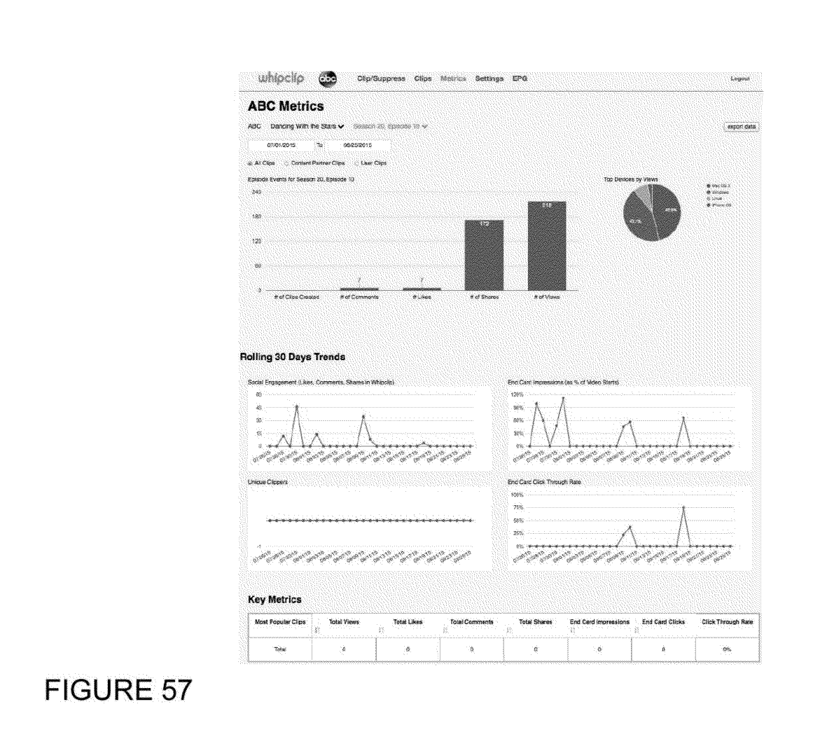

Partners may be able to drill down from channels to shows to specific episodes. Partners may also be able to select specific date ranges for their data. An example of a dashboard for a specific channel is shown in FIGS. 53 and 54. In particular, the dashboard in FIG. 53 displays a histogram with the number of clip views by show. It also displays the top 5 shows by views and the top devices by views. The content owner may also choose to only display the metrics related to all clips, or only the content partner's own generated clips or all the end-user. Partners may also specify date ranges. In FIG. 54, the dashboard displays several plots with a timeline of the social engagement; unique clippers, end card impressions and end card click through rate. An example of a dashboard for a specific show within the channel is shown in FIG. 55, wherein a table summarizing the key metrics for the most popular clips is presented, such as total views, total likes, total comments, total shares, end card impressions, end card clicks and click through rate. An example of a dashboard for a specific episode within the show is shown in FIGS. 56 and 57, wherein similar metrics may be displayed than for the channel metrics.

All metrics may be sortable based on, for example Partner Clips, User Clips or Partner & User Clips.

Instrumentation data may include data on the following, but is not limited to:

Properties

Widget Properties

Widget Impression

Clip Module Impression

Clip Module Play

Clip Module End Card View

Clip Module End Card Click

Performance reporting may include reporting of the following, but is not limited to:

publisher

page views

clip plays

end card view

end card clip

Publisher Payment Report may include report on the following, but is not limited to:

publisher

page views

clip plays

end card view

end card clip

amount owed

### 17. Searching on TV Transcripts and Video to Generate Program Excerpts

The invention enables an end-user to search within digital media resources, such as television series, episodes or clips. An end-user may submit an input text as a search query and the system is able to generate one or more than one clip that is relevant to the search query. The system may provide a clip that has already been created, published or shared and is already available on the web, social, or third party application or website. The system may also create a new clip by defining the start and end point of the clip in order to generate a new clip according to the search query. This may be done in real time when a search request is submitted by an end-user.

The system may search on TV transcripts or may also use image or video processing techniques such as facial recognition techniques to generate a clip that matches the search query. The system may use a combination of TV transcript search and image processing techniques. Additional features may be taken into account such as for example social activity around digital media resources as described in this section.

A commercially available and scalable search engine has been customised and configured such that it can be applied in the context of searching media content. In particular, the weight of the different fields searched are controlled, analyzed and indexed in a specific way.

Whipclip tailored search ranking algorithm takes into account several parameters such as, but not limited to: Linguistic match—Ceteris paribus, exact matches are ranked higher than partial matches; higher density and proximity of query terms is also ranked higher.

Different fields may have different weights based on their relative importance. For example the different weights may be assigned to the following:

postMessage: high

transcript and Closed Caption From Transcript: medium

episodeSynopsis: medium

showCast.character: low

showCast.actor: low

episodeName: low

showSynopsis: low

episodeCast.actor: low

episodeCast.character: low

Additional features of the search function may include the following, alone or in combination:

popularity of the searched content item, for example a more popular or trending content item may be ranked higher.
recency of the searched content item, such as when the content item was created and published, for example, a more recent content item may be ranked higher.
de-duplication, for example duplicated content item may be ranked lower.
popularity may be a function of number of likes, shares, views, or comments of the searched content item.
transcript search, a search for something in the transcript that just aired should ranked higher than content items that have aired days or weeks ago.
search for specific TV cast members, using facial recognition techniques.

A trade off may be selected between the relevancy of the search request and the social weight of the searched content item.

The system extracts closed captions of a video and indexes them into the search engine with their associated timestamp. These captions, along with EPG metadata and user comments, enable users to find specific moments accurately within TV video using the search feature.

### 17.1 Searching on TV Transcripts to Generate Program Excerpts

A TV search system indexes the EPG metadata and full transcripts of streams of TV broadcast from various TV channels, and facilitates textual search over the indexed content. When the system finds a textual match, it creates a video clip around the time of the match and returns it as a search result.

The system uses a standard search engine, but there is a particular difficulty in this functionality in comparison to standard search. The documents that are indexed by the search engine are TV programs, but the search results are in a lower resolution; they should be clips from the specific time that the searched text was uttered in the show.

The method may be as followed:

During the show:
1. We get the EPG metadata for each show in each TV stream, and the full transcript of the show, as a list that includes timestamp and text for each line in the transcript.
2. The system creates one string of text from the transcript, in the following format: “<timestamp1> text line 1<timestam2> text line 2, . . . , <timestamp n> text line n”. The search engine is instructed to ignore characters that appear within the characters < and >.
3. The system sends the show metadata and transcript string to indexing.

During search query:
4. The query is sent to the search engine and the search engine returns a set of search results. Each result includes a document (which is a TV program), with text highlights.
5. For each result:
   a. for each text highlight that comes from the transcript, we use its offset within the transcript string to find the nearest preceding timestamp. This is the time of the result in the video.
   b. A video clip is created from A seconds before the timestamp and B seconds after the timestamp (A and B are configurable).
6. The list of search results includes the collection of all video clips obtained above.
   17.2 Using Face Recognition Technology to Facilitate Searching within TV Shows

The system may also implement additional face recognition techniques. The search function may therefore include the ability to search for the appearance of specific TV cast members. This is an extension of the TV search system described above, to support direct video search; specifically when a search request includes a name of cast members or characters in TV shows. The system may return the part of the show in which this character appears.

The method may be as follows:

Before the show:
1. We get show EPG metadata for each show in each TV stream (about two weeks before the show). The EPG metadata includes the list of cast members, and the respective character names (the latter is relevant in fiction shows, and not relevant in talk shows or reality TV).
2. For each character we obtain a set of pictures from a public web images search API.
3. We use an external face recognition system. For each show, we train the system to recognize the set of cast members that appear on the show, by sending the set of pictures downloaded for that person.

During the show:
4. We use a Face Recognition service on each key frame in the video, and get an assessment of the probability that each cast member appear in each key frame.
5. A filtering algorithm is applied on the result to get a better assessment of the parts of the show that each cast member appeared. The idea is to use information from one frame to improve the understanding of neighboring frames.

During search:
6. When a search query is submitted, the system tries to match the query with cast members (using mapping of cast member names to character names when applicable), and if there is a match the system guides the search towards the parts of the show in which the cast member appeared.

Hence information on nearly the exact time where each cast members appeared in the video may be retrieved. An end-user may therefore search for a particular cast member, character or actor on TV and the system may process the search query, and generate a clip by defining the start and end point of the clip for which the cast member, character or actor appeared. The clip may be provided to the end-user. The system may also generate a list of clips where the cast member, character appeared on TV. The system may also generate a list the exact minutes where each cast member, character or actor appeared on TV.

The search using facial recognition processing may also be combined with a search on EPG metadata, closed caption, subtitle or user comments.

### APPENDIX 1

This Appendix 1 list various innovations, described below as Concepts A S, and which can be implemented in the Whipclip system.

Any Concept A-S can be combined with any other concept; any of the more detailed features linked to each concept can also be combined with any Concept A-S and any other detailed feature.

Short titles for the innovations are:

Concept A: Content-owner can alter permissions at any time

Concept B: Media search with relevancy ranking using social traction

Concept C: Closed captions with milli-second time stamps

Concept D Recognition of TV cast members

Concept E: Automatic scheduling of clip creation and publication

Concept F: Social value of clips: hot moments

Concept G: Detecting peak moment(s) of a TV program based on clipping activity

Concept H: Monetising TV

Concept I: Embed Portal

Concept J: App auto-opens to show clips from the TV channel you are watching on your TV set

Concept K: Search input creates the clip

Concept L: Extensible search system using a micro-service architecture

Concept M: Analysing user-interaction with video content by examining scrolling behaviours

Concept N: Suppression

Concept O: Adding end-cards in real-time

Concept P: Secure media management and sharing system with licensed content

Concept Q: Social network (eg Facebook) integration

Concept R: Clipping system within RAM

Concept S: Compression of video metadata

### More Detail on the Innovations

### Concept A: Content-Owner can Alter Permissions at any Time

A. Method of controlling the distribution of media clips stored on one or more servers, including the following processor implemented steps:

(a) updateable permissions or rules relating to the media clip are defined by a content owner, content partner or content distributor (‘content owner’) and stored in memory;
(b) the clip is made available from the server via a website, app or other source, for an end-user to view;
(c) the permissions or rules stored in memory are then updated;
(d) the permissions or rules are reviewed before the clip is subsequently made available, to ensure that any streaming or other distribution of the clip is in compliance with any updated permissions or rules.

Optional key features:
Content owner controls updating of the permissions or rules
Updated permissions or rules include entirely new permission or rules
Permissions or rules define if the clip or any part of the clip has to be suppressed
Permissions or rules define the end-card, e.g. its content
Permissions or rules define the duration of the clip
Permissions or rules define when the clip expires
Permissions or rules relates to the hierarchy of episode show channel, with permission or rules relating to an episode taking priority over permissions or rules relating to a show, and permission or rules relating to a show taking priority over permissions or rules relating to a channel; these may then be stored as recurring properties at that level of the hierarchy
Permissions or rules for content that includes the clips are updated after the first release of the content
Permissions or rules are applied to or present in EPG metadata
Permissions or rules define accessibility of the clip according to an end user specification (geolocation/age/name of end user)
Permissions or rules define a maximum aggregated time an end user can watch a specific episode/show/season.
The content that includes the clips is live broadcast TV content
The content that includes the clips is previously aired TV content, but indexed and searchable
The content owner/partner can
   define a specific section of the content to be edited to a shareable clip
   edit multiple sections of the content into a single shareable clip
   write text or provide other commentary or media to accompany the clip that is shared
   preview the content before it is shared
   mark as a spoiler one or more specific sections of the content
   define a maximal aggregated time a given user can watch a particular program.
The content owner/partners can administer suppression information in real time to a specific section of the content
Suppression is administered in real time while clips are loading to the server
The suppression information enable one or more of the following:
   prevent access to a specific section of the content
   grant or deny an end-user access to a specific section of the content according to an end-user specifications (such as location coordinates, age of the user, name of the user, . . . ),
   decide the time frame in which to allow access to a specific section of the content
   grant an end-user access to a specific section of the content to enable an end-user to create, edit, or share specific section of the content.
   deny an end-user access to a specific section of the content this denies the possibility to create/edit/or share the specific section and also deletes the specific sections that have already been created/edit or shared on the partner portal (or any other platform)
   Suppression rules at episode, season, or show levels
      by time code
      by time zone
      by geolocation (e.g. DMA-based instead of time zone to comply with regional sports networks agreements (e.g. NBA) or Geo-targeting to the level of zip code)
   Expire clips after specified period
   Suppress commercials
   Suppress internal clips
   Suppress user clips
   Suppress user comments
   Suppress specific portions of a clip (e.g. the last X minute of a show)
   Age-gating to prevent minors from seeing adult content (e.g. nudity)
   Suppress clips after a certain amount of time (e.g. Season one clips no longer allowed during Season
   Gives ability to limit number of clips per show. For example, a limit of the percentage of an episode that a user can see across all episodes can be set. As another example, a holding bin can be set so that clips of shows aired in the US Eastern time zone are marked spoilers for the US Western time zone
   Customizable messaging for user experience in cases of suppression
   Delete any video clip that was already created from the suppressed part of the stream
Define expiration time on specific video clips
Define expiration on the metadata level, e.g., for all clips created from a channel, or all clips created from a show, or from all clips created for a specific episode of a show
Delete specific video clips—the result is that any embedding of this clip will no longer work
Sharing features
   Share to Facebook
   Share to Twitter
   Share to Pinterest
   Share to Tumblr
   Email link
   Embed code link
   Accounts may be pre-populated to users accounts based on what information they have provided in settings for social log-in links.
End cards
   Customizable end card with image, clickable link, and link text
   Modify the end-card of clips at any metadata level. This can be set to affect the end-cards of published clips and/or future clips.
Advertising
   Integration with third party ad servers (e.g., FreeWheel, Google DFP)
Metrics Reporting
Customize account settings for specific channel(s), show(s) and episode(s)
Set rules and restrictions for how Whipclip app users (consumers) can interact with content
   Concept B: Media Search with Relevancy Ranking Using Social Traction

B. Method of searching digital media content such as television series, episodes or clips using a processor-based system, including the steps of ranking or scoring of a specific content item as a function of both (i) relevancy of user-input search query terms to metadata associated with that specific content item and also (ii) social traction, weight or popularity of that specific content item.

Optional key features:
Social traction or popularity is a function of one or more of: number of likes, number of shares, number of views, number of comments of that specific content item
Scoring of a specific content item is a function of recency of the content item, such as when that content item was first created or published
Metadata includes closed captions or sub-titles embedded in or added to video
Metadata includes manually sourced or added data
All steps of the method are undertaken by the processor
   Concept C: Closed Captions with Millisecond Time Stamps

C. Method of searching digital media resources, such as television series, episodes or clips, using a processor based system, including the steps of

(i) timestamping closed captions or sub-titles embedded in or added to video with timestamps that are accurate to at least a milli-second and;
(ii) searching against the closed captions or sub-titles to retrieve matching items, including the timestamps;
(iii) indexing or retrieving those items with at least millisecond accuracy.

### Concept D Recognition of TV Cast Members

D: Method of searching digital media content, such as television series, episodes or clips, using a processor based system including the following steps:

(a) obtaining a set of pictures for each cast member;
(b) training a facial recognition system using the set of pictures;
(c) using the trained facial recognition system to generate an index or record, such as a time-stamped index, for each appearance of one or more cast members, the index or record also including the cast member name and/or character name and
(d) responding to a search query that includes a cast member name or character name by providing a video clip with that cast member name or character name, the clip being located using the index or record.

Optional key features:
a cast list that names the cast members and/or their character names is retrieved from an item of content, such as from EPG metadata for that item of content
facial recognition includes the processor-implemented steps of
   (a) training a processor-based facial recognition system to recognize a specific face in media assets and then
   (b) searching for that face across multiple video frames
   (c) attributing a frame-specific confidence level to whether the face is present in each individual video frame in a sequence of frames
   (d) attributing an overall confidence level to whether that face is present in the sequence by analyzing or processing multiple frame-specific confidence levels.
analyzing or processing multiple frame-specific confidence levels includes averaging frame-specific confidence levels
analyzing or processing multiple frame-specific confidence levels includes attributing less or no weight or significance to a low confidence score for a specific frame if adjacent frames have a high confidence score
overall confidence level that a specific face has been correctly recognized is influenced by the presence of a closed caption associated with that frame that mentions the name of the person whose face is a candidate for the correct face

### Concept E: Automatic Scheduling of Clip Creation and Publication

E: Method for automatic scheduling of a clip from a live TV broadcast including the processor implemented steps of:

(a) a content owner defining a scheduled time frame for the clip to be created and published;
(b) the clip of live TV is created at the scheduled creation time and then made available from a website, app or other source for an end-user at the scheduled publication time.

Other optional key features:
The content owner can define that a clip is created and published in real time, e.g. simultaneously
The content owner can define that a clip is created and published when a user logs into a content sharing application, hence enabling for example the user to view the last 1 minute of live TV content
The content owner can define that a clip is created and published for a defined portion of a show/season/episode/program/game.
The time frame during which publication occurs can be partly or entirely in the future
the clip is recorded and made available from a website, app or other source for an end-user; the end-user selects the clip at a time T; the clip for that TV show or event is provided at approximately time T, but the content of the clip is delayed by a predefined time delay with respect to live TV.
content owner controls the time delay
time delay is 1 minute
time delay is adjusted to maximize the conversion of users from watching the time-delayed clip to watching the show or event on live TV.

### Concept F Social Value of Clips: Hot Moments

F: A processor-implemented method of assessing the popularity of media content, comprising the steps of:

(a) providing a clip of that media content from a server;
(b) generating a score for the social traction, weight or popularity over defined time periods for each clip, such as for each second, to detect the most popular moments within the clip by evaluating the social traction, weight or popularity of each defined time period.

Optional key features:
The social traction, weight or popularity of each defined time period is evaluated by measuring or counting one or more of: the number of likes, number of shares, number of views, number of comments of that clip, number of clips created from the clip.
Method generates a score for the social traction, weight or popularity over defined time periods for each clip, such as for each second, to detect the most popular moments within the clip
Clip is between 5 seconds and 90 seconds and captures specific moments of a TV show
Method is used to assess the popularity of specific characters in a TV show
Method is used to evaluate success of a product placement in a TV show
Method is used in a real-time trend analysis process
Method is used to provide an end-user with trending media content, such as video clips, that are relevant or interesting to that specific user
Method is used in a market or audience research system

### Concept G Detecting Peak Moment(s) of a TV Program Based on Clipping Activity

G. A processor-implemented method of scoring media, such as a TV program, comprising the steps of:

(a) measuring or receiving clipping activity scores or clipping related data;
(b) determining one or more ‘peak moments’ of the media, each associated with high clipping activity scores or other clipping related data; and
(b) grouping the content of some or all of the media into a series of segments, which each include one or more peak moments of the program.

Optional features:
when a clip is created, published or shared, a score for each second within the clip is calculated at first using a normal distribution function wherein a score is higher in the middle of the clip, and a total score for each second within the media or program is then aggregated by adding the calculated score for each second within the created, published or shared clip.
the media or program is segmented based on the total score local maxima and minima.
Method is used, for example by a content owner of the media, to automatically generate a clip that includes a peak moment.
Method is used, for example by a content owner, for promotion of key moments in social media.
Method is used in real time.
Method is used in a search functionality.
Method is used to customise an end-user feed.
Method is used in a real-time trend analysis process.
Method is used in a market research system.

### Concept H Monetising TV

H: Method of distributing media clips from a remote server including the following processor implemented steps:

(a) a clip of TV is recorded and made available from a website, app or other source for an end-user;
(b) a user selectable option, such as a ‘buy now’ button, is displayed together with the clip on the website, app or other source;
(c) when the user selects the option, then a product or service featured in the clip at that moment is identified.

Optional key features:
End-user is given the option to purchase the product or service that is identified
Metadata in the clip identifies all products or services that are capable of being identified in the clip

### Concept I Embed Portal

I: Method of distributing media clips from a remote server including the following processor implemented steps:

(a) a clip of TV is recorded and then embedded into and made available from a third party website;
(b) a processor-based device, controlled independently of the third party website, sets permissions or rules for the clip.

Optional key features:
the processor-based device is a server that stores the permissions or rules and receive instructions to vary or update the permissions or rules
Content owner controls updating of the permissions or rules
Updated permissions or rules include entirely new permission or rules
Permissions or rules define the end-card, e.g. its content
Permissions or rules define the duration of the clip
Permissions or rules define when the clip expires
Permissions or rules relates to the hierarchy of episode show channel, with permission or rules relating to an episode taking priority over permissions or rules relating to a show, and permission or rules relating to a show taking priority over permissions or rules relating to a channel
Permissions or rules for content are updated after the first release of the content
Permissions or rules are defined in media clip EPG metadata
Permissions or rules are as defined in Concept A above
   Concept J App Auto-Opens to Show Clips from the TV Channel You are Watching on Your TV Set

J: A method of synchronizing the operation of an app on a portable computing device to content on a TV set, comprising the processor-implemented steps of:

(a) detecting, using the portable computing device, which TV content a user is watching on a TV set;
(b) arranging for the app to automatically show clips relating to that content.

Optional key features:
Detecting the TV content uses acoustic fingerprinting or other content identification systems

### Concept K Search Input Creates the Clip

K: A method of creating clips of media content, including the following processor implemented steps:

(a) processing a search query or input;
(b) generating a clip using the search query to define the extent of the clip, such as the start and end points of the clip;
(c) providing the clip to an end-user.

Optional key features:
one search query can lead to creating multiple clips from the same show (if there are several hits), and if two resulting clips are close enough to each other in the timeline, or overlap, they are merged to one.
The length of the clip can be determined according to the strength of the match.
Each clip is accompanied with its transcript, where the text that matches the query is highlighted.

### Concept L Extensible Video Clipping System Using a Micro-Service Architecture

L: An extensible video clipping system using a micro-service architecture including:

(a) multiple services, each publishing any change of state to a message bus to which all services subscribe, making the architecture readily extensible through the addition of any new service that can subscribe to the message bus;
and in which video data updates are not written directly to a persistent database but instead written directly to the message bus, which then writes to the persistent database.

Optional key features:
The multiple services access in real time a shared cache which stores all of the social data (likes comments etc)
One service enables the creation of video clips
One service enables the sharing of video clips
   Concept M: Analysing User-Interaction with Video Content by Examining Scrolling Behaviours

M: A method of analyzing user interaction with video content displayed on a computing device in which that content can be scrolled by the end-user; including the processor-based steps of:

(a) generating scrolling data that defines how the user scrolls through video content.

Optional key features:
the scrolling data relates to a specific video clip
the scrolling data relates to whether the user paused to look at the summary or a still from the video clip, and the action that followed after the pause
the scrolling data relates to whether the user paused to look at the summary or a still from the video clip, and did view the clip
the scrolling data relates to whether the user paused to look at the summary or a still from the video clip, but did not view the clip
the scrolling data relates to how quickly a user scrolled past the summary or a still from the video clip, and did view the clip
the scrolling data relates to how quickly a user scrolled past the summary or a still from the video clip, but did not view the clip
the scrolling data is used in a machine learning process to learn the user's preferences for content
the scrolling data is used in a machine learning process to learn the user's preferences for content and to adjust the content that is displayed to the user in accordance with those preferences
the content adjustment occurs in real-time as the user scrolls through content

### Concept N Suppression

N: Method of distributing media clips from a remote server including the following processor implemented steps:

(a) defining updateable suppression rules relating to the media clip;
(b) making the clip available from a website, app or other source for an end-user to view on demand, in compliance with those suppression rules;
(c) reviewing the suppression rules before the clip is made available to an end-user, to ensure that any distribution or streaming is in compliance with the suppression rules.

Optional key features:
Suppression rules are defined in media clip metadata
See also suppression rules defined in Concept A
   Concept O Adding end-cards in real-time

O: Method of distributing media clips from a remote server including the following processor implemented steps:

(a) defining updateable rules relating to an end-card for the media clip;
(b) including in the clip an end-card that has been added in real-time in compliance with those rules; and
(c) making the clip available from a website, app or other source for an end-user to view on demand.

Optional key features:
the end-card includes a link to a specific URL
the end-card is tailored according to the specific details of the user (such as for example its geolocation coordinates).
the rules define the maximum length of the media clip
the rules define the automatic expiration time of the media clip.
   Concept P: Secure Media Management and Sharing System with Licensed Content

P1: A secure media management and sharing system including:

(a) a content delivery network that sends licensed content to wireless connected media devices, such as smartphones or tablets;
(b) a server that receives instructions from an application or other software running on the connected media devices to generate or locate a clip of the licensed content and to share that clip with designated contacts, such as friends in a social network.

P2: A portable, personal media viewing device that can receive licensed data for a live TV broadcast, in which an application running on the device can (i) show that TV broadcast on a screen on the portable personal media viewing device to a user, and then (ii) enable a clip of that live broadcast data to be created/defined by the user and shared with others.

P3: A method of sharing content, comprising the steps of:

(a) a content delivery network sending licensed content to wireless connected media devices, such as smartphones or tablets;
(b) a server receiving instructions from an application or other software running on the connected media devices to generate or locate a clip of the licensed content and to share that clip with designated contacts, such as friends in a social network;
(c) generating or locating that clip and sharing that clip with the designated contacts.

Optional key features:
The content is live broadcast TV content
The content is previously aired TV content, but indexed and searchable
Sharing/editing content of live content is done in real-time.
application or other software running on the connected media devices displays the licensed content
Live broadcast TV content is displayed on the wireless connected media device at approximately the same time that same content is displayed on conventional TV, such as cable TV.
Application enables an end-user to search for specific moments in previously broadcast content, such as previous episodes of TV series
Designated contacts are contacts listed in a messaging or social network application
Application enables a user to define the specific section of the content to be edited to a shareable clip
Application enables a user to edit multiple sections of the content into a single shareable clip
Application enables a user to write text or provide other commentary or media to accompany the clip that is shared with the designated contacts
CDN or other backend equipment can suppress the availability of defined portions of a show/season/episode.
CDN or other backend equipment can set a maximum length for the content.
CDN or other backend equipment can set a maximum aggregated time an end-user can watch a show/season/episode.
CDN or other backend equipment can grant or deny access of defined portions of a show/season/episode based on end-user specifications, such as location coordinates, age or name of the end-user.
Video is provided to an end-user only if the corresponding live TV has already been broadcast in the end-user's time zone.
Video clips can be rapidly and easily embedded into any web sites to help promote the content.
Video clips can be rapidly and easily embedded into any messaging or social network application, where they can be shared by recipients, leading to viral exponential growth in exposure.
Video clips include clickable end cards e.g. each video's final frame includes a link that takes a viewer to a destination defined by the content owner (e.g. their own website).
   Concept Q: Social Network (e.g. Facebook) Integration

Q: A method of enabling digital media content to be shared from a social network system to multiple end-user accounts of that social network, comprising the steps of:
(a) creating an intermediary page or resource on the social network, that page or resource permitting an unrestricted number of shares of an item of digital media content;
   (b) posting or sharing an item of digital media content to the intermediary page;
   (c) sharing that item an unrestricted number of times.

Optional features:
An endcard is automatically added to an item posted to the intermediary page so that when the item is shared it automatically includes that end-card
The end-card includes a programmable hyperlink, and link text, in order to route referral traffic to a destination of the content owner's choice.
   Concept R: Clipping System within RAM

### Suppression Metadata (First Algorithm)

R. Method for the efficient storage of metadata relating to clips of digital media content while preserving access and insertion operations for those clips, comprising the processor-implemented steps in which metadata of fixed length per time unit, such as suppression flags and availability of various segment resolutions, is stored via a tree structure of constant depth and where at each node, there is an array that stores an aggregated state for the time window it represents.

Optional features
metadata that is repetitive for large section can be represented at higher level in the tree without having to be represented in the children nodes.
The aggregated view is a simple value to represent that all segments in this time window have a specific state
The aggregated view is a reference to children nodes with more accurate information about slices of that time window.

### Concept S: Compression of Video Metadata

S. A processor-implemented method of storing video metadata in memory wherein a clip is composed of one or more video segments, and wherein the video metadata includes information about the video segment(s), such as duration of the segment(s), and wherein the amount of storage per second of video metadata is constant.

Optional features
A fixed number of bits are used to store each second of the video metadata.
Wherein the first bit of every fixed number of bits defines if it is a start or continuation of the video segment, and wherein the rest of the fixed number of bits available encode the segment duration.
Method is used to enable the efficient creation of large amount of video clips.
Method is used to enable the efficient playing of large amount of video clips.
Method is used to retrieve quickly and efficiently video metadata, and enables the real time creation and playing of video clip, wherein the video clip is composed of a sequence of video segments.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1: Method of controlling the distribution of media clips stored on one or more servers, including the following processor implemented steps:
(a) updateable permissions or rules relating to the media clip are defined by a content owner, content partner or content distributor (‘content owner’) and stored in memory;
(b) the clip is made available from the server via a website, app or other source, for an end-user to view;
(c) the permissions or rules stored in memory are then updated;
(d) the permissions or rules are reviewed before the clip is subsequently made available, to ensure that any streaming or other distribution of the clip is in compliance with any updated permissions or rules.

2. The method of claim 1 in which the content owner controls updating of the permissions or rules.

3. The method of claim 1 in which updated permissions or rules include entirely new permission or rules.

4. The method of claim 1 in which the permissions or rules define if the clip or any part of the clip has to be suppressed.

5. The method of claim 1 in which the permissions or rules define the end-card.

6. The method of claim 1 in which the permissions or rules define the duration of the clip.

7. The method of claim 1 in which the permissions or rules define when the clip expires.

8. The method of claim 1 in which the permissions or rules relate to the hierarchy of episode show channel, with permissions or rules relating to an episode taking priority over permissions or rules relating to a show, and permission or rules relating to a show taking priority over permissions or rules relating to a channel and are then stored as recurring properties at that level of the hierarchy.

9. The method of claim 1 in which the permissions or rules for content are updated after the first release of the media clip.

10. The method of claim 1 in which the permissions or rules are applied to or present in EPG metadata.

11. The method of claim 1 in which the permissions or rules define accessibility of the clip according to an end user specification, such as the geolocation, or age or name of an end user.

12. The method of claim 1 in which the permissions or rules define a maximum aggregated time an end user can watch a specific episode/show/season.

13. The method of claim 1 in which the media clips are taken from content that is live broadcast TV content.

14. The method of claim 1 in which the media clips are taken from content that is previously aired TV content, but indexed and searchable.

15. The method of claim 1 including the step of the content owner defining a specific section of the content to be edited to a shareable clip.

16. The method of claim 1 including the step of the content owner editing multiple sections of the content into a single shareable clip.

17. The method of claim 1 including the step of the content owner writing text or providing other commentary or media to accompany the clip that is shared.

18. The method of claim 1 including the step of the content owner previewing the content before it is shared.

19. The method of claim 1 including the step of the content owner marking as a spoiler specific sections of the clip.

20. The method of claim 1 including the step of the content owner defining a maximal aggregated time a given user can watch a particular program.

21. The method of claim 1 including the step of the content owner administering suppression information in real time to a specific section of the content.

22. The method of claim 1 including the step of suppression being administered in real time while clips are loading to the server.

23. The method of claim 1 including the step of suppression information enabling the prevention of access to a specific section of the content.

24. The method of claim 1 including the step of suppression information granting or denying an end-user access to a specific section of the content according to an end-user specifications, such as location coordinates, age of the user, name of the user.

25. The method of claim 1 including the step of suppression information deciding the time frame in which to allow access of specific section of the content.

26. The method of claim 1 including the step of suppression information granting an end-user access to a specific section of the content enables an end-user to create, edit, or share specific section of the content.

27. The method of claim 1 including the step of suppression information denying an end-user access to a specific section of the content.

28. The method of claim 1 including the step of suppression information denying the possibility to create/edit/or share a specific section and also deleting any such specific sections that have already been created/edit or shared on the partner portal or any other platform.

29. The method of claim 1 including the step of the permission or rules being defined at episode, season, or show levels.

30. The method of claim 1 including the step of the permission or rules being defined by time code.

31. The method of claim 1 including the step of the permission or rules being defined by time zone.

32. The method of claim 1 including the step of the permission or rules being defined by geolocation.

33. The method of claim 1 including the step of the permission or rules expiring clips after a specified period.

34. The method of claim 1 including the step of the permission or rules suppressing commercials.

35. The method of claim 1 including the step of the permission or rules suppressing internal clips.

36. The method of claim 1 including the step of the permission or rules suppressing user clips.

37. The method of claim 1 including the step of the permission or rules suppressing user comments.

38. The method of claim 1 including the step of the permission or rules suppressing specific portions of a clip.

39. The method of claim 1 including the step of the permission or rules age-gating to prevent minors from seeing adult content.

40. The method of claim 1 including the step of the permission or rules suppressing clips after a certain amount of time.

41. The method of claim 1 including the step of the permission or rules limiting the number of clips per show.

42. The method of claim 1 including the step of the permission or rules defining an expiration time for specific video clips.

43. The method of claim 1 including the step of the permission or rules defining expiration for a video clip at the metadata level.

44. The method of claim 1 including the step of the permission or rules deleting a specific video clip, with the result that any embedding of this clip will no longer work.

45. The method of claim 1 including the step of the permission or rules enabling or prohibiting sharing to a social network.

46. The method of claim 1 including the step of the permission or rules defining the content in an end card.

47. A system designed to distribute media clips, the system including a server programmed to implement a method in which:
(a) updateable permissions or rules relating to the media clip are defined by a content owner, content partner or content distributor (‘content owner’) and stored in memory;
(b) the clip is made available from the server via a website, app or other source, for an end-user to view;
(c) the permissions or rules stored in memory are then updated;
(d) the permissions or rules are reviewed before the clip is subsequently made available, to ensure that any streaming or other distribution of the clip is in compliance with any updated permissions or rules.
